(19) United States
(12) Patent Application Publication
(10) Pub. No.: US 2026/0112638 A1
(43) Pub. Date: Apr. 23, 2026

(54) SECONDARY BATTERY

(71) Applicant: SEMICONDUCTOR ENERGY LABORATORY CO., LTD., Atsugi-shi, Kanagawa-ken (JP)

(72) Inventors: Atsushi KAWATSUKI, Yokohama, Kanagawa (JP); Yohei MOMMA, Isehara, Kanagawa (JP); Shuhei YOSHITOMI, Ayase, Kanagawa (JP); Jo SAITO, Atsugi, Kanagawa (JP)

(21) Appl. No.: 19/114,176

(22) PCT Filed: Sep. 27, 2023
(86) PCT No.: PCT/IB2023/059586

§ 371 Date: Mar. 21, 2025

(30) Foreign Application Priority Data
Oct. 4, 2022 (JP) 2022-160406
Jul. 24, 2023 (JP) 2023-120106

(51) Int. Cl. H01M 4/62; H01M 4/02; H01M 4/131; H01M 4/1391; H01M 4/36; H01M 4/525

(52) U.S. Cl. CPC H01M 4/625; H01M 4/131; H01M 4/1391; H01M 4/364; H01M 4/525; H01M 2004/021; H01M 2004/028

(57) ABSTRACT

A secondary battery that achieves higher conductivity of a positive electrode and has higher capacity is provided. The secondary battery includes a positive electrode that includes a positive electrode active material, a first conductive material, and a second conductive material whose shape is different from that of the first conductive material. The positive electrode active material includes lithium cobalt oxide containing magnesium in its surface portion. The weight of the second conductive material is lower than or equal to the weight of the first conductive material. The second conductive material forms an assembly and has a portion sticking to the positive electrode active material.

### TECHNICAL FIELD

One embodiment of the present invention relates to a secondary battery. The present invention is not limited to the above field and relates to a semiconductor device, a display device, a light-emitting device, a power storage device, a lighting device, an electronic device, a vehicle, and manufacturing methods thereof. The secondary battery of one embodiment of the present invention can be used as a power supply necessary for the above semiconductor device, display device, light-emitting device, power storage device, lighting device, electronic device, and vehicle. Examples of the above electronic device include an information terminal device provided with the secondary battery. Furthermore, examples of the above power storage device include a stationary power storage device.

### BACKGROUND ART

In recent years, demand for secondary batteries with high output and high capacity has rapidly grown and the secondary batteries are essential as repeatedly-usable energy sources in modern society. A positive electrode active material included in a secondary battery is an oxide and has lower conductivity than a negative electrode active material containing carbon. Thus, a conductive material is actively studied to improve the conductivity of a positive electrode. For example, as a conductive material of a positive electrode, a structure in which fibrous carbon and spherical graphite are mixed is known (Patent Document 1 and Patent Document 2).

### REFERENCES

### Patent Documents

[Patent Document 1] Japanese Published Patent Application No. H11-345607
[Patent Document 2] Japanese Translation of PCT International Application No. 2018-501602

### SUMMARY OF THE INVENTION

### Problems to be Solved by the Invention

Lithium cobalt oxide is a positive electrode active material expected to have high capacity, but it is concerned that the conductivity of a positive electrode is low because lithium cobalt oxide is an oxide. Lithium cobalt oxide is not mentioned in examples of Patent Document 1 or Patent Document 2, and a conductive material suitable for lithium cobalt oxide is not studied. In view of the above, an object of the present invention is to increase the conductivity of a positive electrode to achieve high capacity by using an appropriate conductive material in the positive electrode using lithium cobalt oxide. Another object is to improve charge-discharge cycle performance. Another object is to improve low-temperature characteristics.

Note that the description of these objects does not preclude the presence of other objects. One embodiment of the present invention does not necessarily achieve all these objects. Other objects can be derived from the description of the specification, the drawings, and the claims.

### Means for Solving the Problems

One embodiment of the present invention is a secondary battery including a positive electrode that includes a positive electrode active material, a first conductive material, and a second conductive material having a shape different from a shape of the first conductive material. The positive electrode active material includes lithium cobalt oxide containing magnesium in a surface portion. The median diameter of the positive electrode active material is greater than or equal to 1 μm and less than or equal to 12 μm. The weight ratio of the second conductive material in the positive electrode is less than or equal to the weight ratio of the first conductive material in the positive electrode. The second conductive material forms an assembly and includes a portion sticking to the positive electrode active material. “The weight ratio of the second conductive material in the positive electrode is less than or equal to the weight ratio of the first conductive material in the positive electrode” can be rephrased as “the weight of the second conductive material is less than or equal to the weight of the first conductive material.”

Another embodiment of the present invention is a secondary battery including a positive electrode that includes a positive electrode active material, a first conductive material, and a second conductive material having a shape different from a shape of the first conductive material. The positive electrode active material includes lithium cobalt oxide containing magnesium in a surface portion. The median diameter of the positive electrode active material is greater than or equal to 1 μm and less than or equal to 12 μm. The weight ratio of the second conductive material in the positive electrode is less than or equal to the weight ratio of the first conductive material in the positive electrode. The second conductive material forms an assembly. The first conductive material is positioned inside the assembly. The assembly includes a portion sticking to the positive electrode active material.

Another embodiment of the present invention is a secondary battery including a positive electrode that includes a positive electrode active material, a particulate conductive material, and a fibrous conductive material. The positive electrode active material includes lithium cobalt oxide containing magnesium in a surface portion. The median diameter of the positive electrode active material is greater than or equal to 1 μm and less than or equal to 12 μm. The weight ratio of the fibrous conductive material in the positive electrode is less than or equal to the weight ratio of the particulate conductive material in the positive electrode. The fibrous conductive material forms an assembly and includes a portion sticking to the positive electrode active material. “The weight ratio of the fibrous conductive material in the positive electrode is less than or equal to the weight ratio of the particulate conductive material in the positive electrode” can be rephrased as “the weight of the fibrous conductive material is less than or equal to the weight of the particulate conductive material.”

Another embodiment of the present invention is a secondary battery including a positive electrode that includes a positive electrode active material, a particulate conductive material, and a fibrous conductive material. The positive electrode active material includes lithium cobalt oxide containing magnesium in a surface portion. The median diameter of the positive electrode active material is greater than or equal to 1 μm and less than or equal to 12 μm. The weight ratio of the fibrous conductive material in the positive electrode is less than or equal to the weight ratio of the particulate conductive material in the positive electrode. The fibrous conductive material forms an assembly. The particulate conductive material is positioned inside the assembly. The assembly includes a portion sticking to the positive electrode active material.

In the present invention, the powder volume resistivity of the positive electrode active material is preferably higher than or equal to 1.0×10⁸ Ω·cm at a pressure of 64 MPa and higher than or equal to 1.0×10⁸ Ω·cm at a pressure of 13 MPa.

In the present invention, the second conductive material preferably includes a carbon fiber.

In the present invention, the fibrous conductive material preferably includes a carbon fiber.

In the present invention, the carbon fiber preferably includes a carbon nanotube.

In the present invention, the powder volume resistivity of the carbon nanotube is preferably lower than or equal to 1×10⁻² Ω·cm at a pressure of 64 MPa.

In the present invention, the powder volume resistivity of the carbon nanotube is preferably lower than or equal to 1×10⁻² Ω·cm at a pressure of 64 MPa and lower than or equal to 1×10⁻¹ Ω·cm at a pressure of 13 MPa.

### Effect of the Invention

According to one embodiment of the present invention, a positive electrode having high conductivity and high capacity and a secondary battery including the positive electrode can be provided. According to one embodiment of the present invention, a positive electrode having excellent charge-discharge cycle performance and a secondary battery including the positive electrode can be provided. According to one embodiment of the present invention, a positive electrode having favorable low-temperature characteristics and a secondary battery including the positive electrode can be provided.

Note that the description of these effects does not preclude the presence of other effects. One embodiment of the present invention does not necessarily have all these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1 is a cross-sectional view illustrating a positive electrode.

FIG. 2A to FIG. 2D are diagrams illustrating a positive electrode active material and a conductive material.

FIG. 3A and FIG. 3B are cross-sectional views illustrating a positive electrode active material.

FIG. 4A to FIG. 4C are diagrams showing concentration distributions of additive elements.

FIG. 5A and FIG. 5B are diagrams each showing concentration distributions of additive elements.

FIG. 6 is a diagram illustrating crystal structures of a positive electrode active material.

FIG. 7 is a diagram showing an XRD pattern of a positive electrode active material.

FIG. 8 is a diagram showing an XRD pattern of a positive electrode active material.

FIG. 9A and FIG. 9B are each diagrams showing an XRD pattern of a positive electrode active material.

FIG. 10A to FIG. 10D are diagrams illustrating a process for forming a positive electrode active material.

FIG. 11 is a diagram illustrating a process for forming a positive electrode active material.

FIG. 12A to FIG. 12C are diagrams illustrating a process for forming a positive electrode active material.

FIG. 13A and FIG. 13B are diagrams each illustrating a process of forming a positive electrode.

FIG. 14A is an exploded perspective view of a coin-type secondary battery, FIG. 14B is a perspective view of the coin-type secondary battery, and FIG. 14C is a cross-sectional perspective view thereof.

FIG. 15A illustrates an example of a cylindrical secondary battery, FIG. 15B is an example of the cylindrical secondary battery, FIG. 15C is an example of a plurality of cylindrical secondary batteries, and FIG. 15D is an example of a power storage system including a plurality of cylindrical secondary batteries.

FIG. 16A and FIG. 16B illustrate examples of a secondary battery, and FIG. 16C is a diagram illustrating an internal state of the secondary battery.

FIG. 17A to FIG. 17C are diagrams illustrating examples of a secondary battery.

FIG. 18A and FIG. 18B are diagrams each showing the appearance of a secondary battery.

FIG. 19A to FIG. 19C are diagrams illustrating a method for manufacturing a secondary battery.

FIG. 20A is a perspective view of a battery pack of one embodiment of the present invention, FIG. 20B is a block diagram of the battery pack, and FIG. 20C is a block diagram of a vehicle including the battery pack.

FIG. 21A to FIG. 21D illustrate examples of transport vehicles, and FIG. 21E is a diagram illustrating an example of an artificial satellite.

FIG. 22A and FIG. 22B are diagrams illustrating a building including a secondary battery of one embodiment of the present invention.

FIG. 23A is a diagram illustrating an electric bicycle, FIG. 23B is a diagram illustrating a secondary battery of the electric bicycle, and FIG. 23C is a diagram illustrating a motor scooter.

FIG. 24A to FIG. 24D are diagrams each illustrating an example of an electronic device.

FIG. 25A illustrates an example of a wearable device, FIG. 25B is a perspective view of a watch-type device, and FIG. 25C is a diagram illustrating a side surface of the watch-type device.

FIG. 26 is a graph showing particle size distribution of LCO or the like in Example.

FIG. 27A and FIG. 27B are graphs showing STEM-EDX analysis of LCO in Example.

FIG. 28A to FIG. 28C are graphs showing STEM-EDX analysis of Sample 1 or the like.

FIG. 29A to FIG. 29C are graphs showing STEM-EDX analysis of Sample 1 or the like.

FIG. 30 is an SEM image of a positive electrode.

FIG. 31A to FIG. 31C are graphs each showing a discharge capacity retention rate in charge-discharge cycle test.

FIG. 32A to FIG. 32C are graphs each showing a discharge capacity retention rate in charge-discharge cycle test.

FIG. 33A and FIG. 33B are graphs each showing a result of discharge capacity at rates.

FIG. 34A and FIG. 34B are graphs each showing a result of discharge capacity at rates.

FIG. 35 is a graph showing a result of discharge capacity at rates.

FIG. 36A and FIG. 36B are graphs each showing a result of discharge capacity at rates.

FIG. 37A and FIG. 37B are graphs each showing a result of discharge capacity at rates.

FIG. 38 is a graph showing a result of discharge capacity at rates.

FIG. 39A to FIG. 39C are graphs each showing discharge capacity in a charge-discharge cycle test.

FIG. 40 is a SEM image of a positive electrode.

FIG. 41A to FIG. 41C are graphs each showing a discharge capacity retention rate in charge-discharge cycle test.

FIG. 42A to FIG. 42C are graphs each showing a discharge capacity retention rate in charge-discharge cycle test.

FIG. 43A to FIG. 43C are graphs each showing a result of discharge capacity at rates.

FIG. 44A to FIG. 44C are graphs each showing a result of discharge capacity at rates.

FIG. 45A to FIG. 45C are graphs each showing discharge capacity in a charge-discharge cycle test.

FIG. 46 is a graph showing an electrode density.

FIG. 47 is a graph showing charge-discharge characteristics at low temperatures.

FIG. 48 is a graph showing charge-discharge characteristics at low temperatures.

FIG. 49 is a graph showing charge-discharge characteristics at low temperatures.

FIG. 50 is a graph showing charge-discharge characteristics at low temperatures.

FIG. 51 is a graph showing charge-discharge characteristics at low temperatures.

FIG. 52 is a graph showing charge-discharge characteristics at low temperatures.

FIG. 53 is a graph showing charge-discharge characteristics at low temperatures.

FIG. 54 is a graph showing charge-discharge characteristics at low temperatures.

FIG. 55 is a graph showing charge-discharge characteristics at low temperatures.

FIG. 56A to FIG. 56C are graphs each showing XRD on a high-voltage charged state.

### MODE FOR CARRYING OUT THE INVENTION

Examples of embodiments for carrying out the present invention will be described below with reference to the drawings and the like. Note that the present invention should not be interpreted as being limited to the examples of embodiments given below. Embodiments for carrying out the invention can be changed unless they deviate from the spirit of the present invention.

In this specification and the like, a space group is represented using the short notation of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “−” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure, and the space group R-3m is represented by a composite hexagonal lattice also in this specification and the like unless otherwise specified. In some cases, not only (hki) but also (hkil) is used as the Miller index. Here, i is −(h+k).

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

The theoretical capacity of a positive electrode active material refers to the amount of electricity obtained when all lithium that can be inserted into and extracted from the positive electrode active material is extracted. For example, the theoretical capacity of LiCoO₂ is 274 mAh/g per weight of the positive electrode active material, the theoretical capacity of LiNiO₂ is 274 mAh/g per weight of the positive electrode active material, and the theoretical capacity of LiMn₂O₄ is 148 mAh/g per weight of the positive electrode active material.

The remaining amount of lithium that can be inserted into and extracted from a positive electrode active material is represented by x in a composition formula, e.g., x in LiₓCoO₂. In the case of a positive electrode active material in a lithium-ion secondary battery, x=(theoretical capacity−charge capacity)/theoretical capacity can be satisfied. For example, in the case where a lithium-ion secondary battery using LiCoO₂ as a positive electrode active material is charged to 219.2 mAh/g per weight of the positive electrode active material, the positive electrode active material can be represented by Li_{0.2}CoO₂, i.e., x=0.2. Note that “x in LiₓCoO₂ is small” means, for example, 0.1<x≤0.24.

LiₓCoO₂ to be used for a positive electrode, which has been appropriately synthesized and almost satisfies the stoichiometric proportion, is LiCoO₂ with x=1. It can also be said that LiₓCoO₂ contained in a lithium-ion secondary battery after its discharge ends is also LiCoO₂ with x=1. Here, “discharge ends” means that a voltage becomes 3.0 V or 2.5 V or lower at a current of 100 mA/g or lower per weight of the positive electrode active material, for example.

Charge capacity and/or discharge capacity used for calculation of x in LiₓMO₂ is preferably measured under the condition of no influence by a short circuit and/or decomposition of an electrolyte solution or the like or small influence by the decomposition. For example, data of a lithium-ion secondary battery, suffering from a sudden change of capacity that seems to result from a short circuit, should not be used for calculation of x.

The space group of a positive electrode active material or the like is identified by XRD, electron diffraction, neutron diffraction, or the like. Thus, in this specification and the like, belonging to a space group, being attributed to a space group, or being a space group can be rephrased as being identified as a space group.

Furthermore, when the arrangement of anions is close to a cubic close-packed structure, the arrangement can be regarded as the cubic close-packed structure. The arrangement of anions forming the cubic close-packed structure refers to a state where anions in a second layer are positioned above voids between anions packed in a first layer, and anions in a third layer are placed at the positions that are right above voids between the anions in the second layer and are not right above the anions in the first layer. Accordingly, anions do not necessarily form a precise cubic lattice structure. At the same time, actual crystals always have a defect and thus, analysis results are not necessarily consistent with the theory. For example, in an electron diffraction pattern or an FFT (fast Fourier transform) pattern of a TEM (Transmission Electron Microscope) image or the like, a spot may appear in a position slightly different from a theoretical position. For example, anions can be regarded as forming a cubic close-packed structure when a difference in orientation from a theoretical position is 5° or less or 2.5° or less.

An element distribution indicates a region where an element is successively detected by a successive analysis method to the extent that the detection value is no longer on a noise level.

Note that in this specification and the like, a surface portion of a positive electrode active material is a region ranging from a particle surface to 20 nm or less or 30 nm or less toward an inner portion in a direction perpendicular or substantially perpendicular to the surface. The surface portion is synonymous with the vicinity of a surface and a region in the vicinity of a surface. Note that “perpendicular” or “substantially perpendicular” specifically means that an angle between a direction and a surface is greater than or equal to 80° and less than or equal to 100°. The inner portion refers to a region that is at a larger depth than the surface portion of a positive electrode active material. The inner portion is synonymous with a bulk or a core.

Note that in this specification and the like, a carbonate, a hydroxy group, or the like chemisorbed after formation of a positive electrode active material may be attached to a particle of the positive electrode active material, but the carbonate, the hydroxy group, or the like is not contained in a surface of the particle. Furthermore, an electrolyte solution, a binder, a conductive material, or a compound originating from any of these that are attached to a particle of the positive electrode active material is not contained either in the surface of the particle. Thus, in quantitative analysis of elements contained in the positive electrode active material, correction may be performed to exclude carbon, hydrogen, excess oxygen, excess fluorine, and the like that might be detected in surface analysis.

In the case where the features of individual particles of a positive electrode active material are described in the embodiments and the like described below, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

Note that the description is made on the assumption that materials (such as a positive electrode active material, a negative electrode active material, an electrolyte solution, and a separator) of a secondary battery have not deteriorated unless otherwise specified. A decrease in discharge capacity due to aging treatment and burn-in treatment during the manufacturing process of a secondary battery is not regarded as deterioration. For example, the case where discharge capacity is higher than or equal to 97% of the rated capacity of a secondary battery composed of a cell or an assembled battery can be regarded as a non-deteriorated state. The rated capacity conforms to JIS C 8711:2019 in the case of a secondary battery for a portable device. The rated capacity of other secondary batteries conform to JIS described above, JIS for electric vehicle propulsion, industrial use, and the like, standards defined by IEC, and the like.

In this specification and the like, in some cases, materials included in a secondary battery that have not deteriorated are referred to as initial products or materials in an initial state, and materials that have deteriorated (have discharge capacity lower than 97% of the rated capacity of the secondary battery) are referred to as products in use, materials in a used state, products that are already used, or materials in an already-used state.

In this specification and the like, a lithium-ion secondary battery refers to a battery in which lithium ions are used as carrier ions; however, carrier ions in the present invention are not limited to lithium ions. For example, as the carrier ions in the present invention, alkali metal ions or alkaline earth metal ions can be used; specifically, sodium ions or the like can be used. In that case, the present invention can be understood by replacing lithium ions with sodium ions or the like. Furthermore, in the case where there is no limitation on carrier ions, the term “secondary battery” is sometimes used.

In this specification and the like, the (001) plane, the (003) plane, and the like are sometimes collectively referred to as the (00l) plane. In this specification and the like, the (00l) plane is sometimes referred to as a C-plane, a basal plane, or the like. In lithium cobalt oxide, lithium has a two-dimensional diffusion path. That is, it can be said that the diffusion path of lithium exists along a plane. In this specification and the like, a plane where the diffusion path of lithium is exposed, i.e., a plane other than a plane where lithium is inserted and extracted (specifically, the (00l) plane), is sometimes referred to as an edge plane.

It can be said in this specification and the like that when surface unevenness information in one cross section of an active material is converted into numbers with measurement data, a smooth surface of the active material has a surface roughness of at least 10 nm or less. The one cross section in this specification and the like is a cross section obtained in observation using a STEM (Scanning Transmission Electron Microscope) image, for example.

In this specification and the like, a secondary particle refers to a particle formed by aggregation of primary particles. In this specification and the like, a primary particle refers to a particle whose appearance shows no grain boundary. In this specification and the like, a single particle refers to a particle whose appearance shows no grain boundary. In this specification and the like, a single crystal refers to a crystal whose inner portion has no grain boundary, whereas a polycrystal refers to a crystal whose inner portion has a grain boundary. A polycrystal may be regarded as a group of a plurality of crystallites, and a grain boundary may be regarded as an interface existing between two or more crystallites. Note that crystallites in a polycrystal are preferably in the same direction.

In this specification and the like, a median diameter (D50) is simply referred to as a median diameter in some cases.

In this specification and the like, the phrase “A and/or B” is an example of an expression that comprehends only A, only B, and A and B.

### Embodiment 1

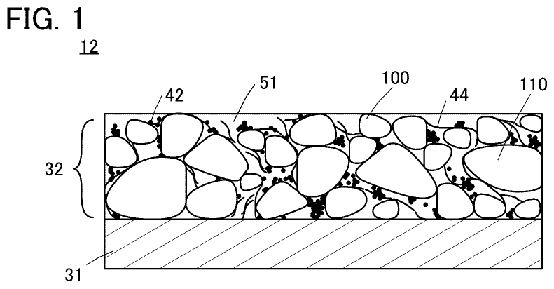

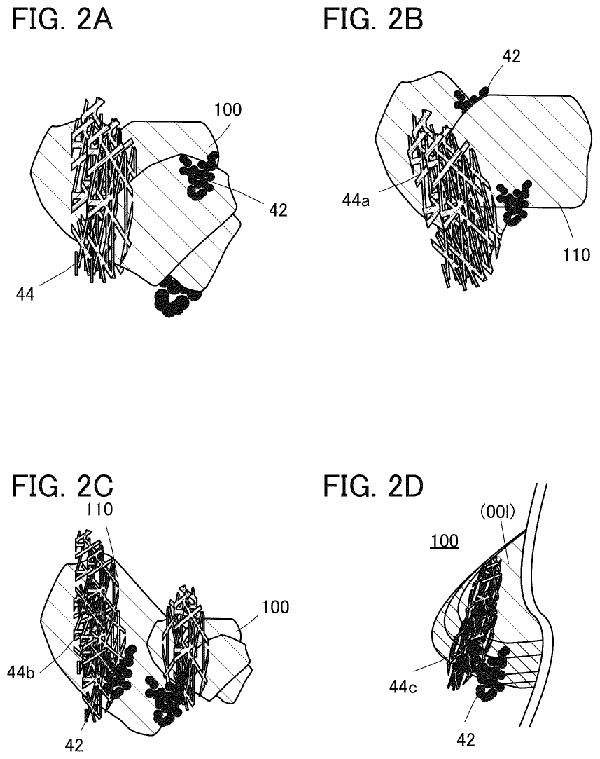

In this embodiment, structure examples of a positive electrode included in a secondary battery of the present invention will be described with reference to FIG. 1 to FIG. 2D and the like.

### <Positive Electrode>

FIG. 1 is a cross-sectional view of a positive electrode 12. The positive electrode 12 includes a positive electrode current collector 31 and a positive electrode active material layer 32. The positive electrode active material layer 32 includes a first positive electrode active material 100, a second positive electrode active material 110, a first conductive material 42, a second conductive material 44, and a space 51. A feature of the positive electrode of the present invention is to include two or more conductive materials, and FIG. 1 illustrates an example in which two conductive materials are included. The first conductive material 42 is preferably a particulate conductive material, and the second conductive material 44 is preferably a fibrous conductive material. In the present invention, the two or more conductive materials preferably have different shapes. Furthermore, in the present invention, the weight of the particulate conductive material is preferably larger than or equal to the weight of the fibrous conductive material. With this structure, the conductivity of the positive electrode can be made appropriate, and the conductivity of the positive electrode can be increased as compared with the case where one conductive material is included.

FIG. 2A to FIG. 2D illustrate examples of enlarged views of the first positive electrode active material 100 or the second positive electrode active material 110. The positive electrode of the present invention has a feature of including two or more conductive materials, and thus there is no particular limitation on the positive electrode active material. Note that the use of lithium cobalt oxide as the first positive electrode active material 100 or the second positive electrode active material 110 can bring about an excellent effect of the present invention. Lithium cobalt oxide has a layered rock-salt crystal structure, and thus a positive electrode active material having another layered rock-salt crystal structure is also expected to bring about a similar effect.

In the positive electrode of the present invention, two or more materials having different particle diameters are preferably used as the positive electrode active materials. Thus, FIG. 1 and FIG. 2C each illustrate a structure including the second positive electrode active material 110 with a large median diameter (D50) in addition to the first positive electrode active material 100. The median diameter (D50) of the second positive electrode active material 110 is preferably greater than or equal to 1.2 times and less than or equal to 3 times, further preferably greater than or equal to 1.5 times and less than or equal to 2 times the median diameter (D50) of the first positive electrode active material 100. The content of the second positive electrode active material 110 is preferably greater than or equal to 1 time and less than or equal to 5 times, further preferably greater than or equal to 2 times and less than or equal to 4 times the content of the first positive electrode active material 100. The content can be replaced with a weight ratio or a weight. Needless to say, an effect can also be obtained in the case where positive electrode active materials formed to have the same particle diameters are used in the positive electrode of the present invention; thus, FIG. 2A illustrates an example of the case where the first positive electrode active material 100 is included and FIG. 2B illustrates an example of the case where the second positive electrode active material 110 is included.

### <Conductive Material>

A metal material or a carbon material can be used as both the first conductive material 42 and the second conductive material 44. As the carbon material, carbon black, Ketjen black (registered trademark), acetylene black (hereinafter referred to as AB in some cases), or the like can be used as the first conductive material 42, which is a particulate conductive material. Such particulate conductive materials may be aggregated in the positive electrode 12. The aggregated state is referred to as an aggregate in some cases. Carbon fiber or the like can be used as the second conductive material 44, which is a conductive material different from the particulate conductive material. Carbon fiber can be regarded as a string-like or fibrous conductive material. Instead of the carbon fiber, graphene or a graphene compound may be used as the second conductive material 44. Graphene or a graphene compound can be regarded as a sheet-like conductive material. Furthermore, graphene or a graphene compound may be added as a third conductive material.

### <Carbon Fiber>

Examples of carbon fiber include VGCF (registered trademark), carbon fiber, and carbon nanotube (hereinafter, referred to as CNT in some cases). In addition, CNT includes a layer of carbon atoms; in the case where the number of layers is one, the CNT is referred to as a single-wall nanotube; in the case where the number of layers is multiple, the CNT is referred to as a multi-wall nanotube; and examples of the multi-wall nanotube include a double-wall nanotube including two layers. Carbon fiber forms an assembly in some cases. Furthermore, carbon fiber has a long axis or a long fiber length and thus forms a tangled state in some cases; this state is referred to as an assembly. Examples of the tangled state include a state where one carbon fiber is tangled and a state where a plurality of carbon fiber are tangled with each other.

As illustrated in FIG. 1, the second conductive material 44 described above can be positioned along the first positive electrode active material 100 and/or the second positive electrode active material 110 in the positive electrode 12. The second conductive material 44 preferably forms an assembly, in which the second conductive material 44 is easily positioned so as to cover the first positive electrode active material 100 and/or the second positive electrode active material 110; be along the first positive electrode active material 100 and/or the second positive electrode active material 110; stick to the first positive electrode active material 100 and/or the second positive electrode active material 110; attach to the first positive electrode active material 100 and/or the second positive electrode active material 110; cling to the first positive electrode active material 100 and/or the second positive electrode active material 110; wrap the first positive electrode active material 100 and/or the second positive electrode active material 110; bind the first positive electrode active material 100 and/or the second positive electrode active material 110; or wind around the first positive electrode active material 100 and/or the second positive electrode active material 110.

The carbon fiber positioned in this manner can inhibit a crack, a fracture, or a shift in the first positive electrode active material 100; thus, a highly safe secondary battery can be provided. In order to effectively inhibit a crack, a fracture, or a shift, carbon fiber is preferably positioned in a plane of the first positive electrode active material 100 where a crack, a fracture, or a shift is likely to occur. In this paragraph, the first positive electrode active material 100 may be replaced with the second positive electrode active material 110. In addition, it is probable that the first positive electrode active material 100 having a smaller median diameter than the second positive electrode active material 110 is more likely to be wrapped by carbon fiber and thus, has a significant effect of inhibiting a crack or the like.

The terms “cover”, “be along”, “stick to”, “attach to”, “cling to”, “wrap”, “bind”, and “wind around”, described above mean that the positive electrode active material and the conductive material are physically in close contact with each other; however, in the present invention, the terms are not limited to physical close contact, and include, for example, the following concepts: a case where covalent bonding occurs, a case where bonding by Van der Waals force occurs, a case where a conductive material is embedded in surface roughness of a positive electrode active material, and a case where a conductive material and a positive electrode active material that are not in contact with each other are electrically connected with an object interposed therebetween. Specifically, the states “cover”, “be along”, “stick to”, “attach to”, “cling to”, “wrap”, “bind”, and the like described above can be observed in a surface SEM image of a positive electrode or a cross-sectional SEM image of a positive electrode, and a positive electrode active material and a conductive material are at least in contact with each other in a surface SEM image of a positive electrode or a cross-sectional SEM image of a positive electrode. As long as a positive electrode active material and a conductive material are in contact with each other in a surface SEM image of a positive electrode or a cross-sectional SEM image of a positive electrode, there is no limitation on the kind and intensity of attracting force between the positive electrode active material and the conductive material. Furthermore, a binder may be positioned at part of the interface between the positive electrode active material and the conductive material. This is because the above effect of inhibiting a crack or the like is not hindered by the binder.

FIG. 2A illustrates the first conductive material 42, the second conductive material 44, and the first positive electrode active material 100. The state illustrated in FIG. 2A can be observed in a surface SEM image, typically. FIG. 2A illustrates a state where the first conductive material 42 is aggregated and the second conductive material 44 forms a tangled state. Needless to say, the first conductive material 42 and the second conductive material 44 may be tangled with each other. The first conductive material 42 or the second conductive material 44 is preferably positioned to stick to at least the first positive electrode active material 100 or may stick to a plurality of first positive electrode active materials 100. The term “stick” can be replaced with the term “cover”, “be along”, “attach”, “cling”, “wrap”, or “bind”. AB can be used as the first conductive material 42, and CNT can be used as the second conductive material 44. Note that in this specification and the like, in some cases, an aggregated AB is referred to as an AB aggregate, and a CNT forming a tangled state is referred to as a CNT assembly.

FIG. 2B illustrates the positive electrode 12 including the second positive electrode active material 110 with a large median diameter (D50). The first conductive material 42 is aggregated, and a second conductive material 44b forms a tangled state. The first conductive material 42 and the second conductive material 44b may be tangled with each other. The first conductive material 42 or the second conductive material 44b is preferably positioned to stick to at least the second positive electrode active material 110 or may stick to a plurality of second positive electrode active materials 110. The term “stick” can be replaced with the term “cover”, “be along”, “attach”, “cling”, “wrap”, or “bind”. AB can be used as the first conductive material 42, and CNT can be used as the second conductive material 44.

FIG. 2C illustrates the positive electrode 12 including both the first positive electrode active material 100 with a small median diameter (D50) and the second positive electrode active material 110 with a large median diameter (D50). In FIG. 2C, the first conductive material 42 is aggregated, a second conductive material 44c forms a tangled state, and the first conductive material 42 and the second conductive material 44c are also tangled with each other. The second conductive material 44c forms an assembly, and the first conductive material 42 is positioned inside the assembly in some cases. The first conductive material 42 or the second conductive material 44c is preferably positioned to stick to at least the first positive electrode active material 100 or may stick to the plurality of first positive electrode active materials 100 and/or the plurality of second positive electrode active materials 110. The term “stick” can be replaced with the term “cover”, “be along”, “attach”, “cling”, “wrap”, or “bind”. AB can be used as the first conductive material 42, and CNT can be used as the second conductive material 44.

FIG. 2D is an enlarged view of the first positive electrode active material 100. The first positive electrode active material 100 has a layered rock-salt structure. In the enlarged view, as examples, the (00l) plane of the first positive electrode active material 100 is illustrated, and the first conductive material 42 and the second conductive material 44c that stick to a plane other than the (00l) plane are illustrated. When the first conductive material 42 and the second conductive material 44c stick to a plane other than the (00l) plane of the first positive electrode active material 100, the first positive electrode active material 100 can be inhibited from cracking from a plane other than the (00l) plane and can have an improved safety.

Carbon fiber or a carbon fiber assembly can bind a plurality of positive electrode active materials together and can be positioned along the plurality of positive electrode active materials. Such carbon fiber or a carbon fiber assembly is preferable as a conductive material for supplying a long-range conductive path. For example, a conductive path with the first positive electrode active material 100 that is distant from the positive electrode current collector 31 can be secured, which enables rapid charge and discharge. Furthermore, the carbon fiber or carbon fiber assembly even in low content enables favorable charge-discharge cycle performance, in which case the content of the first positive electrode active material 100 in the positive electrode 12 can be increased, which is preferable.

The specific surface area of VGCF (registered trademark) among carbon fiber is preferably less than or equal to 100 m²/g, further preferably greater than or equal to 60 m²/g, still further preferably greater than or equal to 20 m²/g. The specific surface area of a CNT among carbon fiber is preferably greater than or equal to 500 m²/g, further preferably greater than or equal to 650 m²/g, still further preferably greater than or equal to 800 m²/g. The specific surface area is, for example, a value measured by a BET method.

The major axis length or the fiber length of VGCF (registered trademark) among carbon fiber is preferably greater than or equal to 1 μm and less than or equal to 100 μm, further preferably greater than or equal to 2 μm and less than or equal to 20 μm. The major axis length or the fiber length of a CNT among carbon fiber is preferably greater than or equal to 100 μm and less than or equal to 600 μm, further preferably greater than or equal to 200 μm and less than or equal to 500 μm. Carbon fiber having a major axis length or a fiber length that is larger than the median diameter of the positive electrode active material can be placed across a plurality of positive electrode active materials; thus, the present invention is not limited to the above values. Furthermore, since carbon fiber forms a tangled state, the major axis length or the fiber length of one carbon fiber is not so important, and the major axis length in the tangled state is also important for the conductive material.

Furthermore, in the case where a cross section of one carbon fiber can be regarded as a circle, the average diameter of the carbon fiber is preferably greater than or equal to 1 nm and less than or equal to 180 nm, further preferably greater than or equal to 2 nm and less than or equal to 150 nm. The average diameter of VGCF (registered trademark) is large, which can be greater than or equal to 100 nm and less than or equal to 180 nm, preferably greater than or equal to 130 nm and less than or equal to 160 nm. A VGCF (registered trademark) having a large average diameter has high dispersibility. The average diameter of a CNT is small, which is can be greater than or equal to 1 nm and less than or equal to 100 nm, preferably greater than or equal to 1 nm and less than or equal to 50 nm, further preferably greater than or equal to 3 nm and less than or equal to 5 nm.

Since the above-described length and the above-described average diameter are satisfied, carbon fiber is likely to easily form an assembly. Carbon fiber forming an assembly can inhibit occurrence of a crack, a fracture, a shift, or the like in the positive electrode active material while functioning as a conductive path for the positive electrode active material, and can inhibit deterioration of a plurality of positive electrode active materials and the like due to charge-discharge cycles. In particular, a CNT has a small average diameter and thus tends to form an assembly.

By reference to the powder volume resistivity of VGCF (registered trademark), the volume resistivity of carbon fiber is preferably lower than or equal to 1×10⁻³ Ω·cm at a pressure of 64 MPa and/or lower than or equal to 1×10⁻² Ω·cm at a pressure of 13 MPa. By reference to the powder volume resistivity of CNT, the volume resistivity of carbon fiber is preferably lower than or equal to 1×10⁻² Ω·cm at a pressure of 64 MPa and/or lower than or equal to 3×10⁻² Ω·cm at a pressure of 13 MPa. Furthermore, by reference to the powder volume resistivity of CNT, the volume resistivity of carbon fiber is preferably lower than or equal to 1×10⁻² Ω·cm and higher than 1×10⁻³ Ω·cm at a pressure of 64 MPa and/or lower than or equal to 3×10⁻² Ω·cm and higher than 9×10⁻³ Ω·cm at a pressure of 13 MPa.

Instead of carbon fiber, graphene or a graphene compound may be used as the second conductive material 44. In addition, graphene or a graphene compound may be newly added. Graphene or a graphene compound can have a function of a conductive path and is a sheet-like conductive material, and thus can inhibit a crack, a fracture, a shift, or the like from occurring in the positive electrode active material, like a fibrous conductive material, leading to an expected effect of inhibiting deterioration of the positive electrode active material due to charge-discharge cycles.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably curved.

In the case where the positive electrode active material layer 32 includes the first positive electrode active material 100 and/or the second positive electrode active material 110, the first conductive material 42, and the second conductive material 44, the total content of the first conductive material 42 and the second conductive material 44 to the total amount of the positive electrode active material layer 32 is preferably greater than or equal to 0.1 wt % and less than or equal to 10 wt %, further preferably greater than or equal to 1 wt % and less than or equal to 5 wt %. The conductive materials having different shapes are preferably used, in which case the proportion of the positive electrode active material in the positive electrode active material layer 32 can be increased. Furthermore, although the proportion between the first conductive material 42 and the second conductive material 44 is not limited, the proportion of the second conductive material 44 is preferably lower than or equal to the proportion of the first conductive material 42.

The positive electrode active material layer 32 may include a binder in addition to the first positive electrode active material 100, the first conductive material 42, and the second conductive material 44. Although the binder can strengthen the positive electrode 12, the binder can be unnecessary for the positive electrode 12 of one embodiment of the present invention. For example, when the second conductive material 44 forms a tangled state to hold the first positive electrode active material 100, the binder can be unnecessary. The binder is preferably unnecessary, in which case the proportion of the positive electrode active material can be further increased. In addition, the weight of the positive electrode active material per unit volume of the positive electrode active material layer is referred to as an active material density or a positive electrode active material density, or the proportion of the positive electrode active material may be referred to as an active material density.

There is an index called electrode density, and the electrode density is the sum of the weights of the positive electrode active material, the first conductive material, and the second conductive material per unit volume of the positive electrode active material layer 32. In the case where the positive electrode active material layer 32 includes a binder, the electrode density is the sum of the weights of the positive electrode active material, the first conductive material, the second conductive material, and the binder per unit volume of the positive electrode active material layer 32. In the case of including the binder, the electrode density of the positive electrode 12 is preferably higher than or equal to 3.1 g/cm³ and lower than or equal to 3.7 g/cm³, further preferably higher than or equal to 3.2 g/cm³ and lower than or equal to 3.5 g/cm³ or higher than or equal to 3.5 g/cm³ and lower than or equal to 3.7 g/cm³.

### <Electrolyte Solution>

The space 51 in e.g., FIG. 1 is filled with an electrolyte solution in some cases. The electrolyte solution can contain an organic solvent and lithium salt (also referred to as an electrolyte) dissolved in the organic solvent. As the organic solvent, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or a mixture of two or more of these solvents can be used as a mixture solvent.

A mixture solvent contains ethylene carbonate (EC), ethyl methyl carbonate (EMC), and dimethyl carbonate (DMC). When a total content of the ethylene carbonate, the ethyl methyl carbonate, and the dimethyl carbonate is 100 vol %, a mixture solvent in which the volume ratio between the ethylene carbonate, the ethyl methyl carbonate, and the dimethyl carbonate is x:y:100-x-y (where 5≤x≤35 and 0<y<65) can be used. More specifically, a mixed solvent containing EC, EMC, and DMC at EC:EMC:DMC=30:35:35 (volume ratio) can be used. Note that the volume ratio may be a volume ratio before mixing to make the mixed solvent, and mixing for making the mixed solvent may be performed at room temperature (typically 25° C.).

EC is a cyclic carbonate and has a high relative permittivity, and thus has an effect of promoting dissociation of a lithium salt. Meanwhile, EC has high viscosity and has a high freezing point (melting point) of 38° C.; thus, it is difficult to use EC alone as the solvent in a low-temperature environment. Then, the solvent specifically described in one embodiment of the present invention contains not only EC but also EMC and DMC. EMC is a chain carbonate and has an effect of decreasing the viscosity of an electrolyte solution, and the freezing point is −54° C. In addition, DMC is also a chain carbonate and has an effect of decreasing the viscosity of an electrolyte solution, and the freezing point is −43° C. An electrolyte solution formed using a mixed solvent where EC, EMC, and DMC having such physical properties are mixed in a volume ratio of x:y:100-x-y (note that 5≤x≤35 and 0<y<65) with the total content of these three solvents of 100 vol % has a freezing point of −40° C. or lower as a feature.

Alternatively, the use of one or more ionic liquids (room temperature molten salts) which have features of non-flammability and non-volatility as the organic solvent can prevent explosion, ignition, and the like of a power storage device even when the power storage device internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the lithium salt (electrolyte) dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (Li(C₂O₄)₂, LiBOB) can be used, or two or more of these lithium salts can be used in an appropriate combination at an appropriate ratio.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent in which the electrolyte is dissolved is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. For example, a polymer having a polyalkylene oxide structure, such as polyethylene oxide (PEO); PVDF; polyacrylonitrile; and a copolymer containing any of them can be used. For example, PVDF-HFP, which is a copolymer of PVDF and hexafluoropropylene (HFP), can be used. The formed polymer may be porous.

For the positive electrode current collector 31, a material that has high conductivity, such as a metal like stainless steel, gold, platinum, aluminum, or titanium, or an alloy thereof can be used. It is preferable that a material used for the positive electrode current collector not be dissolved at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The positive electrode current collector 31 can have a foil-like shape, a plate-like shape, a sheet-like shape, a net-like shape, a punching-metal shape, an expanded-metal shape, or the like as appropriate. The positive electrode current collector 31 preferably has a thickness greater than or equal to 5 μm and less than or equal to 30 μm.

### <Binder>

The binder is preferably provided to bind various members together, for example, to bind positive electrode active materials, to bind conductive materials, or to bind a positive electrode active material and a positive electrode current collector. Furthermore, preferably, the binder exhibits thermal stability and is electrochemically stable at a positive electrode potential. As the binder, a rubber material such as styrene-butadiene rubber (SBR), styrene-isoprene-styrene rubber, acrylonitrile-butadiene rubber, butadiene rubber, or an ethylene-propylene-diene copolymer is preferably used, for example. Fluororubber can also be used as the binder.

As the binder, for example, a water-soluble polymer is preferably used. As the water-soluble polymer, a polysaccharide can be used, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is further preferable that such a water-soluble polymer be used in combination with any of the above rubber materials.

Alternatively, as the binder, a polymer material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used. A polymer material is preferable because it is flexible and thus enables an increase in electrode density. Although having a CH bond and a CF bond, PVDF is preferable because it has no polarity as a whole and thus is easily dispersed appropriately in a positive electrode.

A plurality of the above-described materials may be used in combination for the binder. Alternatively, a binder may be unnecessary because the binder is not a material that directly contributes to battery characteristics.

For the binder, a material having a significant viscosity modifying effect (the material is also referred to as a thickener in some cases) and another material may be used in combination. For example, a rubber material or the like has high adhesion and high elasticity but may have difficulty in viscosity modification when mixed in a solvent. In such a case, a rubber material and a material having a significant viscosity modifying effect are preferably mixed. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

The above-described materials used for the binder are each preferably dissolved in an organic solvent and then used. As the organic solvent, methyl alcohol, ethyl alcohol, propyl alcohol, diethylformamide, dimethylacetoamide, N-methyl-2-pyrrolidone (NMP), dimethylimidazolidinone, or the like can be used. This organic solvent is used to obtain slurry in some cases, and the organic solvent is referred to as a dispersion medium in some cases.

### <Negative Electrode>

The negative electrode includes a negative electrode active material layer and a negative electrode current collector. The negative electrode active material layer includes a negative electrode active material and may further include a conductive material and a binder.

### <Negative Electrode Active Material>

As the negative electrode active material, for example, an alloy-based material or a carbon material can be used.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements enable higher capacity than carbon; in particular, silicon has a high theoretical capacity of 4200 mAh/g per weight of the negative electrode active material. For this reason, silicon is preferably used for the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases.

In this specification and the like, “SiO” refers to silicon monoxide, for example. SiO can alternatively be expressed as SiOₓ. Here, it is preferable that x be 1 or an approximate value of 1. For example, x is preferably greater than or equal to 0.2 and less than or equal to 1.5, and preferably greater than or equal to 0.3 and less than or equal to 1.2.

As the carbon material, graphite, graphitizing carbon (soft carbon), non-graphitizing carbon (hard carbon), carbon fiber (a carbon nanotube), graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used here. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of lithium metal (higher than or equal to 0.05 V and lower than or equal to 0.3 V vs. Li/Li⁺) when lithium ions are inserted into graphite (when a lithium-graphite intercalation compound is formed). For this reason, a lithium ion battery using graphite can have a high operating voltage. In addition, graphite is preferred because of its advantages such as relatively high capacity per unit volume, relatively small volume expansion, low cost, and a higher level of safety than that of lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), or molybdenum dioxide (MoO₂) can be used.

Alternatively, as the negative electrode active material, Li₃₋ₓMₓN (M=Co, Ni, or Cu) with a Li₃N structure, which is a nitride of lithium and a transition metal, can be used. For example, Li_{2.6}Co_{0.4}N is preferable because of its high discharge capacity (900 mAh/g and 1890 mAh/cm³ per weight of the negative electrode active material).

A nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that even in the case of using a material containing lithium ions as a positive electrode active material, a nitride of lithium and a transition metal can be used as the negative electrode active material by extracting the lithium ions contained in the positive electrode active material in advance.

A material that causes a conversion reaction can also be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

As another mode of the negative electrode, a negative electrode that does not contain a negative electrode active material after completion of the fabrication of the battery may be used. The negative electrode that does not contain a negative electrode active material can be, for example, a negative electrode which includes only a negative electrode current collector at the time of completion of the fabrication of the battery and in which lithium ions extracted from the positive electrode active material due to charge of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

In the case of using the negative electrode that does not contain a negative electrode active material, a film for making lithium deposition uniform may be provided over the negative electrode current collector. For the film for making lithium deposition uniform, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over the negative electrode current collector relatively easily, and thus is suitable for the film for making lithium deposition uniform. Moreover, as the film for making lithium deposition uniform, for example, a metal film that forms an alloy with lithium can be used. As the metal film that forms an alloy with lithium, for example, a magnesium metal film can be used. It is suitable for the film for making lithium deposition uniform because lithium and magnesium form a solid solution in a wide range of compositions.

In the case of using the negative electrode that does not contain a negative electrode active material, a negative electrode current collector having projections and depressions can be used. In the case of using the negative electrode current collector having projections and depressions, a depression of the negative electrode current collector becomes a cavity in which lithium contained in the negative electrode current collector is easily deposited, so that the lithium can be inhibited from having a dendrite-like shape when being deposited.

For the conductive material and the binder that can be included in the negative electrode active material layer, materials similar to those for the conductive material and the binder that can be included in the positive electrode active material layer can be used.

### <Negative Electrode Current Collector>

For the negative electrode current collector, copper or the like can also be used in addition to a material similar to that of the positive electrode current collector. Note that a material that does not alloy with carrier ions of lithium or the like is preferably used for the negative electrode current collector.

### <Separator>

When the electrolyte includes an electrolyte solution, a separator is positioned between the positive electrode and the negative electrode. As the separator, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably processed into a bag-like shape to wrap any one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charge at high voltage and discharge can be inhibited and thus the reliability of the secondary battery can be increased. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### <Exterior Body>

The positive electrode 12 in FIG. 1 is used, and a stack in which a separator is provided over the positive electrode and a negative electrode is provided over the separator is put in an exterior body or the like (a metal can may be used instead of the exterior body) and an electrolyte solution is injected into the exterior body, whereby a secondary battery can be manufactured.

For an exterior body included in the secondary battery, a metal material such as aluminum and/or a resin material can be used, for example. A film-like exterior body can also be used. As the film, it is possible to use, for example, a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. An aluminum-containing film having a three-layer structure is sometimes referred to as an aluminum laminate film.

The contents of this embodiment can be freely combined with the contents of the other embodiments.

### Embodiment 2

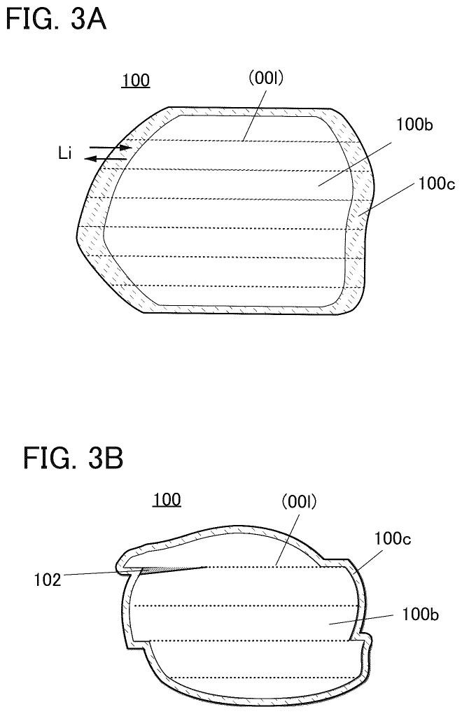

In this embodiment, a positive electrode active material will be described with reference to FIG. 3 to FIG. 6 and the like.

### <Positive Electrode Active Material>

A positive electrode active material needs to contain a transition metal that can play a role in an oxidation-reduction reaction in order to maintain a neutrally charged state even when lithium ions are inserted and extracted. It is preferable that the positive electrode active material of one embodiment of the present invention mainly contain cobalt as the transition metal playing a role in an oxidation-reduction reaction. In addition to cobalt, at least one or two or more selected from nickel and manganese may be used. Containing cobalt at greater than or equal to 75 atomic %, preferably greater than or equal to 90 atomic %, further preferably greater than or equal to 95 atomic % as the transition metal contained in the positive electrode active material brings many advantages such as relatively easy synthesis, easy handling, and excellent cycle performance, which is preferable. Such cobalt is referred to as a main component of the positive electrode active material or a main component of the transition metal of the positive electrode active material.

As the positive electrode active material, lithium cobalt oxide is preferably used. The lithium cobalt oxide can also be referred to as a composite oxide containing lithium, cobalt, and oxygen. Note that the composition of the lithium cobalt oxide that is the positive electrode active material is not strictly limited to Li:Co:O=1:1:2. Lithium cobalt oxide has a layered rock-salt crystal structure and includes a (00l) plane and a plane other than the (00l) plane, and lithium ions can be inserted into and extracted from the plane other than the (00l) plane.

### <Additive Element>

Furthermore, the positive electrode active material preferably contains an additive element. As examples of the additive element, magnesium (Mg), fluorine (F), nickel (Ni), and aluminum (Al) are given, and in addition to them, titanium (Ti), zirconium (Zr), vanadium (V), iron (Fe), manganese (Mn), chromium (Cr), niobium (Nb), arsenic (As), zinc (Zn), silicon (Si), sulfur (S), phosphorus (P), boron (B), bromine (Br), beryllium (Be), and the like are given.

Note that as the additive element, magnesium, fluorine, nickel, aluminum, titanium, zirconium, vanadium, iron, manganese, chromium, niobium, arsenic, zinc, silicon, sulfur, phosphorus, boron, bromine, or beryllium is not necessarily contained.

When the positive electrode active material is substantially free from manganese, for example, the above advantages such as relatively easy synthesis, easy handling, and excellent cycle performance are enhanced. The weight of manganese contained in the positive electrode active material is preferably less than or equal to 600 ppm, further preferably less than or equal to 100 ppm, for example.

FIG. 3A and FIG. 3B show structure examples of the first positive electrode active material 100 of one embodiment of the present invention. FIG. 3A and FIG. 3B each show a (00l) plane of a layered rock-salt crystal structure, and a plane other than the (00l) plane in FIG. 3A is shown with arrows indicating insertion and extraction of lithium. Although a structure example of the first positive electrode active material 100 is described in this embodiment, the second positive electrode active material 110 with a different median diameter (D50) has a similar structure.

As illustrated in FIG. 3A, the first positive electrode active material 100 preferably includes a surface portion 100c and an inner portion 100b. The surface portion 100c is preferably along the periphery of the first positive electrode active material 100; however, the surface portion 100c being along the periphery do not need to have a uniform thickness. As illustrated in FIG. 3A, the surface portion 100c may have an uneven thickness. The surface portion 100c is a region containing an additive element in addition to an element contained in the first positive electrode active material 100. It can also be said that the thickness of the surface portion 100c varies depending on the distribution of the additive element. Note that the thickness of the surface portion 100c may also be referred to as a distance from the particle surface of the positive electrode active material 100 in the depth direction.

A typical example of the additive element contained in the surface portion 100c is magnesium. The bonding strength of magnesium with oxygen is high, thereby inhibiting release of oxygen around magnesium, and thus the surface portion 100c is a region where oxygen release can be inhibited. The above-described surface portion 100c may be referred to as a shell region. The inhibition of oxygen release improves the safety of a secondary battery.

Since the surface portion 100c contains an additive element, the surface portion 100c is a region having higher resistance than the inner portion 100b. That is, a positive electrode active material including the surface portion 100c may have higher resistance than a positive electrode active material not including the surface portion 100c. The high resistance can be demonstrated by powder resistance described later.

As the additive element contained in the surface portion 100c, an element other than magnesium may be used; in order to obtain the above effect, an element regarded as having at least a high bonding strength with oxygen is preferably used. Other than magnesium, aluminum, nickel, and the like are given as examples. In order to obtain the above effect, the surface portion 100c may contain, as the additive element, aluminum and/or nickel in addition to magnesium.

The surface portion of the first positive electrode active material 100 includes a region having the (00l) plane and a region having the plane other than the (00l) plane. The additive element is likely to be added through the region having the plane where lithium ions are diffused as shown by arrows in FIG. 3A, that is, the plane other than the (00l) plane. That is, in the surface portion, the additive element distribution is sometimes different between the region having the (00l) plane and the region having the plane other than the (00l) plane. For example, magnesium is diffused more easily in the region having the plane other than the (00l) plane than in the region having the (00l) plane. Thus, in the surface portion 100c containing magnesium, the thickness of the region having the (00l) plane is sometimes smaller than the thickness of the region having the plane other than the (00l) plane, as illustrated in FIG. 3A.

As described later, in the first positive electrode active material 100 containing the additive element such as magnesium, the breakage of the crystal structure can be inhibited even in high-voltage charge. Thus, a secondary battery including the first positive electrode active material 100 can have a high charge voltage and can achieve high capacity.

The first positive electrode active material 100 illustrated in FIG. 3B is a structure example including a crack 102. This first positive electrode active material 100 also has the effect described above with reference to FIG. 3A by including the surface portion 100c.

The crack 102 may be referred to as a region with a shifted crystal plane or a region cracked at a crystal plane, and is often generated along the (00l) plane. At the above-described crack 102, a new plane is exposed. The new plane does not include the surface portion 100c; thus, the first positive electrode active material 100 preferably has an extremely small number of cracks 102. When the first positive electrode active material 100 is observed with a surface SEM or a cross-sectional SEM, for example, the number of observable cracks 102 in one particle of the positive electrode active material is preferably greater than or equal to 0 and less than or equal to 5.

Generation of the crack 102 is sometimes triggered by pressure application following application of slurry for the positive electrode on the positive electrode current collector. Thus, to reduce cracks, the pressure of a press machine in a manufacturing process of the positive electrode is preferably a linear pressure lower than or equal to 500 kN/m, further preferably a linear pressure lower than or equal to 300 kN/m, still further preferably a linear pressure lower than or equal to 250 kN/m, for example. During pressure application with use of the press machine, rollers are preferably heated. The heating melts a binding agent in the slurry for the positive electrode, which can strengthen the bonds between the positive electrode active materials, between the positive electrode active material and a conductive material, and between the positive electrode active material and the positive electrode current collector, for example.

As illustrated in FIG. 3A, the first positive electrode active material 100 preferably has a smooth surface as a whole. In other words, the first positive electrode active material 100 preferably has a shiny surface as a whole. The first positive electrode active material 100 can be regarded as having no corner or being rounded.

### <Crystallinity>

The first positive electrode active material 100 preferably has high crystallinity and is further preferably a single crystal or a polycrystal. The positive electrode active material 100 is preferably subjected to initial heating described in Embodiment 3 to have high crystallinity. It is particularly preferable that the first positive electrode active material 100 include a single crystal, in which case a crack is unlikely to be generated even when the volume of the first positive electrode active material 100 is changed due to charge and discharge. Furthermore, when the first positive electrode active material 100 is a single crystal, a secondary battery using the first positive electrode active material 100 is presumably unlikely to ignite and can have a high level of safety.

### <Median Diameter (D50) of Positive Electrode Active Material>

The median diameter (D50) of the first positive electrode active material 100 of one embodiment of the present invention is preferably small. The allowable range of the median diameter is described. When the positive electrode active material is too small, application might be difficult to perform in the formation of the positive electrode. Alternatively, when the positive electrode active material is too small, the surface area becomes too large, which might cause an excessive reaction between a positive electrode active material surface and an electrolyte. Alternatively, when the positive electrode active material is too small, a large amount of conductive material sometimes needs to be mixed, which might lead to a decrease in capacity. In consideration of the above, the median diameter (D50) of the positive electrode active material is preferably greater than or equal to 1 μm. The median diameter (D50) of the minimum particle of the positive electrode active material is preferably greater than or equal to 100 nm. The positive electrode active material with a small median diameter (D50) is preferable because a shifted region is unlikely to be caused. The positive electrode active material with a small median diameter (D50) is preferable because a crack is unlikely to be caused even after pressing step.

However, it is feared that only active materials with too small a median may cause a reduction of the density of the positive electrode active material layer or the promotion of a side reaction with the electrolyte solution, for example. In view of this, the median diameter (D50) of the positive electrode active material is preferably less than or equal to 12 μm, further preferably less than or equal to 10 μm, still further preferably less than or equal to 8 μm.

That is, the median diameter (D50) of the positive electrode active material is greater than or equal to 1 μm and less than or equal to 12 μm, preferably greater than or equal to 1 μm and less than or equal to 10 μm. Alternatively, the median diameter (D50) of the positive electrode active material is greater than or equal to 100 nm and less than or equal to 12 μm, preferably greater than or equal to 100 nm and less than or equal to 10 μm. As described above, the second positive electrode active material 110 with a large median diameter (D50) has preferably a medial diameter (D50) that is greater than or equal to 1.2 times and less than or equal to 3 times, further preferably greater than or equal to 1.5 times and less than or equal to 2 times the median diameter (D50) of the first positive electrode active material 100.

Note that above-described median diameter (D50) can be measured by observation using a SEM or a TEM or with a particle size distribution analyzer using a laser diffraction and scattering method, for example. When measured with a particle size distribution analyzer or the like using a laser diffraction and scattering method, the median diameter (D50) is the particle diameter when the cumulative amount is 50% in a cumulative curve obtained as a result of the particle size distribution measurement. Note that an example of a method for measuring the median diameter by analysis with a SEM, a TEM, or the like includes a method for measuring 20 or more particles to make a cumulative curve, and setting a particle diameter when the accumulation of particles accounts for 50% as the median diameter.

### <Details of Additive Elements>

### <Magnesium>

Magnesium ion, which is one of the additive elements, is divalent, and a magnesium ion is more stable in lithium sites than in cobalt sites in the layered rock-salt crystal structure and thus is likely to enter the lithium sites. An appropriate concentration of magnesium in the lithium sites of the surface portion can facilitate maintenance of the layered rock-salt crystal structure. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the first positive electrode active material 100. In addition, a high concentration of magnesium in the surface portion is expected to increase the corrosion resistance to hydrofluoric acid generated by the decomposition of the electrolyte solution.

An appropriate concentration of magnesium can bring the above-described advantages without an adverse effect on insertion and extraction of lithium in charge and discharge. However, excess magnesium might adversely affect insertion and extraction of lithium. Furthermore, the effect of stabilizing the crystal structure might be reduced. This is probably because magnesium enters the cobalt sites in addition to the lithium sites. Moreover, a surplus magnesium compound (e.g., oxide or fluoride) which is substituted for neither the lithium site nor the cobalt site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charge and discharge decreases.

Thus, the first positive electrode active materials 100 as a whole preferably contain an appropriate amount of magnesium. For example, the atomic ratio of magnesium is preferably greater than or equal to 0.001 times and less than or equal to 0.1 times, further preferably greater than 0.01 times and less than 0.04 times, still further preferably approximately 0.02 times the atomic ratio of cobalt. The amount of magnesium contained in the first positive electrode active materials 100 as a whole here may be a value obtained by element analysis on the first positive electrode active materials 100 with GD-MS, ICP-MS, or the like, or may be a value based on the ratio of the raw materials mixed in the formation process of the first positive electrode active materials 100, for example.

### <Aluminum>

Aluminum ion, which is one of the additive elements, is a trivalent ion and can enter the cobalt site in the layered rock-salt crystal structure. Since aluminum is a representative element and its valence does not change, lithium around aluminum is unlikely to move even in charge and discharge. Thus, aluminum and lithium therearound serve as columns to inhibit a change in the crystal structure. Furthermore, aluminum has effects of inhibiting cobalt around aluminum to be dissolved and improving continuous charge tolerance. Moreover, an Al—O bond is stronger than a Co—O bond; thus, extraction of oxygen around aluminum can be inhibited. These effects improve thermal stability. Thus, containing aluminum as the additive element can increase the level of safety of a secondary battery. Furthermore, the first positive electrode active material 100 can have a crystal structure that is unlikely to be broken by repeated charge and discharge.

Meanwhile, excess aluminum might adversely affect insertion and extraction of lithium.

Thus, the first positive electrode active materials 100 as a whole preferably contain an appropriate amount of aluminum. For example, in the first positive electrode active materials 100 as a whole, the atomic ratio of aluminum is preferably greater than or equal to 0.05% and less than or equal to 4%, further preferably greater than or equal to 0.1% and less than or equal to 2%, still further preferably greater than or equal to 0.3% and less than or equal to 1.5% of the atomic ratio of cobalt. Alternatively, it is preferably greater than or equal to 0.05% and less than or equal to 2%. Alternatively, it is preferably greater than or equal to 0.1% and less than or equal to 4%. The amount contained in the first positive electrode active materials 100 as a whole here may be a value obtained by entirely performing element analysis on the first positive electrode active materials 100 with GD-MS, ICP-MS, or the like or may be a value based on the ratio of the raw materials mixed in the formation process of the first positive electrode active materials 100, for example.

### <Nickel>

Nickel, which is one of the additive elements, can enter both the cobalt site and the lithium site. Nickel preferably occupies the cobalt sites because a lower oxidation-reduction potential can be obtained as compared with the case where only cobalt occupies the cobalt sites, leading to an increase in discharge capacity.

In addition, when nickel occupies lithium sites, a shift in the layered structure formed of octahedrons of cobalt and oxygen can be inhibited. Moreover, a change in volume in charge and discharge is inhibited. Furthermore, the elastic modulus becomes large, i.e., hardness increases. This is probably because nickel in the lithium sites serves as a column supporting the CoO₂ layers. Thus, the crystal structure is expected to be more stable in a charged state particularly at high temperatures, e.g., 45° C. or higher, which is preferable.

Meanwhile, in the case of excess nickel, the influence of distortion due to the Jahn-Teller effect becomes strong, which is not preferable. Moreover, excess nickel might adversely affect insertion and extraction of lithium.

Thus, the first positive electrode active materials 100 as a whole preferably contain an appropriate amount of nickel. For example, the atomic ratio of nickel contained in the first positive electrode active materials 100 is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the atomic ratio of cobalt. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by entirely performing element analysis on the positive electrode active materials with GD-MS, ICP-MS, or the like, or may be a value based on the ratio of the raw materials mixed in the formation process of the positive electrode active materials, for example.

### <Fluorine>

Fluorine ion, which is one of the additive elements, is a monovalent anion; when fluorine is substituted for part of oxygen in the surface portion, the lithium extraction energy is lowered. This is because the change in valence of cobalt ions associated with lithium extraction is from trivalent to tetravalent in the case of not containing fluorine and is from divalent to trivalent in the case of containing fluorine, and the oxidation-reduction potentials in these cases differ from each other. It can thus be said that when fluorine is substituted for part of oxygen in the surface portion of the first positive electrode active material 100, lithium ions near fluorine are likely to be extracted and inserted smoothly. Accordingly, a secondary battery including the positive electrode active material 100 can have improved charge and discharge characteristics, improved large current characteristics, or the like. When fluorine is present in the surface portion, which has a surface in contact with the electrolyte solution, the corrosion resistance to hydrofluoric acid can be effectively increased.

In the case where a fluorine compound (also referred to as a fluoride in some cases) such as lithium fluoride has a lower melting point than a different element source, the fluorine compound or the like can serve as a fusing agent (also referred to as a flux agent) for lowering the melting point of the different additive element source. In the case of a fluorine compound containing LiF and MgF₂, the eutectic point of LiF and MgF₂ is around 742° C.; thus, the heating temperature in the heating step following the mixing of the additive element is preferably set higher than or equal to 742° C.

### <Titanium>

An oxide of titanium, which is one of the additive elements, is known to have superhydrophilicity. Accordingly, the positive electrode active material 100 that contains titanium oxide in the surface portion can have good wettability with a high-polarity solvent. In a secondary battery formed using this first positive electrode active material 100, the first positive electrode active material 100 and a high-polarity electrolyte solution can have favorable contact at the interface therebetween, which may inhibit an internal resistance increase.

### <Additive Element Distribution>

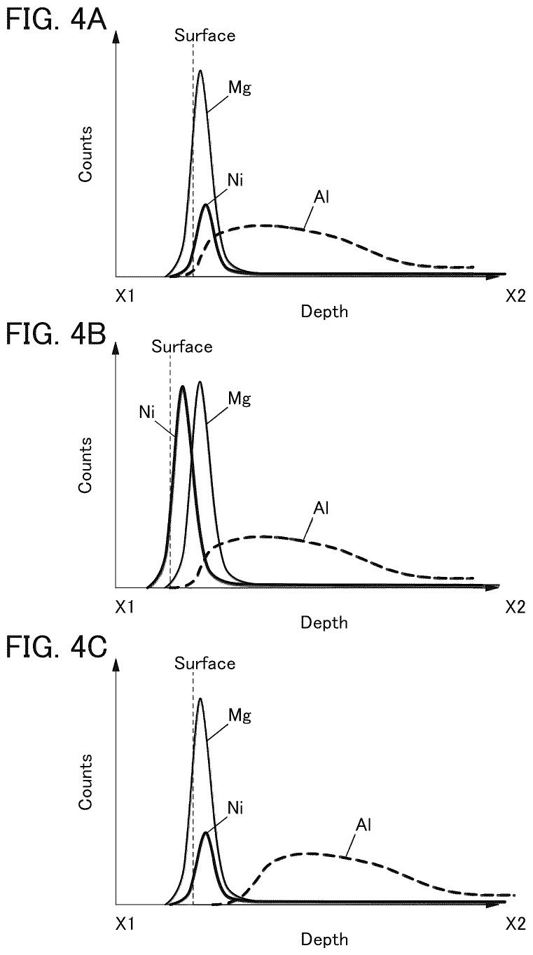

As shown in FIG. 4A to FIG. 4C, the detection intensities of at least magnesium and nickel among the additive elements in the surface portion are each preferably larger than the detection intensity in the inner portion 100b. A peak with a small width of the detection intensity is preferably observed in a region of the surface portion that is closer to the particle surface. For example, the peak of the detection intensity is preferably observed in a region ranging from the surface or the reference point to 3 nm or less. The distribution of magnesium and that of nickel preferably overlap with each other. The peak of the detection intensity of magnesium and that of the detection intensity of nickel may be at the same depth, the peak of magnesium may be closer to the surface, or the peak of nickel may be closer to the surface as shown in FIG. 4B. The difference in depth between the peak of the detection intensity of nickel and the peak of the detection intensity of magnesium is preferably less than or equal to 3 nm, further preferably less than or equal to 1 nm. In some cases, the detection intensity of nickel is much smaller in the inner portion 100b than in the surface portion, or no nickel is detected in the inner portion 100b.

Although not illustrated, as in the case of magnesium or nickel, the detection intensity of fluorine in the surface portion is preferably larger than the detection intensity in the inner portion. In addition, a peak of the detection intensity is preferably observed in a region of the surface portion that is closer to the particle surface. For example, the peak of the detection intensity is preferably observed in a region ranging from the surface or the reference point to 3 nm or less. Similarly, the detection intensities of titanium, silicon, phosphorus, boron, and/or calcium in the surface portion are also preferably larger than the detection intensities in the inner portion. In addition, peaks of the detection intensities are each preferably observed in a region of the surface portion that is closer to the surface. For example, the peaks of the detection intensities are each preferably observed in a region ranging from the surface or the reference point to 3 nm or less.

A peak of the detection intensity of at least aluminum among the additive elements is preferably observed in a region that is located inward from a region where a peak of the detection intensity of magnesium is observed. The distribution of magnesium and that of aluminum may overlap with each other as shown in FIG. 4A, or there may be almost no overlap between the distribution of magnesium and that of aluminum as shown in FIG. 4C. A peak of the detection intensity of aluminum may be in the surface portion or be in a position deeper than the surface portion. For example, the peak is preferably observed in a region ranging from the surface or the reference point to a position of 5 nm to 30 nm, both inclusive, toward the inner portion.

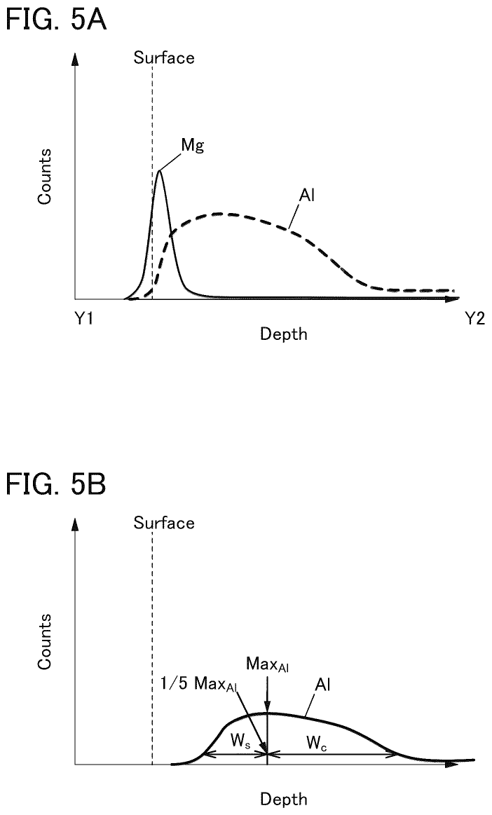

The distribution of aluminum is not normal distribution in some cases. For example, when the distribution of aluminum is divided by the maximum value Max_{Al}, the length of the tail on the surface side is sometimes different from that of the tail on the inner portion side. More specifically, when the peak width at the height (⅕ Max_{Al}) that is ⅕ of the height of the maximum value (Max_{Al}) of the detection intensity of aluminum is divided into two parts by a perpendicular extending from the maximum value to the horizontal axis, the peak width We on the inner portion side is sometimes larger than the peak width Wₛ on the surface side as shown in FIG. 5B.

In such a manner, aluminum is distributed more inwardly than magnesium presumably because the diffusion rate of aluminum is higher than that of magnesium. Meanwhile, the detection intensity of aluminum is low in the region that is the closest to the surface, which is presumably because aluminum can be more stable in a region other than a region where magnesium or the like at a high concentration forms a solid solution.

To be specific, in a region having a layered rock-salt crystal structure belonging to the space group R-3m or a cubic rock-salt crystal structure, the distance between a cation and oxygen in a region where magnesium at a high concentration forms a solid solution is longer than that in LiAlO₂ having a layered rock-salt crystal structure, and thus aluminum is less likely to be stable. In the vicinity of cobalt, valence change due to replacement of Li⁺ with Mg²⁺ can be offset by Co²⁺ which is changed from Co³⁺, so that cation balance can be maintained. By contrast, Al is always trivalent and thus is presumed to be unlikely to be together with magnesium in a rock-salt or layered rock-salt crystal structure.

Although not illustrated, as in the case of aluminum, a peak of the detection intensity of manganese is preferably observed in a region that is located inward from that of magnesium.

Note that the additive elements do not necessarily have similar concentration gradients or similar distributions throughout the surface portion of the first positive electrode active material 100. FIG. 5A shows an example of the profiles of the additive elements, showing a depth direction example of the (00l) plane of lithium cobalt oxide that is the first positive electrode active material 100.

The additive element distribution in the region having the surface with a (00l) orientation may be different from that in the region having another surface. For example, the detection intensities of one or two or more selected from the additive elements may be lower in the region having the (00l) plane than in the plane other than the (00l) plane. Specifically, the detection intensity of nickel may be low. Alternatively, the peaks of the detection intensities of one or two or more selected from the additive elements in the region having the surface with a (00l) orientation may be positioned shallower from the surface than the peaks thereof in the region having the plane other than the (00l) plane is. Specifically, the peaks of the detection intensities of magnesium and aluminum may be positioned shallow from the surface in the region having the plane other than the (00l) plane.

In a layered rock-salt crystal structure belonging to R-3m, cations are arranged parallel to the (00l) plane. In other words, CoO₂ layers and lithium layers are alternately stacked in parallel with the (00l) plane. Accordingly, a diffusion path of lithium ions is also parallel to the (00l) plane. Meanwhile, the CoO₂ layer is relatively stable and thus, the surface of the first positive electrode active material 100 is more stable when having a (00l) orientation. A main diffusion path of lithium ions in charge and discharge is not exposed at the (00l) plane.

A diffusion path of lithium ions is exposed at the plane other than the (00l) plane. Thus, the plane other than the (00l) plane and the surface portion thereof easily lose stability because they are regions where extraction of lithium ions starts as well as important regions for maintaining a diffusion path of lithium ions. It is thus extremely important to reinforce the plane other than the (00l) plane and the surface portion thereof so that the crystal structure of the whole first positive electrode active material 100 is maintained.

Accordingly, in the first positive electrode active material 100, it is preferable that the additive element profile in the region having the plane other than the (00l) plane be distribution shown in any one of FIG. 4A to FIG. 4C. In particular, among the additive elements, nickel is preferably detected in the region having the plane other than the (00l) plane. By contrast, in the region having the (00l) plane, the concentrations of the additive elements may be low as described above.

For example, the half width of the distribution of magnesium in the region having the (00l) plane is preferably greater than or equal to 10 nm and less than or equal to 200 nm, further preferably greater than or equal to 50 nm and less than or equal to 150 nm, still further preferably greater than or equal to 80 nm and less than or equal to 120 nm. The half width of the distribution of magnesium in the region having the plane other than the (00l) plane is preferably greater than 200 nm and less than or equal to 500 nm, further preferably greater than 200 nm and less than or equal to 300 nm, still further preferably greater than or equal to 230 nm and less than or equal to 270 nm.

The half width of the distribution of nickel in the region having the plane other than the (00l) plane is preferably greater than or equal to 30 nm and less than or equal to 150 nm, further preferably greater than or equal to 50 nm and less than or equal to 130 nm, still further preferably greater than or equal to 70 nm and less than or equal to 110 nm.

In a formation method as described in a later-described embodiment, in which high-purity LiCoO₂ is formed, an additive element is mixed afterwards, and heating is performed, the additive element spreads mainly through a diffusion path of lithium ions. Thus, the additive element distribution in the region having the plane other than the (00l) plane can easily fall within a preferred range.

### <Crystal Structure>

<In the Case where x in LiₓCoO₂ is 1>

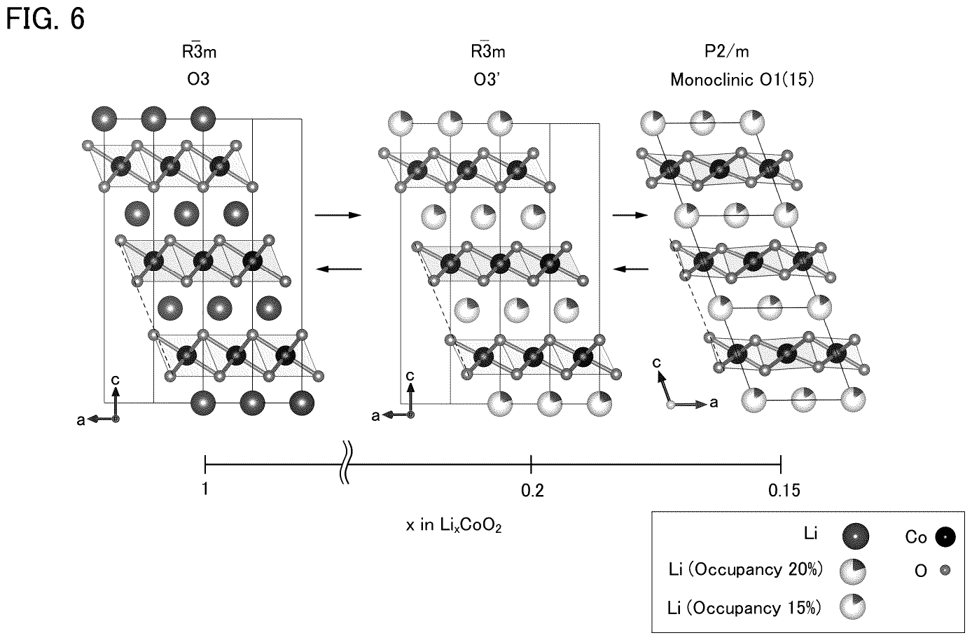

In FIG. 6, the horizontal axis represents a value of x in LiₓCoO₂ and FIG. 6 illustrates crystal structures of lithium cobalt oxide in states where x is 0.15, 0.2, and 1. A crystal structure of lithium cobalt oxide with x of 1 is described first. The case where x in LiₓCoO₂ is 1 means discharged state. In the discharged state, the first positive electrode active material 100 preferably has a layered rock-salt crystal structure belonging to the space group R-3m. It is preferable that the inner portion 100b, which accounts for the majority of the volume of the first positive electrode active material 100, have a layered rock-salt crystal structure. In the layered rock-salt crystal structure, lithium occupies octahedral sites and a unit cell includes three CoO₂ layers; thus, this crystal structure is referred to as an O3 type crystal structure (denoted by O3 in the diagram) in some cases. Note that the CoO₂ layer is assumed to have a structure in which an octahedral structure with cobalt coordinated to six oxygen atoms continues on a plane in an edge-shared state. Such a layer is sometimes referred to as a layer formed of octahedrons of cobalt and oxygen.

The surface portion of the first positive electrode active material 100 preferably has a function of reinforcing the layered structure, which is formed of octahedrons of a transition metal M and oxygen, of the inner portion 100b so that the layered structure does not break even when lithium is extracted from the first positive electrode active material 100 by charge. Alternatively, the surface portion preferably functions as a barrier film for the first positive electrode active material 100. Alternatively, the surface portion, which is the outer portion of the first positive electrode active material 100, preferably reinforces the first positive electrode active material 100. Here, the term “reinforce” means inhibition of a change in the structures of the surface portion and the inner portion 100b of the first positive electrode active material 100, such as extraction of oxygen, and/or inhibition of oxidative decomposition of an electrolyte on the surface of the first positive electrode active material 100.

Accordingly, the surface portion may have a crystal structure different from that of the inner portion 100b. For example, at least part of the surface portion of the first positive electrode active material 100 may have a rock-salt crystal structure. Alternatively, the surface portion may have both a layered rock-salt crystal structure and a rock-salt crystal structure.

<State where x in LiₓCoO₂ is Small>

The crystal structure in a state where x in LiₓCoO₂ is small of the first positive electrode active material 100 is different from that of a conventional positive electrode active material. Here, “x is small” means 0.1<x≤0.24, and x=0.12 or x=0.2 may be used, for example. The conventional positive electrode active material is lithium cobalt oxide containing no additive element.

Conventional lithium cobalt oxide with x being approximately 0.12 has a crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that the number of cobalt atoms per unit cell in the actual H1-3 type crystal structure is twice that in other structures. However, in this specification including FIG. 6, the c-axis of the H1-3 type crystal structure is half that of the unit cell for the sake of easy comparison with the other crystal structures.

For the H1-3 type crystal structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in a positive electrode active material can be judged by Rietveld analysis of XRD patterns, for example. In this case, a unit cell is selected such that the value of GOF (goodness of fit) is small.

When such charge that makes x be 0.24 or less and discharge are repeated, the crystal structure of conventional lithium cobalt oxide repeatedly and dynamically changes between the R-3m O3 structure in a discharged state and the H1-3 type crystal structure (i.e., an unbalanced phase change), which might adversely affect the stability of the crystal structure.

Accordingly, when charge that makes x be 0.24 or less and discharge are repeated, the crystal structure of conventional lithium cobalt oxide is gradually broken. The broken crystal structure triggers degradation of the cycle performance. This is because the broken crystal structure has a smaller number of sites which lithium can occupies stably and makes it difficult to insert and extract lithium.

Meanwhile, the first positive electrode active material 100, illustrated in FIG. 6, with x being 0.24 or less, e.g., approximately 0.2 has a crystal structure different from the H1-3 type crystal structure of the conventional lithium cobalt oxide. The first positive electrode active material 100 with x being approximately 0.2 has a trigonal crystal structure belonging to the space group R-3m. The symmetry of the CoO₂ layers of this structure is the same as that of O3. Thus, this crystal structure is called an O3′ type crystal structure. This crystal structure belongs to the space group R-3m, and thus is denoted by R-3m O3′ in FIG. 6. Although this crystal structure is not a spinel structure, an XRD pattern similar to that of the spinel structure appears in some cases, and this crystal structure is referred to as a pseudo-spinel structure in some cases.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (×10⁻¹ nm), further preferably 2.807≤a≤2.827 (×101 nm), typically a=2.817 (×10⁻¹ nm). The lattice constant of the c-axis is preferably 13.681≤c≤13.881 (×10⁻¹ nm), further preferably 13.751≤c≤13.811, typically c=13.781 (×10⁻¹ nm).

The first positive electrode active material 100 of one embodiment of the present invention with x being approximately 0.15 has a monoclinic crystal structure belonging to the space group P2/m. This structure includes one CoO₂ layer in a unit cell. In this case, lithium being present in the first positive electrode active material 100 is approximately 15 atomic % of that in a discharged state. Thus, this crystal structure is referred to as a monoclinic O1(15) type crystal structure. In FIG. 6, this crystal structure is denoted by P2/m monoclinic O1(15).

In the unit cell of the monoclinic O1(15) type crystal structure, the coordinates of cobalt and oxygen can be represented within the ranges below:

$$Co 1 ( 0.5 , 0 , 0.5 ) ,$$

$$Co 2 ( 0 , 0.5 , 0.5 ) ,$$

$$O 1 ( X ( O 1 ) , 0 , Z ( O 1 ) ) ,$$

$$0.23 \leq X ( O 1 ) \leq 0.24 , 0.61 \leq Z ( O 1 ) \leq 0.65 ,$$

$$O 2 ( X ( O 2 ) , 0.5 , Z ( O 2 ) ) , and$$

$$0.75 \leq X ( O 2 ) \leq 0.78 , 0.68 \leq Z ( O 2 ) \leq 0.71 .$$

In addition, the lattice constant of the unit cell is as follows:

$$a = 4.880 \pm 0.05 ( \times 1 {0}^{- 1} nm ) ,$$

$$b = 2. 817 \pm 0.05 ( \times 1 {0}^{- 1} nm ) ,$$

$$c = 4. 839 \pm 0.05 ( \times 1 {0}^{- 1} nm ) ,$$

$$α = 90 ° ,$$

$$β = 10 \; 9.6 \pm 0.1 ° , and$$

$$γ = 90 ° .$$

Note that this crystal structure can have lattice constants even when belonging to the space group R-3m if a certain level of error is allowed. The coordinates of cobalt and oxygen in the unit cell of this case can be represented within the ranges below:

$$Co ( 0 , 0 , 0.5 ) ,$$

$$O ( 0 , 0 , Z ( O ) ) , and$$

$$0.21 \leq Z ( O ) \leq 0.23 .$$

In addition, the lattice constant of the unit cell is as follows:

$$a = 2.817 \pm 0.02 ( \times 1 {0}^{- 1} nm ) , and$$

$$c = 13.68 \pm 0.1 ( \times 1 {0}^{- 1} nm ) .$$

In both of the O3′ type crystal structure and the monoclinic O1(15) type crystal structure, an ion of cobalt, nickel, magnesium, or the like occupies a site coordinated to six oxygen atoms. Note that a light element such as lithium and magnesium sometimes occupies a site coordinated to four oxygen atoms.

As denoted by the dotted lines in FIG. 6, the CoO₂ layers hardly shift between the R-3m O3 in a discharged state, the O3′ type crystal structure, and the monoclinic O1(15) type crystal structure.

The R-3m O3 in a discharged state and the O3′ type crystal structure which contain the same number of cobalt atoms have a difference in volume of 2.5% or less, specifically 2.2% or less, typically 1.8%.

The R-3m O3 in a discharged state and the monoclinic O1(15) type crystal structure which contain the same number of cobalt atoms have a difference in volume of 3.3% or less, specifically 3.0% or less, typically 2.5%.

As described above, in the first positive electrode active material 100, a change in the crystal structure caused when x in LiₓCoO₂ is small, i.e., when a large amount of lithium is extracted, is smaller than that in a conventional positive electrode active material. In addition, a change in the volume per the same number of cobalt atoms is inhibited. Thus, the crystal structure of the first positive electrode active material 100 is unlikely to break even when charge that makes x be 0.24 or less and discharge are repeated. Therefore, the positive electrode active material 100 inhibits a decrease in charge and discharge capacity in charge and discharge cycles. Furthermore, compared with the case of a conventional positive electrode active material, a larger amount of lithium can be inserted and extracted stably, and thus the first positive electrode active material 100 enables high discharge capacity per weight and per volume. Accordingly, with the use of the first positive electrode active material 100, a secondary battery with high discharge capacity per weight and per volume can be manufactured.

Note that the first positive electrode active material 100 is confirmed to have the O3′ type crystal structure in some cases when x in LiₓCoO₂ is greater than or equal to 0.15 and less than or equal to 0.24, and is estimated to have the O3′ type crystal structure even when x is greater than 0.24 and less than or equal to 0.27.

However, the crystal structure is influenced by not only x in LiₓCoO₂ but also the number of charge-discharge cycles, a charge current and a discharge current, temperature, an electrolyte, and the like, so that the range of x is not limited to the above. Hence, when x in LiₓCoO₂ in the first positive electrode active material 100 is greater than 0.1 and less than or equal to 0.24, it is acceptable that not all the inner portion 100b of the first positive electrode active material 100 has the O3′ type crystal structure. The positive electrode active material may include another crystal structure or may be partly amorphous.

In order to make x in LiₓCoO₂ small, charge at a high charge voltage is necessary in general. Thus, the state where x in LiₓCoO₂ is small can be rephrased as a state where charge at a high charge voltage has been performed. For example, when CC (constant current)/CV (constant voltage) charge is performed at a voltage of 4.6 V or higher with reference to the potential of a lithium metal in a 25° C. environment, the H1-3 type crystal structure appears in a conventional positive electrode active material. Thus, a charge voltage of 4.6 V or higher can be regarded as a high charge voltage with reference to the potential of a lithium metal. In this specification and the like, unless otherwise specified, a charge voltage is shown with reference to the potential of a lithium metal.

In the first positive electrode active material 100, when the charge voltage is increased, the H1-3 type crystal is eventually observed in some cases. As described above, the crystal structure is influenced by the number of charge-discharge cycles, a charge current and a discharge current, an electrolyte, and the like, so that the first positive electrode active material 100 of one embodiment of the present invention can have the O3′ type crystal structure even at a lower charge voltage, e.g., a charge voltage of higher than or equal to 4.5 V and lower than 4.6 V at 25° C. in some cases.

In the case where graphite is used as a negative electrode active material in a secondary battery, for example, the voltage of the secondary battery is lower than the above-mentioned voltages by the potential of the graphite. The potential of the graphite is approximately 0.05 V to 0.2 V with reference to the potential of a lithium metal. Thus, in the case of a secondary battery using graphite as a negative electrode active material, a similar crystal structure is obtained at a voltage obtained by subtracting the potential of the graphite from the above-described voltage.

Although lithium occupies all lithium sites in O3′ with the same occupancy in FIG. 6, one embodiment of the present invention is not limited thereto. Lithium may occupies only some of the lithium sites unevenly; for example, lithium may be symmetrically present as in the monoclinic O1 (Li_{0.5}CoO₂). Distribution of lithium can be analyzed by neutron diffraction, for example.

The O3′ type crystal structure can be regarded as a crystal structure that contains lithium between layers randomly but is similar to a CdCl₂ type crystal structure. The crystal structure similar to the CdCl₂ type crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ type crystal structure in general.

### <Analysis Method>

Whether or not a given positive electrode active material is the positive electrode active material of one embodiment of the present invention, which has the O3′ type crystal structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt contained in the positive electrode active material can be analyzed with high resolution, comparison of the degree of crystallinity and comparison of the crystal orientation can be performed, distortion of lattice periodicity and the crystallite size can be analyzed, and a positive electrode obtained only by disassembling a secondary battery can be measured with sufficient accuracy, for example. A diffraction peak reflecting the crystal structure of the inner portion of the positive electrode active material, which accounts for the majority of the volume of the positive electrode active material, is obtained through XRD, in particular, powder XRD.

In the case where the crystallite size is analyzed by powder XRD, the measurement is preferably performed while the influence of orientation due to pressure or the like is removed. For example, it is preferable that the positive electrode active material be taken out from a positive electrode obtained from a disassembled secondary battery, the positive electrode active material be made into a powder sample, and then the measurement be performed.

Note that a positive electrode active material with small x sometimes causes a change in the crystal structure when exposed to the air. For example, the O3′ type crystal structure changes into the H1-3 type crystal structure in some cases. For that reason, all samples subjected to analysis of crystal structures are preferably handled in an inert atmosphere such as an argon atmosphere.

### <XRD>

The apparatus and conditions of the XRD measurement are not particularly limited as long as appropriate adjustment and calibration are performed. The measurement can be performed with the apparatus and conditions as described below, for example.
XRD apparatus: D8 ADVANCE produced by Bruker AXS
X-ray source: CuKα₁ radiation
Output: 40 kV, 40 mA
Angle of divergence: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm
   As a standard sample used for the adjustment and calibration, a standard sintered alumina plate SRM 1976 from NIST (National Institute of Standards and Technology) can be used, for example. From the obtained XRD patterns, the background and CuKa₂ radiation peak can be eliminated using analysis software.

In the case where the measurement sample is a powder, the sample can be set by, for example, being put on a glass sample holder or being sprinkled on a reflection-free silicon plate to which grease is applied. In the case where the measurement sample is a positive electrode, the positive electrode can be set in the following manner: the positive electrode is attached to a substrate with a double-sided adhesive tape and the position of the positive electrode active material layer can be adjusted to the measurement plane required by the apparatus.

Characteristic X-rays may be monochromatized with the use of a filter or the like or may be monochromatized with XRD data analysis software after an XRD pattern is obtained. For example, a peak due to CuKα₂ radiation can be eliminated and only a peak due to CuKα₁ radiation can be extracted by using DEFFRAC.EVA (XRD data analysis software produced by Bruker Corporation). This software can also be used to eliminate the background, for example.

In this specification and the like, the value of 2θ of a diffraction peak refers to the value of 2θ at which a peak top of the diffraction peak appears in the XRD pattern after the calculation model is fitted. There is no particular limitation on the crystal structure analysis software used for the fitting; for example, it is possible to use TOPAS ver. 3 (crystal structure analysis software produced by Bruker Corporation).

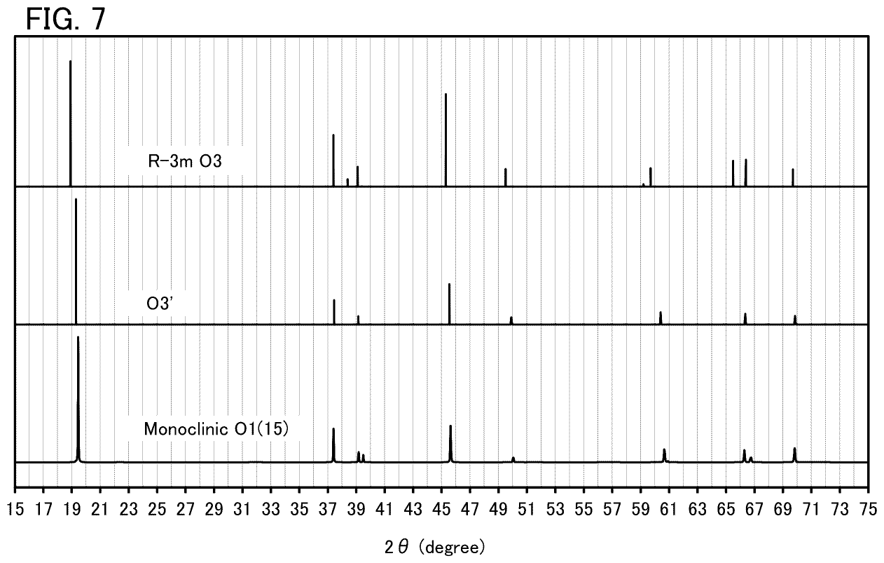

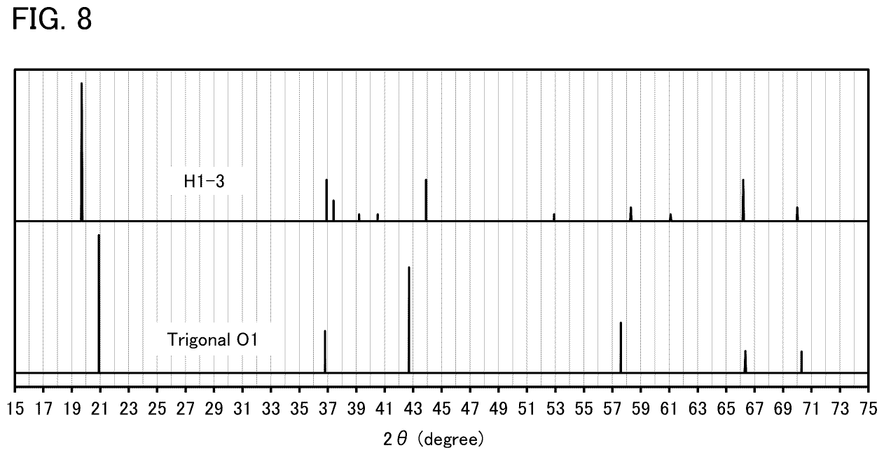

FIG. 7 shows XRD patterns of the O3 type crystal structure, the O3′ type crystal structure, and the monoclinic O1(15) type crystal structure of the case where CuKα₁ is used as a radiation source. FIG. 8 shows an ideal powder XRD pattern with CuKα₁ radiation calculated from a model of the H1-3 type crystal structure and an ideal XRD pattern with CuKα₁ radiation calculated from the trigonal O1 type crystal structure with x of 0. FIG. 7 shows all the XRD patterns described above. Note that the patterns in the range of 2θ (degree) of 18° to 21°, and the range of 2θ of 42° to 46° are shown. In addition, the patterns of LiCoO₂ (O3) and CoO₂ (O1) were made from crystal structure data obtained from ICSD (Inorganic Crystal Structure DatABase) with Reflex Powder Diffraction, which is a module of Materials Studio (BIOVIA). At this time, the 2θ range was from 15° to 75°, the step size was 0.01, the wavelength k was 1.54×10⁻¹⁰ m, and a single monochromator was used. Patterns of the O3′ type crystal structure and the monoclinic O1(15) type crystal structure were obtained in the following manner: the crystal structures were estimated from the XRD pattern of the first positive electrode active material 100, and the fitting was performed with TOPAS ver. 3 (crystal structure analysis software produced by Bruker Corporation).

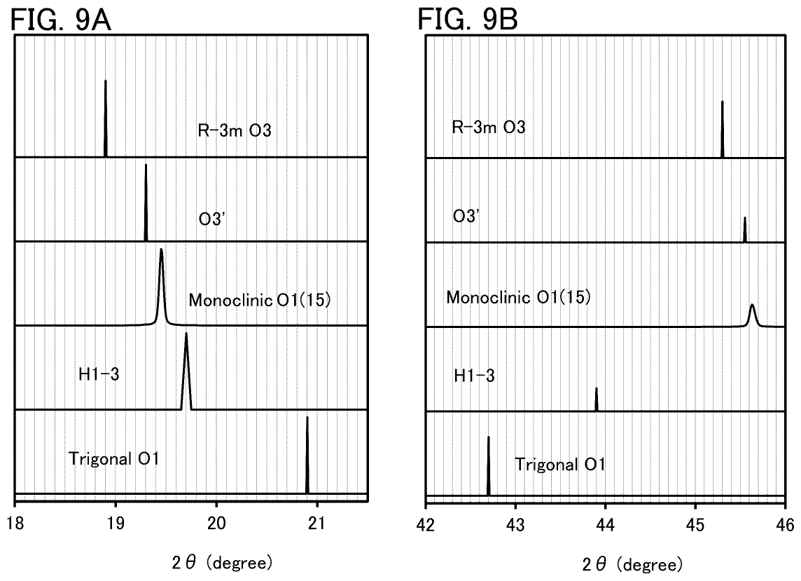

As shown in FIG. 7, FIG. 9A, and FIG. 9B, the O3′ type crystal structure exhibits diffraction peaks at 2θ of 19.25±0.12° (greater than or equal to 19.13° and less than 19.37°) and 2θ of 45.47±0.10° (greater than or equal to 45.37° and less than 45.57°).

Furthermore, the monoclinic O1(15) type crystal structure exhibits diffraction peaks at 2θ of 19.47±0.10° (greater than or equal to 19.37° and less than or equal to 19.57°) and 2θ of 45.62±0.05° (greater than or equal to 45.57° and less than or equal to 45.67°).

However, as shown in FIG. 8, FIG. 9A, and FIG. 9B, the H1-3 type crystal structure and the trigonal O1 do not exhibit peaks at these positions. Thus, exhibiting the peak at greater than or equal to 19.13° and less than 19.37° and/or the peak at greater than or equal to 19.37° and less than or equal to 19.57° and the peak at greater than or equal to 45.37° and less than 45.57° and/or the peak at greater than or equal to 45.57° and less than or equal to 45.67° in a state with small x in LiₓCoO₂ can be the feature of the first positive electrode active material 100.

It can be said that the positions of the XRD diffraction peaks exhibited by the crystal structure with x=1 and the crystal structure with x≤0.24 are close to each other. More specifically, it can be said that a difference in 2θ between the main diffraction peak exhibited by the crystal structure with x=1 and the main diffraction peak exhibited by the crystal structure with x≤0.24, which are exhibited at 2θ of greater than or equal to 42° and less than or equal to 46°, is 0.7° or less, preferably 0.5° or less.

Although the first positive electrode active material 100 has the O3′ type crystal structure and/or the monoclinic O1(15) type crystal structure when x in LiₓCoO₂ is small, it is acceptable that not all of the particles have the O3′ type crystal structure and/or the monoclinic O1(15) type crystal structure. The positive electrode active material may include another crystal structure or may be partly amorphous. Note that when the XRD patterns are subjected to Rietveld analysis, the O3′ type crystal structure and/or the monoclinic O1(15) type crystal structure preferably account(s) for greater than or equal to 50%, further preferably greater than or equal to 60%, still further preferably greater than or equal to 66%. The positive electrode active material in which the O3′ type crystal structure and/or the monoclinic O1(15) type crystal structure account(s) for greater than or equal to 50%, preferably greater than or equal to 60%, further preferably greater than or equal to 66% enables sufficiently good cycle performance.

Furthermore, even after 100 or more cycles of charge and discharge after the measurement starts, the O3′ type crystal structure and/or the monoclinic O1(15) type crystal structure preferably account(s) for greater than or equal to 35%, further preferably greater than or equal to 40%, still further preferably greater than or equal to 43% when Rietveld analysis is performed.

In addition, the H1-3 type crystal structure and the O1 type crystal structure preferably account for less than or equal to 50% in Rietveld analysis performed in a similar manner. Alternatively, the H1-3 type crystal structure and the O1 type crystal structure preferably account for less than or equal to 34%. It is further preferable that substantially no H1-3 type crystal structure and substantially no O1 type crystal structure be observed.

Sharpness of a diffraction peak in an XRD pattern indicates the degree of crystallinity. It is thus preferable that the diffraction peaks after charge be sharp, in other words, have a small half width, e.g., a small full width at half maximum. Even peaks that are derived from the same crystal phase have different half widths depending on the XRD measurement conditions and the 2θ value. In the case of the above-described measurement conditions, the peak observed at 2θ greater than or equal to 43° and less than or equal to 46° preferably has a full width at half maximum of less than or equal to 0.2°, further preferably less than or equal to 0.15°, still further preferably less than or equal to 0.12°. Note that not all peaks need to fulfill the requirement. A crystal phase can be regarded as having high crystallinity when some peaks fulfill the requirement. Such high crystallinity sufficiently contributes to stability of the crystal structure after charge.

The crystallite sizes of the O3′ type crystal structure and the monoclinic O1(15) type crystal structure included in the first positive electrode active material 100 only decrease to approximately 1/20 of LiCoO₂ (O3) in a discharged state. Thus, a clear peak(s) of the O3′ type crystal structure and/or the monoclinic O1(15) type crystal structure can be observed when x in LiₓCoO₂ is small, even under the same XRD measurement conditions as those of a positive electrode before charge and discharge. In contrast, conventional LiCoO₂ has a small crystallite size and a broad and small peak even when it can have a structure part of which is similar to the O3′ type crystal structure and/or the monoclinic O1(15) type crystal structure.

### <Crystallite Size>

A particle of the first positive electrode active material 100 is preferably a single crystal or polycrystal. A single crystal particle included in the first positive electrode active material 100 is referred to as a single particle in some cases. The crystallite size of the first positive electrode active material 100 is preferably large. Accordingly, the first positive electrode active material 100 which has a large crystallite size calculated using the XRD diffraction pattern has no crack or fewer cracks that might be generated between primary particles, as compared to a positive electrode active material formed by sintering of a large number of primary particles. Thus, cracks can be expected to be inhibited even when the volume of the first positive electrode active material 100 is changed by charge and discharge. The crystallite size calculated from the half width of the XRD diffraction pattern is preferably greater than or equal to 150 nm, further preferably greater than or equal to 180 nm, still further preferably greater than or equal to 200 nm, for example. A positive electrode active material whose crystallite size calculated from the XRD diffraction pattern is within the above range can be regarded as a positive electrode active material having a sufficiently large crystallite size and having features close to those of a single particle.

An XRD diffraction pattern for calculation of the crystallite size is preferably obtained in a state of the positive electrode active material alone, or may be obtained in a state of a positive electrode including a current collector, a binder, a conductive material, and the like in addition to the positive electrode active material. Note that the positive electrode active material particles in the positive electrode may be oriented such that the crystal planes of the positive electrode active material particles are oriented in the same direction owing to, for example, pressure application in a formation process. Due to the high orientation, the crystallite size may fail to be calculated accurately; thus, it is further preferable that to obtain an XRD diffraction pattern, a positive electrode active material layer be taken out of the positive electrode, the binder and the like in the positive electrode active material layer be eliminated to some extent using a solvent or the like, and the positive electrode active material layer be put in a sample holder, for example. Alternatively, a powder sample of the positive electrode active material or the like may be attached onto a reflection-free silicon plate to which grease is applied, for example.

The crystallite size can be calculated from, for example, the Scherrer equation shown below.

$$Crystallite size [ nm ] = \frac{Scherre constant \times X - ray wavelength [ nm ]}{Half width [ rad ] \times cos ( \frac{Peak diffraction angle [ rad ]}{2} )} \qquad [ Formula 1 ]$$

The crystallite size can be calculated using ICSD coll. code. 172909 as the literature value of lithium cobalt oxide and a diffraction pattern that is obtained with Bruker D8 ADVANCE, for example, Cu used as an X-ray source, the 2θ ranged from 15° to 90°, an increment being 0.005, and LYNXEYE XE-T as a detector. DIFFRAC.TOPAS ver. 6 can be used as crystal structure analysis software for analysis, and for example, a value of LVol-IB, which is a crystallite size, is preferably employed as a crystallite size. When Preferred Orientation that is calculated is less than 0.8, too many particles are oriented in the same direction in a sample; thus, this sample is not suitable for calculation of a crystallite size in some cases. The crystallite sizes obtained at the diffraction peaks are preferably corrected to calculate an average value of the crystallite sizes.

### <Charge Method>

Charge for determining whether or not a composite oxide is the positive electrode active material of one embodiment of the present invention can be performed on a coin cell (CR2032 type with a diameter of 20 mm and a height of 3.2 mm) formed using a lithium counter electrode, for example.

More specifically, it is possible to use a positive electrode formed by application of slurry in which the positive electrode active material, a conductive material, and a binder are mixed to a positive electrode current collector made of aluminum foil.

A lithium metal can be used for a counter electrode. Note that when a material other than the lithium metal is used for the counter electrode, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) are mixed at EC:DEC=3:7 (volume ratio) and to which 2 wt % vinylene carbonate (VC) is added can be used.

As a separator, a 25-μm-thick polypropylene porous film can be used.

A positive electrode can and a negative electrode can each formed of stainless steel (SUS) can be used.

The coin cell manufactured with the above conditions is charged with a given voltage (e.g., 4.5 V, 4.55 V, 4.6 V, 4.65 V, 4.7 V, 4.75 V, or 4.8 V). The charge method is not particularly limited as long as charge with a given voltage can be performed for sufficient time. In the case of constant current charge and constant voltage charge (referred to as CCCV charge), for example, constant current charge can be performed with a current higher than or equal to 20 mA/g and lower than or equal to 100 mA/g per weight of the positive electrode active material. Constant voltage charge can be ended with a current higher than or equal to 2 mA/g and lower than or equal to 10 mA/g. To observe a phase change of the positive electrode active material, charge with such a small current value is preferably performed. The temperature is set to 25° C. or 45° C. After charge is performed in this manner, the coin cell is disassembled in a glove box with an argon atmosphere to take out the positive electrode, whereby the positive electrode active material with predetermined charge capacity can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere. After charge is completed, the positive electrode is preferably taken out immediately and subjected to the analysis. Specifically, the positive electrode is preferably subjected to analysis within 1 hour, further preferably within 30 minutes after the completion of charge.

In the case where the crystal structure in a charged state after charge and discharge are performed multiple times is analyzed, the conditions of the charge and discharge performed multiple times may be different from the above-described charge condition. For example, as charge, constant current charge to a given voltage (e.g., 4.6 V, 4.65 V, 4.7 V, 4.75 V, or 4.8 V) at a current value per weight of the positive electrode active material of higher than or equal to 20 mA/g and lower than or equal to 100 mA/g can be performed and then constant voltage charge can be performed until the current value becomes higher than or equal to 2 mA/g and lower than or equal to 10 mA/g, and as discharge, constant current discharge (referred to as CC discharge) can be performed at higher than or equal to 20 mA/g and lower than or equal to 100 mA/g until the voltage reaches 2.5 V.

Also in the case where the crystal structure in a discharged state after charge and discharge are performed multiple times is analyzed, constant current discharge can be performed at 2.5 V and a current value higher per weight of the positive electrode active material of higher than or equal to 20 mA/g and lower than or equal to 100 mA/g, for example.

### <Powder Resistance Measurement>

The powder volume resistivity of the first positive electrode active material 100 is described.

The powder volume resistivity of the first positive electrode active material 100 is preferably higher than or equal to 1.0×10³ Ω·cm, further preferably higher than or equal to 4.0×10³ Ω·cm at a pressure of 64 MPa. The additive element is distributed at a preferable concentration in the surface portion 100c of the first positive electrode active material 100, so that the above value is obtained. In other words, the volume resistivity can be used as an indicator of the favorable formation of the surface portion 100c. The first positive electrode active material 100 with the above volume resistivity has a stable crystal structure even at a high voltage, and can be regarded as having a stable crystal structure of a positive electrode active material in a charged state.

It is feared that a battery reaction is hindered in the case where a high-resistance region is located to have a large thickness from the particle surface of the first positive electrode active material 100 toward the inner portion thereof. It is thus further preferable that only a thin region near the surface such as the surface portion 100c actually have high resistance. The surface portion 100c is preferably located to have a small thickness from the surface toward the inner portion, like in a region within 20 nm, preferably a region within 10 nm, further preferably a region within 5 nm in a direction perpendicular or substantially perpendicular to the surface.

When the volume resistivity is too high, charge-discharge cycle performance is insufficient in some cases. Thus, the powder volume resistivity of the first positive electrode active material 100 is preferably lower than or equal to 1.0×10¹² Ω·cm. Note that in the case of using a CNT as the conductive material, the powder volume resistivity of the first positive electrode active material 100 can be lower than or equal to 1.0×10¹³ Ω·cm. Since the CNT can sufficiently ensure a conductive path, favorable charge-discharge cycle performance can be obtained even with the above-described volume resistivity.

A battery including the first positive electrode active material 100 having such a volume resistivity can be a secondary battery that is unlikely to ignite in an internal short circuit test such as a nail penetration test. Moreover, the battery can achieve favorable performance in a charge-discharge cycle test under high-voltage conditions.

A method for measuring the powder volume resistivity of the first positive electrode active material 100 of one embodiment of the present invention is described.

Measurement of powder volume resistivity preferably has a first mechanism including terminals for measuring resistance and a second mechanism for applying pressure to a powder sample (sample) serving as a measurement target. The second mechanism preferably includes a cylinder into which the powder sample is to be put and a piston which can move up and down in the cylinder. A spring or the like is connected to the piston, so that pressure can be applied to the sample in the cylinder. The first mechanism preferably includes a measurement electrode that is in contact with the bottom surface of the cylinder. As such a measurement instrument that has the terminals for resistance measurement and the mechanism for applying pressure to the powder serving as a measurement target, for example, MCP-PD51 produced by Mitsubishi Chemical Analytech Co., Ltd. can be used. As a resistance meter, Loresta-GP or Hiresta-UP can be used. Loresta-GP can be used for the measurement for a low-resistance sample by a four-probe method, whereas Hiresta-UP can be used for the measurement for a high-resistance sample by a two-terminal method. Note that the measurement environment is preferably a stable environment such as an environment of a dry room but may be an environment of a common laboratory. In the environment of a dry room, the temperature is preferably higher than or equal to 20° C. and lower than or equal to 25° C. and the dew point is preferably lower than or equal to −40° C., for example. In the environment of a common laboratory, the temperature may be higher than or equal to 15° C. and lower than or equal to 30° C. and the humidity may be higher than or equal to 30% and lower than or equal to 70%.

The measurement of powder volume resistivity using the above-described measurement instrument is described. In the measurement of powder volume resistivity, the electric resistance and thickness of the powder to which pressure is applied are measured. The pressure applied to the powder can be changed. For example, the electric resistance and thickness of the powder can be measured at pressures of 13 MPa, 25 MPa, 38 MPa, 51 MPa, and 64 MPa. The powder volume resistivity can be calculated from the measured value of the electric resistance and thickness of the powder.

A calculation method of volume resistivity is described. In the case where the measurement is performed by a two-terminal method using Hiresta-UP, the volume resistivity can be calculated by multiplying the electric resistance of the powder by the area of the electrode putting pressure on the powder and then dividing the product by the thickness of the powder. In the case where the measurement is performed by a four-probe method using Loresta-GP, the volume resistivity can be calculated by multiplying the electric resistance of the powder, a correction coefficient, and the thickness of the powder. The correction coefficient is a value that depends on the sample shape, the sample size, and the measurement position and can be calculated using calculation software incorporated in Loresta-GP.

### <X-Ray Photoelectron Spectroscopy (XPS)>

In an inorganic oxide, a region ranging from the particle surface to a depth of approximately 2 nm to 8 nm (typically, 5 nm or less) can be analyzed by XPS using monochromatic aluminum Kα radiation as an X-ray source; thus, the concentrations of elements in a region to approximately half the depth of the surface portion can be quantitatively analyzed. The bonding states of the elements can be analyzed by narrow scanning. XPS analysis can be performed on a plurality of positive electrode active material particles.

In the first positive electrode active material 100 of one embodiment of the present invention, the concentration of one or two or more selected from the additive elements is preferably higher in the surface portion 100c than in the inner portion 100b. This means that the concentration of one or two or more selected from the additive elements in the surface portion or the surface portion 100c is preferably higher than the average concentration of the selected element(s) in the first positive electrode active materials 100 as a whole. For this reason, for example, it can be said that the concentration of one or two or more additive elements, which is measured by XPS or the like, is preferably higher than the average concentration of the additive element(s) in the first positive electrode active materials 100 as a whole, which is measured by ICP-MS, GD-MS, or the like. For example, the concentration of magnesium measured by XPS or the like is preferably higher than the average concentration of magnesium in the first positive electrode active materials 100 as a whole. The concentration of nickel measured by XPS or the like is preferably higher than the average concentration of nickel in the first positive electrode active materials 100 as a whole. The concentration of aluminum measured by XPS or the like is preferably higher than the average concentration of aluminum in the first positive electrode active materials 100 as a whole. The concentration of fluorine measured by XPS or the like is preferably higher than the average concentration of fluorine in the first positive electrode active materials 100 as a whole. The average in the first positive electrode active materials 100 as a whole indicates the average of the surface portion and the inner portion.

In XPS analysis on the first positive electrode active materials 100, for example, the ratio of the atomic ratio of cobalt to the atomic ratio of magnesium (which may be referred to as a presence ratio and is denoted by A_{Mg}/A_{Co}) is preferably greater than 0, and specifically, preferably greater than or equal to 0.8 and less than or equal to 1.4, further preferably greater than or equal to 0.9 and less than or equal to 1.3, still further preferably greater than or equal to 1.0 and less than or equal to 1.2. For example, the ratio of the atomic ratio of cobalt to the atomic ratio of nickel (A_{Ni}/A_{Co}) is preferably greater than 0, and preferably greater than or equal to 0.07 and less than or equal to 0.15, further preferably greater than or equal to 0.08 and less than or equal to 0.13, still further preferably greater than or equal to 0.09 and less than or equal to 0.11. For example, the ratio of the atomic ratio of cobalt to the atomic ratio of fluorine (A_{F}/A_{Co}) is preferably greater than 0, and preferably greater than or equal to 0.5 and less than or equal to 1.0, further preferably greater than or equal to 0.6 and less than or equal to 0.9, still further preferably greater than or equal to 0.7 and less than or equal to 0.8. The ratio is preferably within the above range in a plurality of portions, e.g., three or more portions of the first positive electrode active materials 100.

### <EDX>

The concentration of the additive element in the first positive electrode active material 100 can be evaluated, for example, by exposing a cross section of the first positive electrode active material 100 using FIB (Focused Ion Beam) or the like and analyzing the cross section using energy dispersive X-ray spectroscopy (EDX), EPMA (electron probe microanalysis), or the like. An EDX analysis apparatus is often provided in a SEM apparatus or a STEM apparatus, which is referred to as SEM-EDX measurement or STEM-EDX measurement.

In EDX measurement, measurement and evaluation performed by linearly scanning an electron beam is referred to as line analysis. Meanwhile, measurement and evaluation performed by scanning an electron beam on a point or a given area is referred to as point analysis. The point analysis can measure a larger area than the line analysis, and thus is preferable in the case where a trace amount of element is confirmed to be present in a region or in the case where the element is quantified. The concentration of each element can be calculated as a quantitative value by any of the point analysis and the line analysis. Moreover, the energy spectrum of each element can be obtained by any of the line analysis and the point analysis, and in combination with the energy spectrum, it is preferable to determine the presence of an element in a trace amount in a region.

A method for calculating a quantitative value of an element by STEM-EDX measurement is described. First, a positive electrode active material that has been processed using FIB is prepared as a sample, and a cross-sectional STEM image is obtained with a STEM apparatus. STEM-EDX line analysis is performed on a region in the cross-sectional STEM image; as a result, a graph showing the distance (nm) on the horizontal axis and the detection intensity (Counts) or the quantitative value (atomic %) on the vertical axis can be made. The distance may be also called a position from a measurement point. The detection intensity is equal to the detected amount of characteristic X-rays. The quantitative value is calculated from the detection intensity. The quantitative values of the elements can be read from the graph showing the quantitative value (atomic %) on the vertical axis.

For example, the concentrations of elements can be quantified separately in a surface portion and an inner portion of the positive electrode active material. In this case, first, a surface portion and an inner portion of the positive electrode active material are determined. The surface portion can be determined by the distance from the surface in the depth direction; thus, the particle surface of the positive electrode active material is determined. For example, in a graph showing a detection intensity on the vertical axis, the reference point or the surface is a point corresponding to 50% of the sum of an average value M_{AVE} of the detection intensity of cobalt in the inner portion and an average value M_{BG} of the detection intensity of cobalt of the background, or a point corresponding to 50% of the sum of an average value O_{AVE} of the detection intensity of oxygen in the inner portion and an average value O_{BG} of oxygen of the background. The surface portion and the inner portion can be determined on the basis of the distance from the surface. Note that in the case where there is a difference in the position of the point corresponding to 50% of the sum of the inner portion and the background between cobalt and oxygen, the difference is probably due to the influence of a carbonate, a metal oxide containing oxygen, or the like, which is attached to the surface. Thus, the point corresponding to 50% of the sum of the average value M_{AVE} of the detection intensity of cobalt in the inner portion and the average value MG of the amount of background cobalt can be used. The above-described position of the surface can also be used in a graph showing a quantitative value on the vertical axis.

The average value MG of cobalt of the background can be calculated by averaging the detection intensity in the range of 2 nm or more, preferably 3 nm or more in a region corresponding to the outside of the active material avoiding the vicinity of the portion where the detection intensity of cobalt begins to increase, for example. The average value M_{AVE} of the detection intensity in the inner portion can be calculated by averaging the detection intensity in the range of 2 nm or more, preferably 3 nm or more in a region where the detection intensity of cobalt is saturated and stabilized, e.g., a region ranging from the surface to a depth of 30 nm or more, preferably from the surface to a depth of 50 nm or more, in a depth direction. Although the description is made in the case of cobalt, the average value O_{BG} of oxygen of the background and the average value O_{AVE} of the detection intensity of oxygen in the inner portion can be calculated in a similar manner.

The above-described surface may be used as a reference point. The reference point can be used as a distance or the like from the reference point to show the position of the peak of each element is in a graph showing Counts on the vertical axis. Note that the reference point may be set to a given point other than the surface. The peak in STEM-EDX analysis refers to a detection intensity in each element profile, a local maximum value of a concentration, or a maximum value of a characteristic X-ray of each element, and is different from a distribution.

Next, a quantitative value of an element having a trace concentration is described. When an element has a sufficient concentration, the peak or distribution of the element is observed in STEM-EDX line analysis results. On the other hand, when an element has a trace concentration, the peak and distribution of the element cannot be observed in some cases. In the case where an element has a sufficient concentration and thus its distribution is observed, the quantitative value (atomic %) on the vertical axis is the quantitative value of the element, and the concentration range of the element can be specified by reading the quantitative value (atomic %) on the vertical axis. In the case where an element has a trace concentration and thus its distribution is not observed, STEM-EDX point analysis is also preferably performed to determine the quantitative value in a complex manner. Specifically, the quantitative value is preferably determined in the following complex manner: an energy spectrum is obtained and the spectrum of the element is combined. STEM-EDX line analysis may be used to obtain an energy spectrum; however, STEM-EDX point analysis that can measure a large area is preferable.

The case of calculating a quantitative value of nickel, which is one of the additive elements, is described as an example. Here, it is assumed that nickel is an element in a trace amount that is contained in the surface portion and/or the inner portion 1, and a clear distribution of nickel cannot be observed in STEM-EDX line analysis. In this case, the surface portion and/or the inner portion is subjected to STEM-EDX point analysis, and the obtained energy spectrum is referred to. When an energy peak of nickel is observed in the energy spectrum, the quantitative value (atomic %) on the vertical axis is the quantitative value of nickel. That is, the concentration range of nickel can be specified by reading the vertical axis of the graph. Meanwhile, when the spectrum of nickel is not observed, the quantitative value (atomic %) on the vertical axis can be regarded as an example of the upper limit of the concentration of nickel.

Through such a procedure, a quantitative value of an element at a trace concentration can be calculated.

For example, in the EDX line analysis of the first positive electrode active material 100 containing magnesium as the additive element, a peak of the concentration of magnesium in the surface portion is preferably observed in a region ranging from the particle surface of the first positive electrode active material 100 to a depth of 3 nm, further preferably 1 nm, still further preferably 0.5 nm toward the center of the first positive electrode active material 100. In addition, the concentration of magnesium preferably attenuates 60% or lower of the peak concentration at a depth of 1 nm from the peak. In addition, the concentration of magnesium preferably attenuates to 30% or lower of the peak concentration at a depth of 2 nm from the peak. Note that due to the influence of spatial resolution in the EDX line analysis, the peak position of the concentration of magnesium may have a negative value when a depth from the surface as a reference toward the inner portion has a positive value. The quantitative value of magnesium is preferably greater than 0 atomic %, further preferably greater than or equal to 0.3 atomic % and less than or equal to 7 atomic %, still further preferably greater than or equal to 0.3 atomic % and less than or equal to 5 atomic %. As described later in Example, the quantitative value may vary between crystal planes.

In the EDX line analysis, a peak of the concentration of fluorine in the surface portion is preferably observed in a region ranging from the particle surface of the first positive electrode active material 100 to a depth of 3 nm, further preferably 1 nm, still further preferably 0.5 nm toward the center of the first positive electrode active material 100. It is further preferable that a peak of the concentration of fluorine be slightly closer to the surface than a peak of the concentration of magnesium, which increases resistance to hydrofluoric acid. For example, it is preferable that a peak of the concentration of fluorine be slightly closer to the surface than a peak of the concentration of magnesium by 0.5 nm or more, further preferably 1.5 nm or more.

When the first positive electrode active material 100 contains nickel as the additive element, a peak of the concentration of nickel in the surface portion is preferably observed in a region ranging from the particle surface of the first positive electrode active material 100 to a depth of 3 nm, further preferably 1 nm, still further preferably 0.5 nm toward the center of the first positive electrode active material 100. Alternatively, the peak is preferably observed within ±1 nm from the surface. When the first positive electrode active material 100 contains magnesium and nickel, the distribution of nickel preferably overlaps with the distribution of magnesium. For example, a difference in the depth direction between a peak of the concentration of nickel and a peak of the concentration of magnesium is preferably 10 nm or less, further preferably 3 nm or less, still further preferably 1 nm or less. The quantitative value of nickel is preferably greater than 0 atomic %, further preferably greater than or equal to 0.3 atomic % and less than or equal to 3 atomic %, still further preferably greater than or equal to 0.3 atomic % and less than or equal to 2 atomic %. As described later in Example, the quantitative value may be different between crystal planes.

In the case where the first positive electrode active material 100 contains aluminum as the additive element, the peak of the concentration of magnesium, nickel, or fluorine is preferably closer to the surface than the peak of the concentration of aluminum in the surface portion in the EDX line analysis. For example, the peak of the concentration of aluminum is preferably observed in a region ranging from the surface of the first positive electrode active material 100 to a depth of greater than or equal to 0.5 nm and less than or equal to 50 nm, further preferably greater than or equal to 3 nm and less than or equal to 30 nm toward the center of the first positive electrode active material 100. The quantitative value of aluminum is preferably greater than 0 atomic %, further preferably greater than or equal to 0.1 atomic % and less than or equal to 3 atomic %, still further preferably greater than or equal to 0.1 atomic % and less than or equal to 2 atomic %. As described later in Example, the quantitative value may be different between crystal planes.

When the first positive electrode active material 100 is subjected to EDX line analysis, area analysis, or point analysis, for example, the ratio of the atomic ratio of magnesium to the atomic ratio of cobalt (A_{Mg}/A_{Co}) at the peak position of magnesium is preferably greater than 0 in a region having an edge plane, and specifically, preferably greater than or equal to 0.8 and less than or equal to 1.4, further preferably greater than or equal to 0.9 and less than or equal to 1.3, still further preferably greater than or equal to 1.0 and less than or equal to 1.2. A region having a basal plane is considered to have a lower atomic ratio of Mg than the region having the edge plane. The ratio of the atomic ratio of nickel to the atomic ratio of cobalt (A_{Ni}/A_{Co}) at the peak position of nickel is preferably greater than 0 in the region having the edge plane, preferably greater than or equal to 0.07 and less than or equal to 0.15, further preferably greater than or equal to 0.08 and less than or equal to 0.13, still further preferably greater than or equal to 0.09 and less than or equal to 0.11. The region having the basal plane is considered to have a lower atomic ratio of Mg than the region having the edge plane. The ratio of the atomic ratio of fluorine to the atomic ratio of cobalt (A_{F}/A_{Co}) is preferably greater than 0 in the region having the edge plane, and preferably greater than or equal to 0.5 and less than or equal to 1.0, further preferably greater than or equal to 0.6 and less than or equal to 0.9, still further preferably greater than or equal to 0.7 and less than or equal to 0.8. The atomic ratio is preferably within the above range in a plurality of portions, e.g., three or more portions of the first positive electrode active material 100.

When the line analysis or the area analysis is performed on the first positive electrode active material 100 containing magnesium as the additive element, for example, the ratio of the atomic ratio of magnesium to the atomic ratio of cobalt (A_{Mg}/A_{Co}) in the vicinity of the crystal grain boundary is preferably greater than or equal to 0.020 and less than or equal to 0.50. It is further preferably greater than or equal to 0.025 and less than or equal to 0.30. It is further preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30. The ratio is preferably within the above range in a plurality of portions, e.g., three or more portions of the first positive electrode active material 100.

### <Pretreatment for Analysis>

Before any of various kinds of analyses is performed, a sample such as a positive electrode active material or a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is unlikely to be dissolved even in that case; thus, the quantitative value or the like of the additive element is not affected.

The contents of this embodiment can be freely combined with any of the contents of the other embodiments.

### Embodiment 3

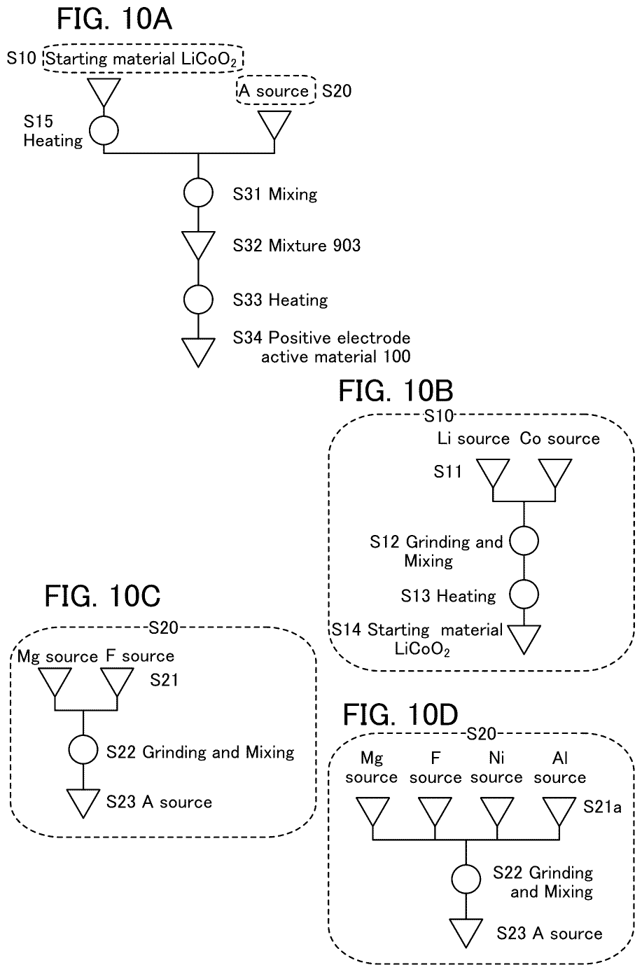

In this embodiment, a method for forming a positive electrode active material of one embodiment of the present invention is described with reference to FIG. 10 to FIG. 12. The positive electrode active material preferably has a median diameter of less than or equal to 12 μm

### Example 1 of Method for Forming Positive Electrode Active Material

An example of a method for forming the positive electrode active material that can be used as one embodiment of the present invention (Example 1 of method for forming positive electrode active material) will be described with reference to FIG. 10A to FIG. 10D. Note that in <Example 1 of method for forming positive electrode active material>, the additive elements described as an additive element X, an additive element Y, and an additive element Z in Embodiment 1 are collectively referred to as an additive element A.

### <Step S10>

First, lithium cobalt oxide is prepared as a starting material in Step S10. The median diameter of the lithium cobalt oxide is preferably less than or equal to 10 μm, further preferably less than or equal to 8 μm. As the lithium cobalt oxide with a median diameter of less than or equal to 10 μm, commercially available lithium cobalt oxide can be used. A typical example of the commercially available lithium cobalt oxide is lithium cobalt oxide produced by NIPPON CHEMICAL INDUSTRIAL CO., LTD. (product name: “CELLSEED C-5H”). In this specification and the like, CELL SEED C-5H is simply referred to as “C-5H”. C-5H has a median diameter of approximately 7 μm.

As the lithium cobalt oxide with a median diameter of less than or equal to 10 μm, lithium cobalt oxide formed through Step S11 to Step S14 shown in FIG. 10B can be used. A formation method of Step S11 to Step S14 is described.

### <Step S11>

In Step S11 shown in FIG. 10B, a lithium source (denoted as Li source in the diagram) and a cobalt source (denoted as Co source in the diagram) are prepared as materials for lithium and a transition metal that are starting materials.

As the lithium source, a lithium-containing compound is preferably used and for example, lithium carbonate, lithium hydroxide, lithium nitrate, or lithium fluoride can be used. The lithium source preferably has a high purity and is preferably a material having a purity higher than or equal to 99.99%, for example.

As the cobalt source, a cobalt-containing compound is preferably used, and for example, tricobalt tetraoxide or cobalt hydroxide can be used. The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities in the positive electrode active material can be controlled by using a high-purity material. As a result, a secondary battery with an increased capacity and increased reliability can be obtained.

### <Step S12>

Next, in Step S12 shown in FIG. 10B, the lithium source and the cobalt source are ground and mixed to form a mixed material. The grinding and mixing can be performed by a dry method or a wet method. To obtain lithium cobalt oxide with a median diameter of less than or equal to 10 μm as a starting material, the grinding and mixing by a wet method are preferred because a material can be crushed into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the transition metal source be mixed into dehydrated acetone whose moisture content is less than or equal to 10 ppm and which has a purity of higher than or equal to 99.5% and be used in the grinding and mixing. With the use of dehydrated acetone with the above-described purity, impurities that might be mixed can be reduced.

A ball mill, a bead mill, or the like can be used as a means for the grinding and mixing, for example. When a ball mill is used, aluminum oxide balls or zirconium oxide balls are preferably used as a medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium.

### <Step S13>

Next, the mixed material described above is heated in Step S13 shown in FIG. 10B.

A temperature rising rate in a temperature rising step of the heat treatment is preferably higher than or equal to 80° C./h and lower than or equal to 250° C./h, although depending on the end-point temperature. In the case where the temperature of a temperature retaining step is 1000° C., for example, the temperature rising rate is preferably 200° C./h.

The temperature rising rate in a treatment chamber of a heat treatment apparatus preferably falls within the above range. Note that the temperature rising rate set for the heat treatment apparatus is not the same as the temperature rising rate in the treatment chamber in some cases. For example, the temperature rising rate in the treatment chamber is sometimes lower than the set temperature rising rate. The set temperature rising rate is preferably adjusted such that the temperature rising rate in the treatment chamber falls within the above range. Note that in the case where the temperature in the treatment chamber cannot be measured, the set temperature rising rate of the heat treatment apparatus preferably falls within the above range. In the case where the temperature of an object can be measured, it is further preferable that the temperature rising rate of the object fall within the above range.

The temperature of the temperature retaining step is preferably higher than or equal to 800° C. and lower than or equal to 1100° C., further preferably higher than or equal to 900° C. and lower than or equal to 1000° C., still further preferably approximately 950° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen vacancy or the like is sometimes induced by a change of trivalent cobalt into divalent cobalt, for example.

The temperature in the treatment chamber of the heat treatment apparatus preferably falls within the above range. Note that the set temperature of the heat treatment apparatus is not the same as the temperature in the treatment chamber in some cases. For example, the temperature in the treatment chamber is sometimes lower than the set temperature. The set temperature is preferably adjusted such that the temperature in the treatment chamber falls within the above range. Note that in the case where the temperature in the treatment chamber cannot be measured, the set temperature of the heat treatment apparatus preferably falls within the above range. In the case where the temperature of an object can be measured, it is further preferable that the temperature of the object fall within the above range.

After the temperature rising step, a phenomenon in which the temperature in the treatment chamber becomes higher than the set temperature (also referred to as overshoot) sometimes occurs at the beginning of the temperature retaining step. Also in the case where the overshoot occurs, the temperature rising rate is preferably adjusted such that the temperature in the treatment chamber falls within the above temperature range of the temperature retaining step. A plurality of temperature rising steps at different temperature rising rates may be provided. For example, a first temperature rising step and a second temperature rising step after the first temperature rising step are provided, and the temperature rising rate in the second temperature rising step is set lower than the temperature rising rate in the first temperature rising step. This can inhibit occurrence of the overshoot. Note that in the case where the temperature temporarily deviates from the temperature range of the temperature retaining step because of the overshoot, the deviation period is preferably short.

When the time of the temperature retaining step is too short, lithium cobalt oxide is sometimes not synthesized, but when the time is too long, the productivity is lowered. For example, the time is preferably longer than or equal to 1 hour and shorter than or equal to 100 hours, further preferably longer than or equal to 2 hours and shorter than or equal to 20 hours.

Note that the temperature rising step, the temperature retaining step, and a cooling step do not need to be strictly distinguished from each other. In the heat treatment, the length of a period in which the temperature falls within the above temperature range is included in the above time range. Thus, in this specification and the like, the temperature of the temperature retaining step is sometimes referred to as a heat treatment temperature or a heating temperature, and the time of the temperature retaining step is sometimes referred to as a heat treatment time or a heating time.

The atmosphere of each of the temperature rising step and the temperature retaining step preferably contains oxygen. Examples of an oxygen-containing atmosphere include an oxygen atmosphere, a dry air atmosphere, an air atmosphere, and an atmosphere in which oxygen and another gas (e.g., one or more selected from nitrogen and noble gases) are mixed. Examples of a noble gas include argon. Moreover, nitrogen, a noble gas, or a mixture of two or more selected from nitrogen and noble gases may be used as the atmosphere.

The atmosphere of each of the temperature rising step and the temperature retaining step preferably contains little moisture. The dew point of the atmosphere is preferably lower than or equal to −50° C., further preferably lower than or equal to −80° C., for example. Dry air can be suitably used for the temperature rising step and the temperature retaining step. When the concentrations of impurities such as CH₄, CO, CO₂, and H₂ in the atmosphere are each lower than or equal to 5 ppb (parts per billion), entry of impurities into a material can sometimes be inhibited.

There is a method in which a gas is continuously introduced into a treatment chamber used for the heat treatment. This method can be regarded as flowing a gas into the treatment chamber. In that case, the flow rate of the gas is, for example, higher than or equal to 0.1 L/min and lower than or equal to 0.7 L/min per liter of volume of the treatment chamber. In the case where the capacity of the treatment chamber is 40 L, the flow rate is preferably 10 L/min or an approximate value thereof. As the gas, for example, an oxygen gas, dry air, a nitrogen gas, a noble gas, or a mixed gas of two or more selected from these gases can be used.

A method may be employed in which after the atmosphere in the treatment chamber is replaced with a desired gas, the gas is prevented from entering and exiting from the treatment chamber. For example, the atmosphere in the treatment chamber can be replaced with an oxygen-containing gas and the gas can be prevented from entering and exiting from the treatment chamber. Alternatively, the gas may be introduced after the pressure in the treatment chamber is reduced. Specifically, the pressure in the treatment chamber is reduced to −970 hPa, which is measured by a differential pressure gauge, and then the gas is introduced until the pressure reaches 50 hPa, for example.

After the temperature retaining step, the object is cooled down in the cooling step. The time of the cooling step is longer than or equal to 15 minutes and shorter than or equal to 50 hours, for example. The cooling step may be performed by natural cooling. The temperature does not necessarily need to decrease to room temperature as long as it decreases to a temperature acceptable to the next step.

The atmosphere of the cooling step preferably contains oxygen. Examples of an oxygen-containing atmosphere include an oxygen atmosphere, a dry air atmosphere, an air atmosphere, and an atmosphere in which oxygen and another gas (e.g., one or more selected from nitrogen and noble gases) are mixed. Moreover, nitrogen, a noble gas, or a mixture of two or more selected from nitrogen and noble gases may be used as the atmosphere.

In the cooling step, a gas may be introduced into the treatment chamber. Alternatively, a gas may be continuously introduced into the treatment chamber in the cooling step. As the gas, an oxygen gas, dry air, a nitrogen gas, a noble gas, a mixed gas of two or more selected from these gases, or the like can be used.

In the cooling step, the temperature in the treatment chamber is controlled using a heater or the like so that the temperature can be gradually decreased from the temperature of the temperature retaining step. In the cooling step, heating may be performed to a temperature that is higher than room temperature and lower than the temperature of the temperature retaining step.

In the cooling step, cooling may be performed at room temperature instead of heating using a heater or the like.

The gas used in the cooling step may be heated to a temperature higher than room temperature. Alternatively, the gas used in the cooling step may be cooled down to a temperature lower than room temperature. Alternatively, one or both of the heat treatment apparatus and the treatment chamber may be cooled down using a cooling solvent such as cooling water. For example, cooling is performed by circulating cooling water around the periphery of the treatment chamber.

In the heat treatment, the temperature rising step and the temperature retaining step may be performed in the same treatment chamber as the cooling step. Alternatively, the temperature rising step and the temperature retaining step may be performed in a different treatment chamber from the cooling step.

In the case where a rotary kiln is used for the heat treatment, the temperature rising step, the temperature retaining step, and the cooling step can be successively performed in the rotary kiln. Alternatively, the cooling step or part of the cooling step may be performed outside the rotary kiln.

A case of using a roller hearth kiln is described. The roller hearth kiln preferably includes at least three regions: a region where the temperature rising step is performed (hereinafter, a temperature rising zone), a region where the temperature retaining step is performed (hereinafter, a temperature retaining zone), and a region where the cooling step is performed (hereinafter, a cooling zone), for example. The mixed material prepared in Step S12 is put in a container for heating such as a sagger, and is transferred sequentially to the temperature rising zone, the temperature retaining zone, and the cooling zone of the roller hearth kiln.

A container used at the time of the heating is preferably a crucible made of aluminum oxide or a sagger made of aluminum oxide. A crucible made of aluminum oxide has a material property that hardly allows the entry of impurities. In this embodiment, a sagger made of aluminum oxide with a purity of 99.9% is used. Note that the heating is preferably performed with the crucible or the sagger covered with a lid, in which case volatilization of a material can be prevented.

After the heating, the heated material is crushed as needed and then may be made to pass through a sieve. Before collection of the heated material, the material may be moved from the crucible to a mortar. As the mortar, a mortar made of zirconium oxide or agate is suitably used. Note that heating conditions equivalent to those in Step S13 can be employed in a later-described heating step other than Step S13.

### <Step S14>

Through the above steps, lithium cobalt oxide (LiCoO₂) can be synthesized as shown in Step S14 in FIG. 10B. The lithium cobalt oxide (LiCoO₂) shown in Step S14 can be referred to as a composite oxide. Note that the lithium cobalt oxide (LiCoO₂) shown in Step S14 may be obtained after particle size distribution is adjusted by performing a crushing step and a classification step after Step S13.

Although the example is described in which the composite oxide is formed by a solid phase method as in Step S11 to Step S14, the composite oxide may be formed by a coprecipitation method. Alternatively, the composite oxide may be formed by a hydrothermal method.

### <Step S15>

Next, as Step S15 shown in FIG. 10A, the lithium cobalt oxide that is a starting material is heated. The heating in Step S15 is the first heating performed on the lithium cobalt oxide and thus is sometimes referred to as initial heating in this specification and the like. The heating is performed before Step S31 described below, and thus is sometimes referred to as preheating or pretreatment.

By the initial heating, a lithium compound or the like unintentionally remaining on the surface of the lithium cobalt oxide is extracted. In addition, an effect of increasing the crystallinity of the inner portion can be expected. Although the lithium source and/or the cobalt source prepared in Step S11 and the like might contain impurities, impurities in the lithium cobalt oxide that is a starting material can be reduced by the initial heating. Note that the effect of increasing the crystallinity of the inner portion is, for example, an effect of reducing distortion, a shift, or the like derived from differential shrinkage or the like of the lithium cobalt oxide formed in Step S14.

Through the initial heating, an effect of smoothing the surface of the lithium cobalt oxide is obtained. Furthermore, through the initial heating, an effect of reducing a crack, a crystal defect, or the like included in the lithium cobalt oxide is obtained.

For the initial heating, it may be unnecessary to separately prepare a lithium source, an additive element source, or a material functioning as a fusing agent.

In this step, too short a heating time does not produce a sufficient effect, whereas too long a heating time lowers the productivity. For example, as an appropriate range of the heating time, any of the heating conditions described for Step S13 can be selected to perform this step. The heating temperature in Step S15 is preferably lower than the temperature in Step S13 so that the crystal structure of the composite oxide is maintained. The heating time in Step S15 is preferably shorter than the time in Step S13 so that the crystal structure of the composite oxide is maintained. For example, the heating is preferably performed at higher than or equal to 700° C. and lower than or equal to 1000° C. (further preferably higher than or equal to 800° C. and lower than or equal to 900° C.) for longer than or equal to 1 hour and shorter than or equal to 20 hours (further preferably longer than or equal to 1 hour and shorter than or equal to 5 hours).

The heating in Step S13 causes a temperature difference between the surface and the inner portion of the lithium cobalt oxide in some cases. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the energy is sometimes referred to as distortion energy. The internal stress is removed by the initial heating in Step S15; in other words, the distortion energy is probably equalized by the initial heating in Step S15. When the distortion energy is equalized, the distortion in the lithium cobalt oxide is relieved. Accordingly, the surface of the lithium cobalt oxide becomes smooth. It can also be said that surface improvement is achieved. In other words, Step S15 can reduce the differential shrinkage caused in the lithium cobalt oxide and make the surface of the composite oxide smooth.

Such differential shrinkage might cause a micro shift in the lithium cobalt oxide, such as a shift in a crystal. To reduce this shift, Step S15 is preferably performed. Performing Step S15 can distribute a shift uniformly in the composite oxide (reduce the shift in a crystal or the like which is caused in the composite oxide or align crystal grains). As a result, the surface of the composite oxide becomes smooth.

The use of lithium cobalt oxide with a smooth surface as a positive electrode active material can improve the safety of a secondary battery, suppress deterioration due to charge and discharge, and prevent breakage in the positive electrode active material.

Note that Step S15 is not essential in one embodiment of the present invention; thus, an embodiment in which Step S15 is skipped is also included in one embodiment of the present invention.

### <Step S20>

Next, details of Step S20 of preparing the additive element A as an A source are described with reference to FIG. 10C and FIG. 10D.

### <Step S21>

Step S20 illustrated in FIG. 10C includes Step S21 to Step S23. In Step S21, the additive element A is prepared. As specific examples of the additive element A, one or more selected from magnesium, fluorine, nickel, aluminum, titanium, zirconium, vanadium, iron, manganese, chromium, niobium, arsenic, zinc, silicon, sulfur, phosphorus, and boron can be used. FIG. 10C illustrates an example of the case where a magnesium source (denoted as Mg source in the diagram) and a fluorine source (denoted as F source in the diagram) are prepared. Note that in Step S21, a lithium source may be separately prepared in addition to the additive element A.

When magnesium is selected as the additive element A, the additive element A source can be referred to as a magnesium source. As the magnesium source, magnesium fluoride (MgF₂), magnesium oxide (MgO), magnesium hydroxide (Mg(OH)₂), magnesium carbonate (MgCO₃), or the like can be used. Two or more of these magnesium sources may be used.

When fluorine is selected as the additive element A, the additive element A source can be referred to as a fluorine source. As the fluorine source, it is possible to use, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), or sodium aluminum hexafluoride (Na₃AlF₆). In particular, lithium fluoride is preferable because it is easily melted in a later-described heating step owing to its relatively low melting point of 848° C. That is, lithium fluoride can function as a fusing agent (also referred to as a flux agent).

Magnesium fluoride can be used as both the fluorine source and the magnesium source. Lithium fluoride can also be used as the lithium source. Another example of the lithium source that can be used in Step S21 is lithium carbonate.

The fluorine source may be a gas; fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in the later-described heating step. Two or more of fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed such that LiF:MgF₂ is approximately 65:35 (molar ratio), the effect of lowering the melting point is maximized. When the proportion of lithium fluoride is too high, cycle performance might deteriorate because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or an approximate value thereof). Note that in this specification and the like, the expression “an approximate value of a given value” means greater than 0.9 times and less than 1.1 times the given value, unless otherwise specified.

### <Step S22>

Next, in Step S22 shown in FIG. 10C, the magnesium source and the fluorine source are ground and mixed. Any of the conditions for grinding and mixing that are described for Step S12 can be selected to perform this step.

### <Step S23>

Subsequently, in Step S23 shown in FIG. 10C, the materials ground and mixed in the above step are collected to give the additive element A source (A source). Note that the additive element A source in Step S23 contains a plurality of starting materials and can also be referred to as a mixture.

As for the particle diameter of the mixture, the median diameter is preferably greater than or equal to 100 nm and less than or equal to 10 μm, further preferably greater than or equal to 300 nm and less than or equal to 5 μm. Also when one kind of material is used as the additive element A source, the median diameter is preferably greater than or equal to 100 nm and less than or equal to 10 μm, further preferably greater than or equal to 300 nm and less than or equal to 5 μm.

A mixture pulverized in Step S22 (which may contain only one kind of the additive element) is easily attached to the surface of the lithium cobalt oxide uniformly when mixed with the lithium cobalt oxide in a later step. The mixture is preferably attached uniformly to the surface of the lithium cobalt oxide, in which case the additive element is easily distributed or dispersed uniformly in the surface portion of the composite oxide after heating.

### <Step S21a>

A process different from that in FIG. 10C is described with reference to FIG. 10D. Step S20 shown in FIG. 10D includes Step S21a to Step S23.

In Step S21a shown in FIG. 10D, four kinds of additive element A sources to be added to the lithium cobalt oxide are prepared. In other words, FIG. 10D is different from FIG. 10C in the kinds of the additive element A sources. A lithium source may be separately prepared in addition to the additive element A sources.

As the four kinds of additive element A sources, a magnesium source (denoted as Mg source in the diagram), a fluorine source (denoted as F source in the diagram), a nickel source (denoted as Ni source in the diagram), and an aluminum source (denoted as Al source in the diagram) are prepared. The magnesium source and the fluorine source can be selected from the compounds and the like described with reference to FIG. 10C. As the nickel source, nickel oxide, nickel hydroxide, or the like can be used. As the aluminum source, aluminum oxide, aluminum hydroxide, or the like can be used.

### <Step S22> and <Step S23>

Next, Step S22 and Step S23 shown in FIG. 10D are similar to Step S22 and Step S23 described with reference to FIG. 10C.

### <Step S31>

Next, in Step S31 shown in FIG. 10A, the lithium cobalt oxide obtained through Step S15 (initial heating) and the additive element A source are mixed. Here, the ratio between the atomic ratio of cobalt A_{Co} in the lithium cobalt oxide obtained through Step S15 and the atomic ratio of magnesium A_{Mg} contained in the additive element A is preferably A_{Co}:A_{Mg}=100:y (0.1≤y≤6), further preferably A_{Co}:A_{Mg}=100:y (0.3≤y≤3). Since the lithium cobalt oxide obtained through the initial heating has a smooth surface, the additive element A can be uniformly added. Thus, the initial heating (Step S15) is preferably performed not after the addition of the additive element A but before the addition of the additive element A.

When nickel is selected as the additive element A, the mixing in Step S31 is preferably performed such that the number of nickel atoms in the nickel source is greater than or equal to 0.05% and less than or equal to 4% of the number of cobalt atoms in the lithium cobalt oxide obtained through Step S15. When aluminum is selected as the additive element A, the mixing in Step S31 is preferably performed such that the number of aluminum atoms in the aluminum source is greater than or equal to 0.05% and less than or equal to 4% of the number of cobalt atoms in the lithium cobalt oxide obtained through Step S15.

The conditions of the mixing in Step S31 are preferably milder than those of the grinding and mixing in Step S12 not to damage the shape of the lithium cobalt oxide. For example, conditions with a smaller number of rotations or a shorter time than that of the mixing in Step S12 are preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room with a dew point of −100° C. to −10° C., both inclusive.

### <Step S32>

Next, in Step S32 in FIG. 10A, the materials mixed in the above manner are collected, whereby a mixture 903 is obtained.

### <Step S33>

Then, in Step S33 shown in FIG. 10A, the mixture 903 is heated. The heating temperature in Step S33 is preferably higher than or equal to 800° C. and lower than or equal to 1100° C., further preferably higher than or equal to 800° C. and lower than or equal to 950° C., still further preferably higher than or equal to 850° C. and lower than or equal to 900° C. The heating time in Step S33 is longer than or equal to 1 hour and shorter than or equal to 100 hours and is preferably longer than or equal to 1 hour and shorter than or equal to 10 hours. The lower limit of the heating temperature in Step S33 needs to be higher than or equal to the temperature at which a reaction between the lithium cobalt oxide and the additive element A source proceeds. The temperature at which the reaction proceeds is the temperature at which interdiffusion of the elements contained in the lithium cobalt oxide and the additive element A source occurs, and may be lower than the melting temperatures of these materials. In the case where an oxide is described as an example, solid phase diffusion occurs at the temperature of 0.757 times the melting temperature Tₘ (Tammann temperature T_{d}); thus, the heating temperature in Step S33 is higher than or equal to 500° C.

For example, in the case where LiF and MgF₂ are included as the additive element A source, the lower limit of the heating temperature in Step S33 is preferably higher than or equal to 742° C. because the eutectic point of LiF and MgF₂ is around 742° C. as shown in FIG. 4. Note that the reaction proceeds more easily at a temperature higher than or equal to the temperature at which one or more selected from the starting materials of the mixture 903 are melted.

The mixture 903 obtained by mixing such that LiCoO₂:LiF:MgF₂=100:0.33:1 (molar ratio) exhibits an endothermic peak at around 830° C. in differential scanning calorimetry (DSC) measurement as shown in FIG. 5. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the melting point (1130° C.) of the lithium cobalt oxide. At a temperature around the melting point, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In addition, at the time of heating the mixture 903, the partial pressure of fluorine or a fluoride originating from the fluorine source or the like is preferably controlled to fall within an appropriate range.

In the formation method described in this embodiment, some of the materials, e.g., LiF as the fluorine source, function as a fusing agent in some cases. Owing to this function, the heating temperature can be lower than the melting point of the lithium cobalt oxide, e.g., a temperature higher than or equal to 742° C. and lower than or equal to 950° C., which allows distribution of the additive element such as magnesium in the surface portion and formation of the positive electrode active material having favorable characteristics.

Since LiF in a gas phase has a specific gravity less than that of oxygen, heating might volatilize LiF and thus LiF in the mixture 903 decreases. In this case, the function of a fusing agent deteriorates. Therefore, heating is preferably performed while volatilization of LiF is inhibited. Note that even when LiF is not used as the fluorine source or the like, Li at the surface of LiCoO₂ and F of the fluorine source might react to produce LiF, which might be volatilized. Thus, such inhibition of volatilization is needed also when a fluoride having a higher melting point than LiF is used.

In view of the above, the mixture 903 is preferably heated with a container in which the mixture 903 is put covered with a lid. Such heating can inhibit volatilization of LiF in the mixture 903.

The heating in this step is preferably performed such that the mixtures 903 are not adhered to each other. Adhesion of the mixtures 903 during the heating might decrease the area of contact with oxygen in the atmosphere and inhibit a diffusion path of the additive element (e.g., fluorine), thereby hindering distribution of the additive elements (e.g., magnesium and fluorine) in the surface portion.

Uniform distribution of the additive element (e.g., fluorine) in the surface portion leads to a smooth positive electrode active material with little unevenness. Thus, it is preferable that the mixtures 903 not be adhered to each other in order to allow the smooth surface obtained through the heating in Step S15 to be maintained or to be smoother in this step.

### <Step S34>

Next, in Step S34 shown in FIG. 10A, the heated material is collected to give the positive electrode active material containing the additive element A, which is one embodiment of the present invention. The collected material may be crushed as needed. In addition, the collected material is preferably made to pass through a sieve. Through the above process, the positive electrode active material of one embodiment of the present invention can have a median diameter of less than or equal to 12 μm (preferably less than or equal to 10.5 μm, further preferably less than or equal to 8 μm).

### Example 2 of Method for Forming Positive Electrode Active Material

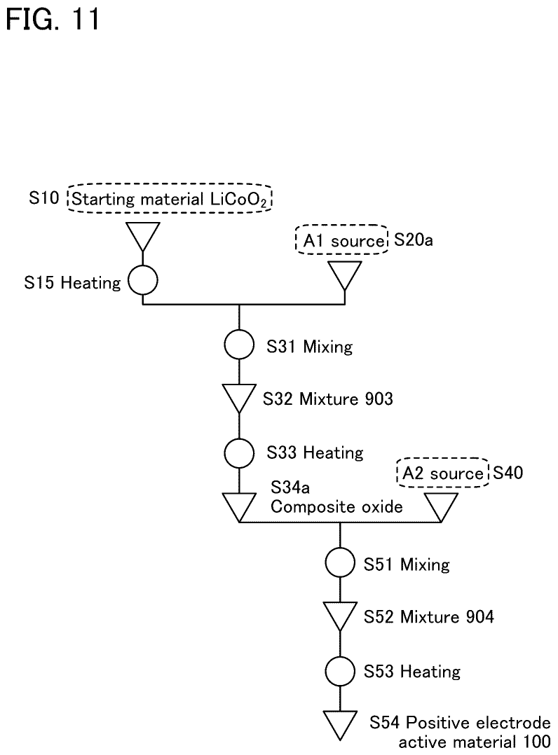

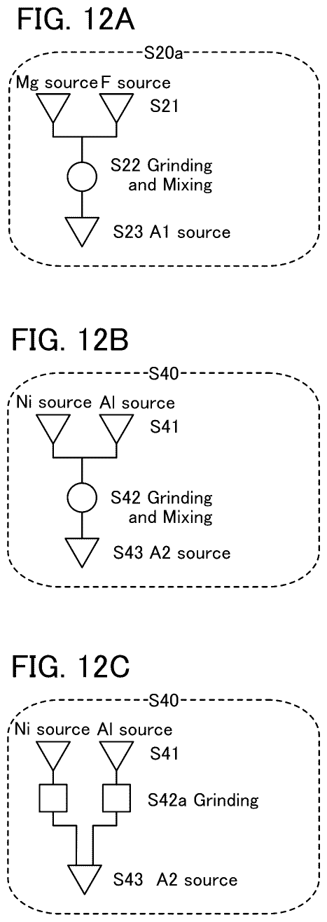

Another example of a method for forming the positive electrode active material (Example 2 of method for forming positive electrode active material) will be described with reference to FIG. 11 and FIG. 12. Although Example 2 of method for forming positive electrode active material is different from Example 1 of method for forming positive electrode active material described above in the number of times of adding the additive element and the mixing method, the description of Example 1 of method for forming positive electrode active material can be referred to for the description of the other points. Note that in <Example 2 of method for forming positive electrode active material>, the additive element X described in Embodiment 1 is referred to as an additive element A1. In addition, the additive element Y and the additive element Z described in Embodiment 1 are collectively referred to as an additive element A2.

### <Step S10> and <Step S15>

Step S10 and Step S15 in FIG. 11 are performed as in FIG. 10A to prepare lithium cobalt oxide obtained through the initial heating. Note that Step S15 is not essential in one embodiment of the present invention; thus, an embodiment in which Step S15 is skipped is also included in one embodiment of the present invention.

### <Step S20a>

Next, as shown in Step S20a, a first additive element A1 source (denoted as A1 source in the diagram) is prepared. Step S20a is described in detail with reference to FIG. 12A.

### <Step S21>

In Step S21 shown in FIG. 12A, the first additive element A1 source (denoted as A1 source in the diagram) is prepared. The A1 source can be selected from the additive elements A described for Step S21 shown in FIG. 10C. For example, one or more selected from magnesium, fluorine, and calcium can be used as the additive element A1. FIG. 12A illustrates an example of the case where a magnesium source (denoted as Mg source in the diagram) and a fluorine source (denoted as F source in the diagram) are used as the additive element A1.

Step S21 to Step S23 illustrated in FIG. 12A can be performed under conditions similar to those in Step S21 to Step S23 illustrated in FIG. 10C. As a result, the additive element A1 source (A1 source) can be obtained in Step S23.

Steps S31 to S33 illustrated in FIG. 11 can be performed under conditions similar to those in Steps S31 to S33 illustrated in FIG. 10A.

### <Step S34a>

Next, the material heated in Step S33 is collected to obtain lithium cobalt oxide containing the additive element A1. Here, the obtained lithium cobalt oxide is also called a second composite oxide to be distinguished from the lithium cobalt oxide obtained through Step S15 (first composite oxide).

### <Step S40>

In Step S40 shown in FIG. 11, a second additive element A2 source (denoted as A2 source in the diagram) is prepared. Step S40 is described also with reference to FIG. 12B and FIG. 12C.

### <Step S41>

In Step S40 illustrated in FIG. 12B, the second additive element A2 source (denoted as A2 source in the diagram) is prepared. The A2 source can be selected from the additive elements A described for Step S20 illustrated in FIG. 10C. For example, one or more selected from nickel, titanium, boron, zirconium, and aluminum can be suitably used as the additive element A2. FIG. 12B illustrates an example of the case where a nickel source and an aluminum source are used as the additive element A2.

Step S41 to Step S43 illustrated in FIG. 12B can be performed under conditions similar to those in Step S21 to Step S23 illustrated in FIG. 10C. As a result, the additive element A2 source (denoted as A2 source in the diagram) can be obtained in Step S43.

Step S41 to Step S43 illustrated FIG. 12C are a variation example of those in FIG. 12B. A nickel source (denoted as Ni source in the diagram) and an aluminum source (denoted as Al source in the diagram) are prepared in Step S41 illustrated in FIG. 12C and are separately ground in Step S42a. Accordingly, a plurality of the second additive element A2 sources (denoted as A2 sources in the diagram) are prepared in Step S43. As described above, Step S40 in FIG. 12C is different from Step S40 in FIG. 12B in that the additive element sources are separately ground in Step S42a.

### <Step S51> to <Step S53>

Next, Step S51 to Step S53 illustrated in FIG. 11 can be performed under conditions similar to those in Step S31 to Step S34 illustrated in FIG. 10A. The heating in Step S53 is preferably performed under conditions of a lower temperature and/or a shorter time than those of the heating in Step S33 illustrated in FIG. 11. Specifically, the heating temperature is preferably higher than or equal to 800° C. and lower than or equal to 950° C., further preferably higher than or equal to 820° C. and lower than or equal to 870° C., still further preferably 850° C.±10° C. The heating time is preferably longer than or equal to 0.5 hours and shorter than or equal to 8 hours, further preferably longer than or equal to 1 hour and shorter than or equal to 5 hours.

When nickel is selected as the additive element A2, the mixing in Step S51 is preferably performed such that the number of nickel atoms in the nickel source is greater than or equal to 0.05% and less than or equal to 4% of the number of cobalt atoms in the lithium cobalt oxide obtained through Step S15. When aluminum is selected as the additive element A2, the mixing in Step S51 is preferably performed such that the number of aluminum atoms in the aluminum source is greater than or equal to 0.05% and less than or equal to 4% of the number of cobalt atoms in the lithium cobalt oxide obtained through Step S15.

### <Step S54>

Next, in Step S54 illustrated in FIG. 11, the heated material is collected, whereby the positive electrode active material of one embodiment of the present invention containing the additive element A1 and the additive element A2 is obtained. The collected material may be crushed as needed. In addition, the collected material may be made to pass through a sieve. Through the above process, the positive electrode active material (composite oxide) of one embodiment of the present invention can have a median diameter of less than or equal to 12 μm (preferably less than or equal to 10.5 μm, further preferably less than or equal to 8 μm).

In Example 2 of the formation method described above, introduction of the additive element to the lithium cobalt oxide is divided into introduction of the first additive element A1 and that of the second additive element A2 as illustrated in FIG. 11 and FIG. 12. When the additive elements are separately introduced, the additive elements are made different in distribution in the depth direction. For example, the first additive element can be distributed such that its concentration is higher in the surface portion than in the inner portion, and the second additive element can be distributed such that its concentration is higher in the inner portion than in the surface portion. The positive electrode active material of one embodiment of the present invention formed through the steps in FIG. 10A and FIG. 10D has an advantage of being formed at low cost since a plurality of kinds of additive element A sources are added at the same time. Meanwhile, although the formation cost of the positive electrode active material of one embodiment of the present invention formed through FIG. 11 and FIG. 12 is relatively high since a plurality of kinds of additive element A sources are separately added in a plurality of steps, the distribution of each of the additive elements A in the depth direction can be more accurately controlled, which is preferable.

### Example 1 of Method for Manufacturing Positive Electrode

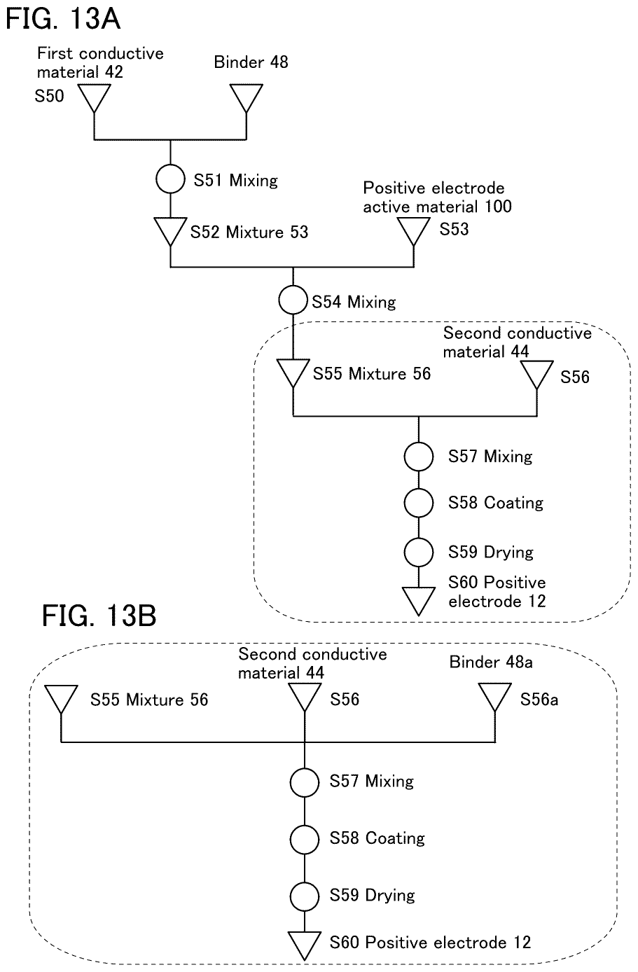

An example of a method for manufacturing a positive electrode is described with reference to FIG. 13A. The positive electrode includes the first conductive material 42, a binder 48, a positive electrode active material of one embodiment of the present invention, and the second conductive material 44.

### <Step S50 to Step S52>

In Step S50 illustrated in FIG. 13A, the first conductive material 42 and the binder 48 are prepared, mixed as illustrated in Step S51, so that a mixture 53 is formed as illustrated in Step S52. In the case where PVDF is used as the binder 48, NMP is preferably used as the organic solvent, and the first conductive material 42 is preferably added and mixed after mixing of PVDF and NMP. According to this procedure, the dispersibility of the binder 48 and the first conductive material 42 can be maintained.

### <Step S53>

In Step S53 illustrated in FIG. 13A, the positive electrode active material (referred to as the positive electrode active material 100 in the drawing) of one embodiment of the present invention obtained in accordance with the above manufacturing method is prepared.

### <Step S54 and Step S55>

In Step S54 illustrated in FIG. 13A, the mixture 53 and the positive electrode active material of one embodiment of the present invention are mixed, so that a mixture 56 is formed as illustrated in the next Step S55. For the mixing in Step S54, a planetary centrifugal mixer, e.g., Awatorirentaro, is preferably used.

### <Step 56>

As illustrated in Step S56 in FIG. 13A, the second conductive material 44 is prepared. The second conductive material 44 is preferably dispersed in a dispersion liquid. NMP is preferably used as the dispersion liquid.

### <Step S57 and Step S58>

In Step S57 illustrated in FIG. 13A, the mixture 56 and the second conductive material 44 are mixed, and then the mixture is applied to coat the positive electrode current collector 31 or the like as illustrated in Step S58 to form a precursor of the positive electrode.

### <Step S59 and Step S60>

In Step S59 illustrated in FIG. 13A, the positive electrode is dried at higher than or equal to 60° C. and lower than or equal to 120° C., preferably higher than or equal to 70° C. and lower than or equal to 90° C., so that the positive electrode 12 is obtained as illustrated in Step S60. Although not illustrated, the precursor of the positive electrode is preferably pressed with a roller press machine before and after the drying step in Step S59. As a pressing treatment condition, a linear pressure is 210 kN/m. Note that each of an upper roll and a lower roll of the roller press machine is preferably set to 120° C. Although the temperatures of the upper roll and the lower roll are not necessarily equal to each other, the temperatures are preferably higher than or equal to the temperature at which the binder 48 starts to melt.

### Example 2 of Method for Manufacturing of Positive Electrode

An example of a method for manufacturing a positive electrode is described with reference to FIG. 13B. The positive electrode includes the first conductive material 42, the binder 48, the positive electrode active material of one embodiment of the present invention, and the second conductive material 44.

### <Step S50 to Step S56>

FIG. 13B illustrates another example of the steps surrounded by the dashed line illustrated in FIG. 13A. Thus, Step S50 to Step S54 are performed as illustrated in FIG. 13A to prepare the mixture 56 illustrated in Step S55. Furthermore, as illustrated in Step S56, the second conductive material 44 is prepared.

### <Step S56a>

Next, unlike in FIG. 13A, a binder 48a is prepared in Step S56a illustrated in FIG. 13B. The binder 48a may be the same as the binder 48 prepared in Step S50. The binder 48a is also preferably dissolved in a dispersant, and NMP is preferably used as the dispersant. Furthermore, the addition amount of the binder 48a in this step is preferably adjusted so that the total amount of the binder 48 and the binder 48a can be the amount of the binder of the positive electrode 12. For example, half of the amount of the binder to be contained in the positive electrode 12 is added as the binder 48 in Step S50, and a remaining amount (half the amount) of the binder to be contained in the positive electrode 12 is added as the binder 48a in Step S56a.

### <Step S57 to Step S60>

After that, as in FIG. 13A, the positive electrode 12 is obtained through Step S57 to Step S60 in FIG. 13B.

In this manner, the positive electrode 12 including the first conductive material 42, the second conductive material 44, the positive electrode active material of one embodiment of the present invention, the binder 48, and the like is manufactured.

The contents of this embodiment can be freely combined with the contents of the other embodiments.

### Embodiment 4

In this embodiment, the appearance of a secondary battery will be described. The appearance may also be referred to as a shape.

### <Coin-Type Secondary Battery>

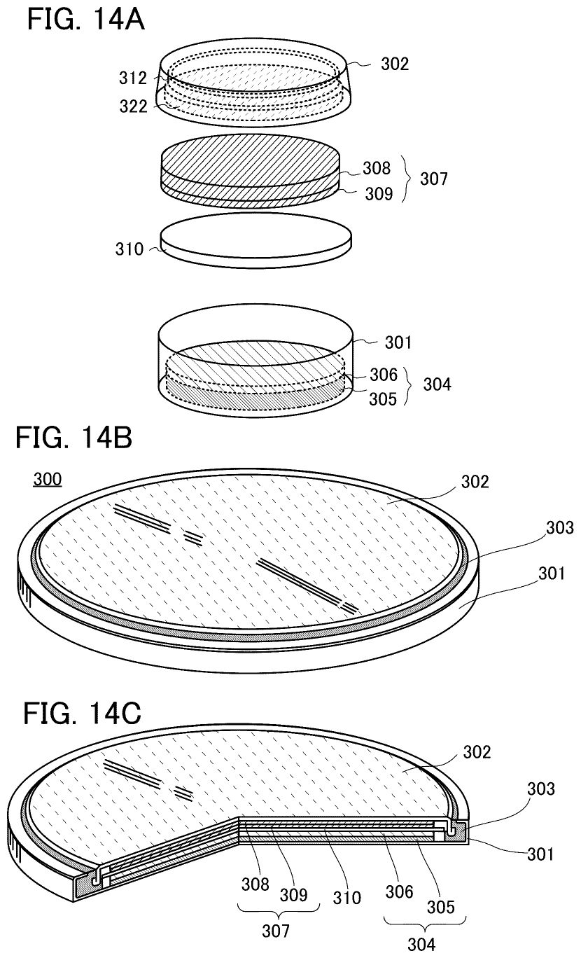

An example of a coin-type secondary battery is described. FIG. 14A is an exploded perspective view of a coin-type (single-layer flat type) secondary battery, FIG. 14B is an external view thereof, and FIG. 14C is a cross-sectional view thereof. Coin-type secondary batteries are mainly used in small electronic devices.

For easy understanding, FIG. 14A is a schematic view illustrating overlap (a vertical relation and a positional relation) between components. Thus, FIG. 14A and FIG. 14B do not completely coincide with each other.

In FIG. 14A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 14A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

FIG. 14B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is preferably provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution or the like. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 14C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is manufactured.

The coin-type secondary battery 300 including the above-described positive electrode 12 or the like can have high discharge capacity and improved safety.

### <Cylindrical Secondary Battery>

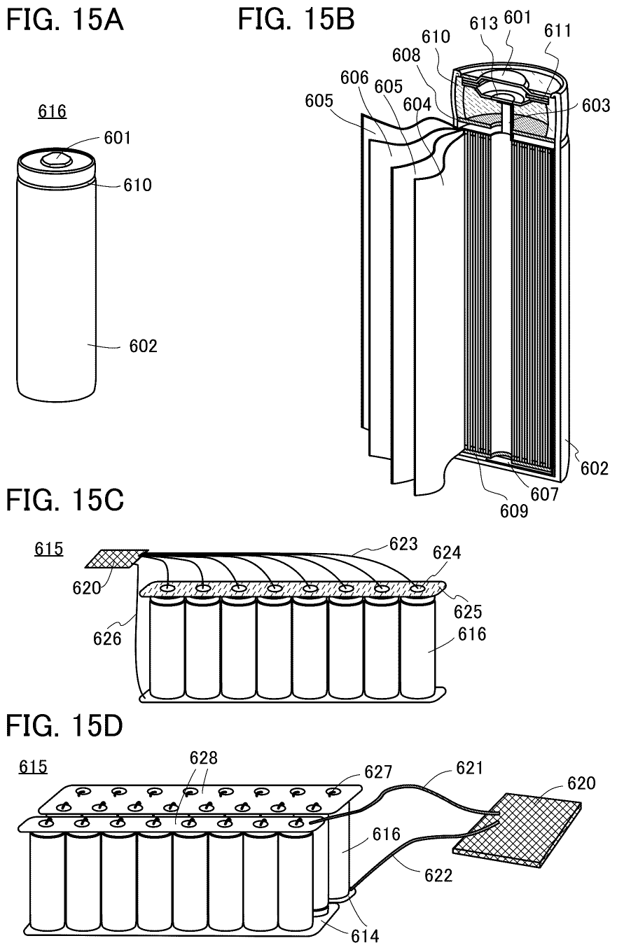

An example of a cylindrical secondary battery is described with reference to FIG. 15A. As illustrated in FIG. 15A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 15B is a diagram schematically illustrating a cross section of a cylindrical secondary battery. The cylindrical secondary battery illustrated in FIG. 15B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a central axis. One end of the battery can 602 is closed and the other end thereof is opened. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, an electrolyte solution (not illustrated) is injected inside the battery can 602 provided with the battery element. An electrolyte solution similar to that for the coin-type secondary battery can be used.

Since a positive electrode and a negative electrode that are used for a cylindrical storage battery are wound, active materials are preferably formed on both surfaces of a current collector.

The cylindrical secondary battery 616 including the above-described positive electrode 12 or the like can have high discharge capacity and improved safety.

A positive electrode terminal (positive electrode current collecting lead) 603 is connected to the positive electrode 604, and a negative electrode terminal (negative electrode current collecting lead) 607 is connected to the negative electrode 606. For the positive electrode terminal 603, a metal material such as aluminum can be used. For the negative electrode terminal 607, a metal material such as copper can be used. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (Positive Temperature Coefficient) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases with a temperature rise, limits the amount of current by increasing the resistance, in order to prevent abnormal heat generation. Barium titanate (BaTiO₃)-based semiconductor ceramics or the like can be used for the PTC element.

FIG. 15C shows an example of a power storage system 615. The power storage system 615 includes a plurality of the secondary batteries 616. The positive electrodes of the secondary batteries are in contact with and electrically connected to conductors 624 isolated by an insulator 625. The conductors 624 are electrically connected to a control circuit 620 through wirings 623. The negative electrodes of the secondary batteries are electrically connected to the control circuit 620 through a wiring 626. As the control circuit 620, a charge and discharge control circuit for performing charge, discharge, and the like or a protection circuit for preventing overcharge and/or overdischarge can be used.

FIG. 15D illustrates an example of the power storage system 615. The power storage system 615 includes a plurality of the secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is unlikely to be influenced by the outside temperature.

In FIG. 15D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### <Other Structure Examples of Secondary Battery>

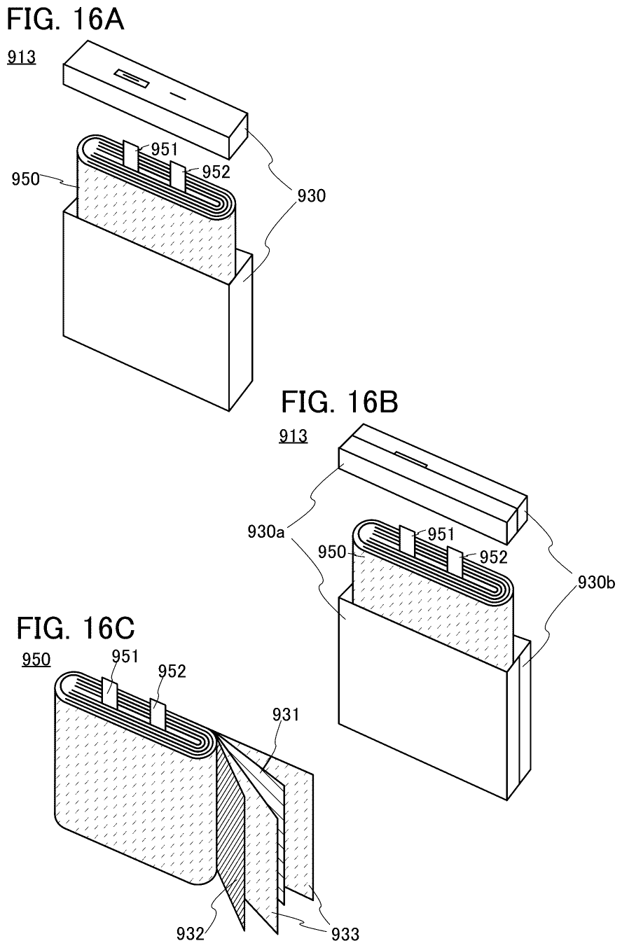

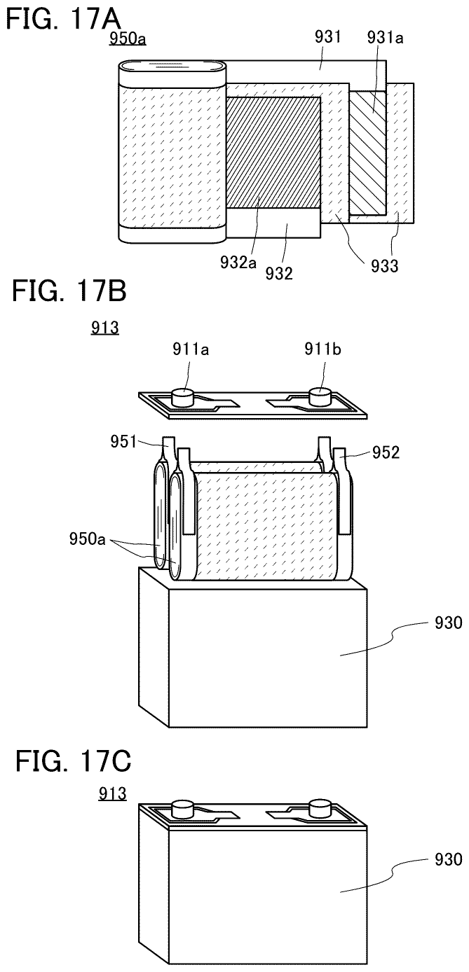

Structure examples of secondary batteries will be described with reference to FIG. 16 and FIG. 17.

A secondary battery 913 illustrated in FIG. 16A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 16A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a stack of a metal material and a resin material can be used.

Note that as illustrated in FIG. 16B, the housing 930 illustrated in FIG. 16A may be formed using a plurality of materials. For example, in the secondary battery 913 illustrated in FIG. 16B, a housing 930a and a housing 930b are attached to each other, and the wound body 950 is provided in a region surrounded by the housing 930a and the housing 930b.

For the housing 930a, a metal material (e.g., aluminum) or a stack of a metal material and a resin material can be used. In particular, when an insulating material such as an organic resin is used for a plane on which an antenna is formed, blocking of an electric field by the secondary battery 913 can be inhibited. When an electric field is not significantly blocked by the housing 930a, an antenna may be provided inside the housing 930a. For the housing 930b, a metal material (e.g., aluminum) or a stack of a metal material and a resin material can be used.

FIG. 16C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

The wound body 950 including the above-described positive electrode 12 or the like enables high discharge capacity and improved safety.

The secondary battery 913 may include a wound body 950a illustrated in FIG. 17. The wound body 950a illustrated in FIG. 17A includes the negative electrode 931, the positive electrode 932, and the separators 933. The negative electrode 931 includes a negative electrode active material layer 931a. The positive electrode 932 includes a positive electrode active material layer 932a.

The wound body 950a including the above-described positive electrode 12 or the like enables high discharge capacity and improved safety.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 17B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 17C, the wound body 950a and an electrolyte solution are covered with the housing 930, whereby the secondary battery 913 is completed. The housing 930 is preferably provided with a safety valve, an overcurrent protection element, and the like. The safety valve is a valve to be released when the internal pressure of the housing 930 reaches a predetermined pressure, in order to prevent the battery from exploding.

As illustrated in FIG. 17B, the secondary battery 913 may include a plurality of the wound bodies 950a. The use of the plurality of wound bodies 950a enables the secondary battery 913 to have higher discharge capacity. The description of the secondary battery 913 illustrated in FIG. 16A to FIG. 16C can be referred to for the other components of the secondary battery 913 illustrated in FIG. 17A and FIG. 17B.

### <Laminated Secondary Battery>

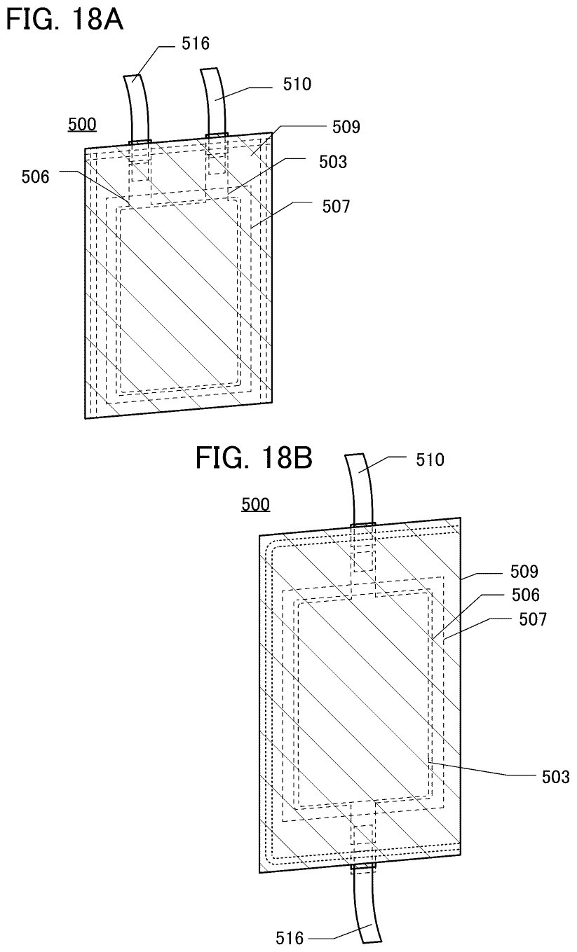

Next, examples of the appearance of a laminated secondary battery 500 are illustrated in FIG. 18A and FIG. 18B. FIG. 18A and FIG. 18B each illustrate the positive electrode 503, the negative electrode 506, a separator 507, an exterior body 509, a positive electrode lead electrode 510, and a negative electrode lead electrode 516.

FIG. 18A illustrates the appearance of the positive electrode 503 and the negative electrode 506. The positive electrode 503 includes the positive electrode current collector 501, and the positive electrode active material layer 502 is formed on the surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. Note that the areas or the shapes of the tab regions included in the positive electrode and the negative electrode are not limited to the examples illustrated in FIG. 18A.

The laminated secondary battery 500 including the above-described positive electrode 12 or the like can have high discharge capacity and improved safety.

### <Method for Fabricating Laminated Secondary Battery>

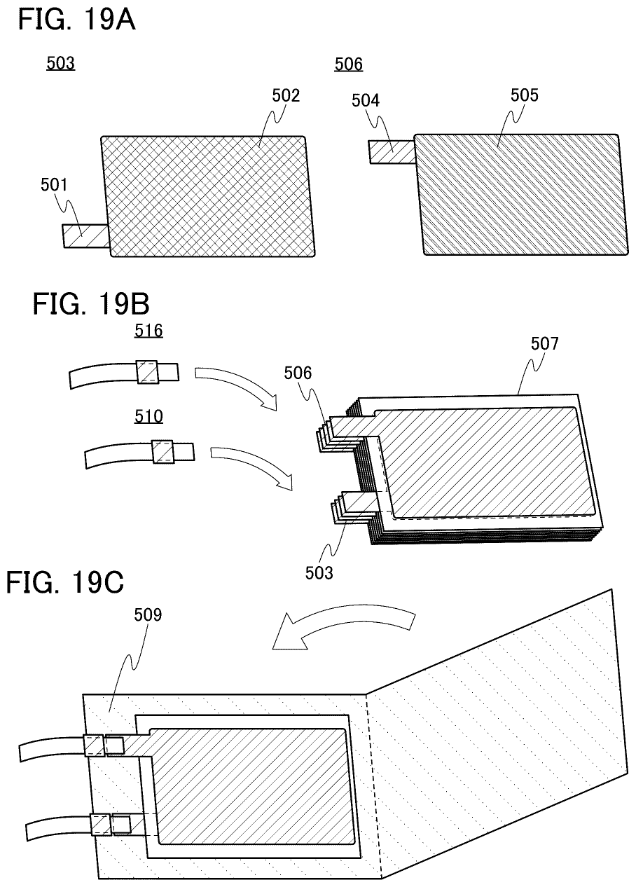

An example of a method for fabricating the laminated secondary battery having the appearance illustrated in FIG. 18A will be described with reference to FIG. 19A to FIG. 19C.

First, the negative electrode 506 and the positive electrode 503 are prepared as illustrated in FIG. 19A, and the negative electrode 506 and the positive electrode 503 are stacked with the separator 507 therebetween as illustrated in FIG. 19B. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 516 is bonded to the tab region of the negative electrode on the outermost surface.

Next, the negative electrodes 506, the separators 507, and the positive electrodes 503 are placed over the exterior body 509.

Subsequently, the exterior body 509 is folded along a portion shown by a dashed line, as illustrated in FIG. 19C. Then, the outer edges of the exterior body 509 are bonded to each other. The bonding is performed by thermocompression, for example. At this time, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be manufactured.

The positive electrode active material of one embodiment of the present invention is used for the positive electrode 503, whereby the secondary battery 500 can have high capacity, high discharge capacity, and excellent cycle performance.

### Embodiment 5

In this embodiment, examples of vehicles each including a secondary battery of one embodiment of the present invention will be described.

Secondary batteries can be used in vehicles, typically automobiles. Examples of automobiles include next-generation clean energy vehicles such as hybrid vehicles (HVs), electric vehicles (EVs), and plug-in hybrid vehicles (PHEVs or PHVs), and secondary batteries can be used as one of the power sources provided for the automobiles. Vehicles are not limited to automobiles. Other examples of vehicles include a train, a monorail train, a ship, a submarine (a deep-submergence vehicle and an unmanned submarine), a flying object (a helicopter, an unmanned aircraft (a drone), an airplane, a rocket, and an artificial satellite), an electric bicycle, and an electric motorcycle, and secondary batteries of one embodiment of the present invention can be used for such vehicles.

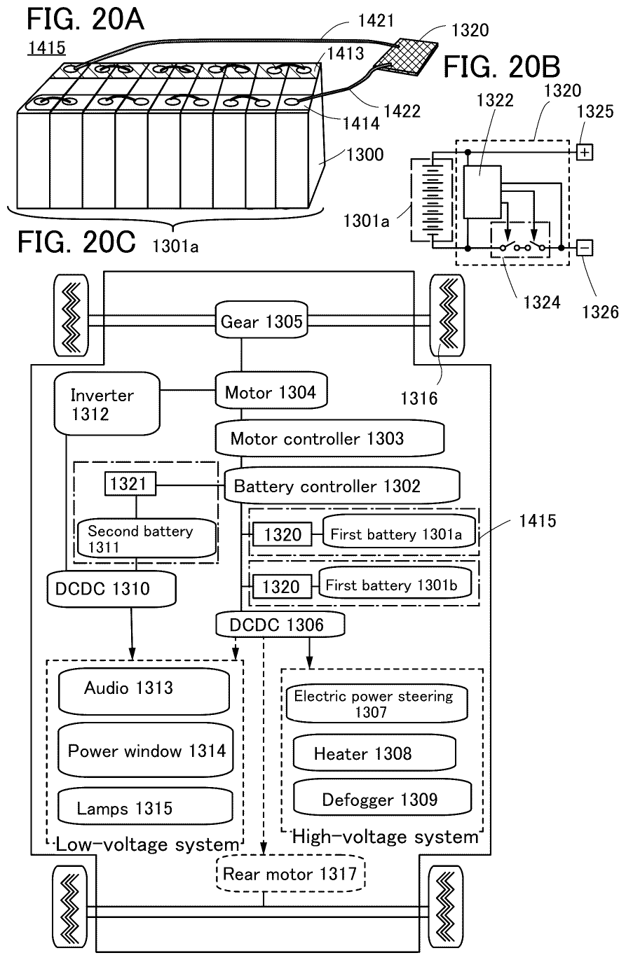

As illustrated in FIG. 20C, an electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than those of the first batteries 1301a and 1301b.

The internal structure of the first battery 1301a may be the wound structure or the stacked-layer structure. In addition, an all-solid-state battery may be used as the first battery 1301a. The use of the all-solid-state battery as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (e.g., an electric power steering 1307, a heater 1308, and a defogger 1309) through a DCDC circuit 1306. In the case where there is a rear motor 1317 for rear wheels, the first battery 1301a is also used to rotate the rear motor 1317.

The second battery 1311 supplies electric power to in-vehicle parts for 14 V (e.g., a stereo 1313, a power window 1314, and lamps 1315) through a DCDC circuit 1310.

Next, the first battery 1301a is described with reference to FIG. 20A.

FIG. 20A illustrates an example in which nine rectangular secondary batteries 1300 form one battery pack 1415. The nine rectangular secondary batteries 1300 are connected in series; one electrode is fixed by a fixing portion 1413 made of an insulator, and the other electrode is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the metal oxide, a metal oxide such as an In-M-Zn oxide (an element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the metal oxide is preferably a CAAC-OS (C-Axis Aligned Crystal Oxide Semiconductor) or a CAC-OS (Cloud-Aligned Composite Oxide Semiconductor). An In—Ga oxide or an In—Zn oxide may be used as the metal oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement.

Note that the “CAC-OS” has a composition in which materials are separated into first regions and second regions to form a mosaic pattern, and the first regions are distributed in the film (this composition is hereinafter also referred to as a cloud-like composition). That is, the CAC-OS is a composite metal oxide having a composition in which the first regions and the second regions are mixed. Note that a clear boundary between the first region and the second region is difficult to observe in some cases.

For example, energy dispersive X-ray spectroscopy (EDX) is used to obtain EDX mapping, and according to the EDX mapping, the CAC-OS in the In—Ga—Zn oxide can be found to have a composition in which the regions containing In as its main component (the first regions) and the regions containing Ga as its main component (the second regions) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, a high on-state current (Ion), high field-effect mobility (p), and favorable switching operation can be achieved.

Oxide semiconductors have various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of single crystal Si, and thus shows a smaller change in characteristics than the single crystal even when the secondary battery is heated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion is used in combination with a secondary battery whose positive electrode includes the positive electrode active material of one embodiment of the present invention, which is obtained in Embodiments 1, 2, and the like, a synergy effect on safety is generated. The secondary battery whose positive electrode includes the positive electrode active material of one embodiment of the present invention, which is obtained in Embodiments 1, 2, and the like, and the control circuit portion 1320 can contribute greatly to elimination of accidents due to secondary batteries, such as fires.

The control circuit portion 1320 that includes a memory circuit including a transistor using an oxide semiconductor can also function as an automatic control device for the secondary battery to eliminate ten causes of instability, such as a micro short circuit. Examples of functions of eliminating the ten causes of instability include prevention of overcharge, prevention of overcurrent, control of overheating during charge, maintenance of cell balance of an assembled battery, prevention of overdischarge, a battery indicator, automatic control of charge voltage and current amount according to temperature, control of the amount of charge current according to the degree of deterioration, detection of abnormal behavior due to a micro short circuit, and anomaly prediction regarding a micro short circuit; the control circuit portion 1320 has at least one of these functions. Furthermore, the automatic control device for the secondary battery can be highly downsized.

A “micro-short circuit” refers to a minute short circuit caused in a secondary battery and refers not to a state where the positive electrode and the negative electrode of a secondary battery are short-circuited so that charge and discharge are impossible, but to a phenomenon in which a slight amount of short-circuit current flows through a minute short-circuit portion. Since a large voltage change is caused even when a micro-short circuit occurs in a relatively short time in a minute area, it is feared that the abnormal voltage value will adversely affect later estimation.

One of the causes of a micro-short circuit is thought to as follows: uneven distribution of positive electrode active materials due to charge and discharge performed multiple times causes local current concentration at part of the positive electrode and part of the negative electrode, whereby a separator partly fails to function or a by-product is generated by a side reaction.

It can be said that the control circuit portion 1320 not only detects a micro-short circuit but also senses the terminal voltage of the secondary battery and controls the charge and discharge state of the secondary battery. For example, to prevent overcharge, both an output transistor of a charge circuit and an interruption switch can be turned off substantially at the same time.

FIG. 20B illustrates an example of a block diagram of the battery pack 1415 illustrated in FIG. 20A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarge and/or overcharge. For example, when the control circuit 1322 detects a voltage that is likely to cause overcharge, current is interrupted by turning off the switch in the switch portion 1324. Furthermore, a function of interrupting current with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors or p-channel transistors. The switch portion 1324 is not limited to a switch including a Si transistor using single crystal silicon; the switch portion 1324 may be formed using, for example, a power transistor including Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to the in-vehicle parts for 42 V (for a high-voltage system), and the second battery 1311 supplies electric power to the in-vehicle parts for 14 V (for a low-voltage system). Lead storage batteries are usually used for the second battery 1311 due to cost advantage. Lead storage batteries have disadvantages compared with lithium ion batteries in that they have a larger amount of self-discharge and are more likely to deteriorate owing to a phenomenon called sulfation. There is an advantage that the second battery 1311 can be maintenance-free when a lithium ion battery is used; however, in the case of long-term use, for example three years or more, anomaly that is difficult to assume at the time of fabrication might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium ion battery is used as both the first battery 1301a and the second battery 1311 is described. As the second battery 1311, a lead storage battery, an all-solid-state battery, or an electric double layer capacitor may be used. For example, the all-solid-state battery in Embodiment 6 may be used. The use of the all-solid-state battery in Embodiment 6 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b can desirably be charged rapidly.

The battery controller 1302 can set the charge voltage, charge current, and the like of the first batteries 1301a and 1301b. The battery controller 1302 can set a charge condition in accordance with charge performance of a secondary battery used, so that rapid charge can be performed.

Although not illustrated, in connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. A connection cable or the connection cable of the charger is sometimes provided with a control circuit. The control circuit portion 1320 is also referred to as an ECU (Electronic Control Unit). The ECU is connected to a CAN (Controller Area Network) provided in an electric vehicle. The CAN is a type of a serial communication standard used as an in-vehicle LAN. The ECU includes a microcomputer. Moreover, the ECU uses a CPU or a GPU.

External chargers installed at charge stations and the like have 100 V-200 V outlets, or a three-phase 200 V outlet with 50 kW, for example. Furthermore, charge can be performed with electric power supplied from external charge equipment by a contactless power feeding method or the like.

For rapid charge, secondary batteries that can withstand high-voltage charge have been desired to perform charge in a short time.

Moreover, it is possible to achieve a secondary battery in which graphene is used as a conductive material, an electrode layer is formed thick to increase the loading amount while suppressing a reduction in capacity, and the electrical characteristics are significantly improved in synergy with maintenance of high capacity. This secondary battery is particularly effective for a secondary battery used in a vehicle; it is possible to provide a vehicle that has a long cruising range, specifically one charge mileage of 500 km or longer, without increasing the proportion of the weight of the secondary battery to the weight of the entire vehicle.

Next, examples in which the secondary battery of one embodiment of the present invention is mounted on a vehicle, typically a transport vehicle, will be described.

Mounting secondary batteries on vehicles can achieve next-generation clean energy vehicles such as hybrid vehicles (HVs), electric vehicles (EVs), and plug-in hybrid vehicles (PHVs). Secondary batteries can also be incorporated in agricultural machines, motorized bicycles including motor-assisted bicycles, motorcycles, electric wheelchairs, electric carts, boats and ships, submarines, aircraft, rockets, artificial satellites, space probes, planetary probes, or spacecraft. A secondary battery including the above-described positive electrode 12 or the like can have high discharge capacity and improved safety. Thus, the secondary battery of one embodiment of the present invention is suitable for reduction in size and reduction in weight and can be suitably used in transport vehicles.

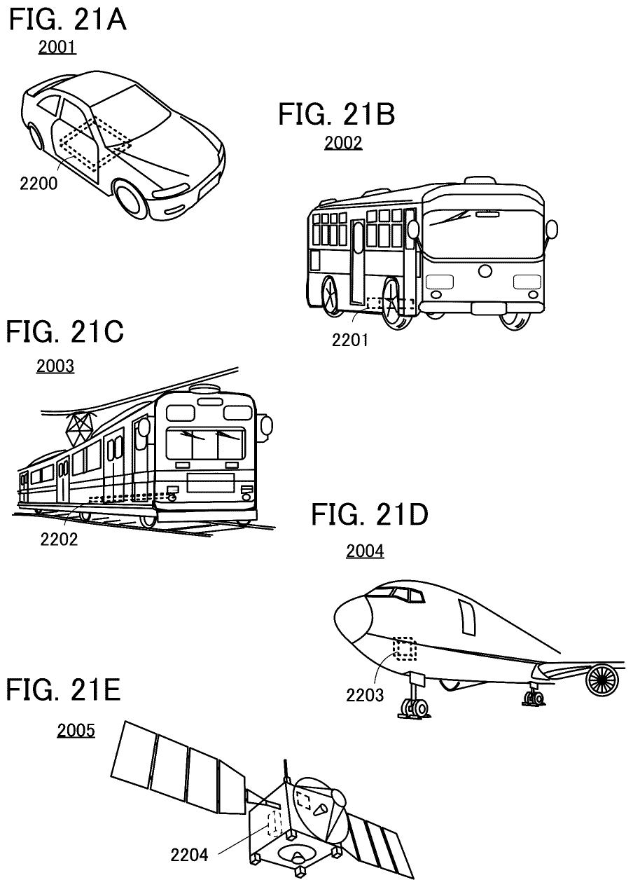

FIG. 21A to FIG. 21D illustrate examples of transport vehicles using one embodiment of the present invention. An automobile 2001 illustrated in FIG. 21A is an electric vehicle that runs using an electric motor as a driving power source. Alternatively, the automobile 2001 is a hybrid vehicle capable of driving with a driving power source selected appropriately from an electric motor and an engine. In the case where the secondary battery is mounted on the vehicle, the secondary battery shown as an example in Embodiment 4 is provided at one position or several positions. The automobile 2001 illustrated in FIG. 21A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary batteries included in the automobile 2001 is supplied with electric power from external charge equipment by a plug-in system, a contactless power feeding system, or the like. In charge, a given method such as CHAdeMO (registered trademark) or Combined Charge System can be employed as a charge method, the standard of a connector, or the like as appropriate. Charge equipment may be a charge station provided in a commerce facility or a household power source. For example, with the use of the plug-in system, the power storage device mounted on the automobile 2001 can be charged by being supplied with electric power from the outside. Charge can be performed by converting AC power into DC power through a converter such as an ACDC converter.

Although not illustrated, the vehicle may be provided with a power receiving device so that it can be charged by being supplied with electric power from an above-ground power transmitting device in a contactless manner. For the contactless power feeding system, by fitting a power transmitting device in a road or an exterior wall, charge can be performed not only when the vehicle stops but also when runs. In addition, the contactless power feeding system may be utilized to perform transmission and reception of electric power between two vehicles. Furthermore, a solar cell may be provided in the exterior of the vehicle to charge the secondary batteries when the vehicle stops or runs. To supply electric power in such a contactless manner, an electromagnetic induction method or a magnetic resonance method can be used.

FIG. 21B illustrates a large transporter 2002 having a motor controlled by electricity, as an example of a transport vehicle. A secondary battery module of the transporter 2002 has a cell unit of four secondary batteries with a nominal voltage of 3.0 V to 5.0 V, both inclusive, and 48 cells are connected in series to have a maximum voltage of 170 V, for example. A battery pack 2201 has the same function as the battery pack in FIG. 21A except, for example, the number of secondary batteries included in the secondary battery module; thus, the description is omitted.

FIG. 21C illustrates a large transport vehicle 2003 having a motor controlled by electricity as an example. A secondary battery module of the transport vehicle 2003 has 100 or more secondary batteries with a nominal voltage of 3.0 V to 5.0 V, both inclusive, connected in series and has a maximum voltage of 600 V, for example. Thus, the secondary batteries are required to have a small variation in performance. By employing the positive electrode active material of one embodiment of the present invention, which is described in Embodiments 1, 2, and the like, for the positive electrode, a secondary battery having stable battery performance can be manufactured and mass production at low cost is possible in light of the yield.

FIG. 21D illustrates an aircraft 2004 having a combustion engine as an example. The aircraft 2004 illustrated in FIG. 21D can be regarded as a kind of transport vehicles since it is provided with wheels for takeoff and landing. The aircraft 2004 includes a battery pack 2203 that includes a charge control device and a secondary battery module configured by connecting a plurality of secondary batteries.

The secondary battery module of the aircraft 2004 has eight 4 V secondary batteries connected in series and has a maximum voltage of 32 V, for example. The battery pack 2203 has a function similar to that in FIG. 21A except, for example, the number of secondary batteries included in the secondary battery module; thus, the description is omitted.

FIG. 21E illustrates an artificial satellite 2005 including a secondary battery 2204 as an example. The artificial satellite 2005 is used in an ultra-low-temperature cosmic space, and thus is preferably provided with the secondary battery 2204 of one embodiment of the present invention. It is further preferable that the secondary battery 2204 be mounted inside the artificial satellite 2005 while being covered with a heat-retaining member.

### Embodiment 6

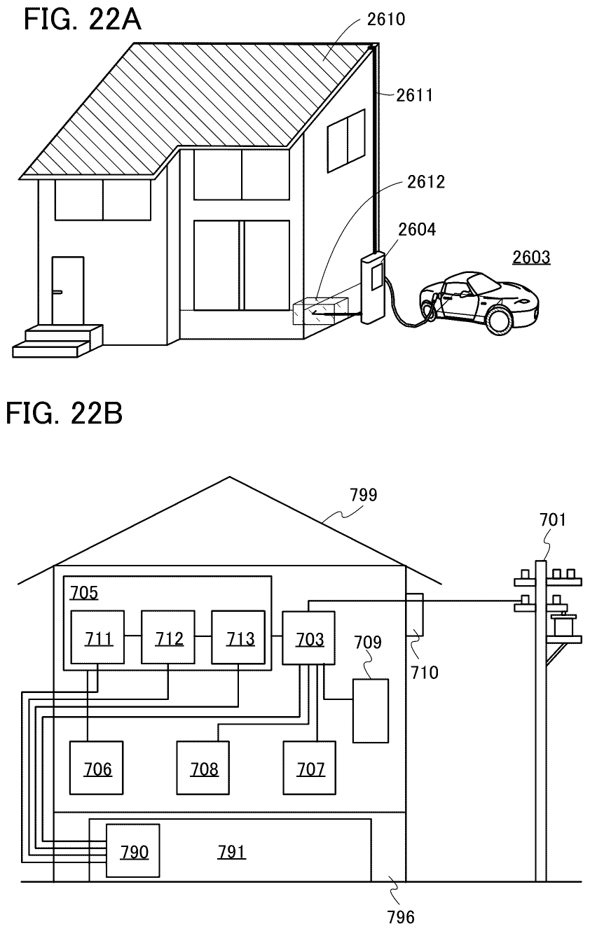

In this embodiment, examples in which the secondary battery of one embodiment of the present invention is mounted on a building will be described with reference to FIG. 22A and FIG. 22B.

A house illustrated in FIG. 22A includes a power storage device 2612 including the secondary battery of one embodiment of the present invention and a solar panel 2610. The secondary battery including the above-described positive electrode 12 or the like can have high discharge capacity and improved safety. The power storage device 2612 is electrically connected to the solar panel 2610 through a wiring 2611 or the like. The power storage device 2612 may be electrically connected to ground-based charge equipment 2604. The power storage device 2612 can be charged with electric power generated by the solar panel 2610. A secondary battery included in a vehicle 2603 can be charged with the electric power stored in the power storage device 2612 through the charge equipment 2604. The power storage device 2612 is preferably provided in an underfloor space. When the power storage device 2612 is provided in the underfloor space, the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source owing to power failure or the like.

FIG. 22B illustrates an example of a power storage device of one embodiment of the present invention. As illustrated in FIG. 22B, a power storage device 791 of one embodiment of the present invention is provided in an underfloor space of a building 799. The power storage device 791 may be provided with the control circuit described in Embodiment 7, and when a secondary battery whose positive electrode includes the positive electrode active material of one embodiment of the present invention, which is obtained in Embodiments 1, 2, and the like is used for the power storage device 791, a synergy effect on safety can be obtained. The secondary battery including the control circuit described in Embodiment 7 and a positive electrode including the positive electrode active material described in Embodiments 1, 2, and the like, which is one embodiment of the present invention, can contribute greatly to elimination of accidents due to the power storage device 791 including secondary batteries, such as fires.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power to be consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can also be checked with an electronic device such as a TV or a personal computer through the router 709. Furthermore, it can be checked with a portable electronic terminal such as a smartphone or a tablet through the router 709. With the indicator 706, the electronic device, or the portable electronic terminal, the demand for electric power depending on a time period (or per hour) that is predicted by the predicting portion 712 can be checked.

### Embodiment 7

In this embodiment, a two-wheeler and a bicycle will be described as examples of vehicles in each of which a secondary battery is mounted. The secondary battery including the above-described positive electrode 12 or the like can have high discharge capacity and improved safety.

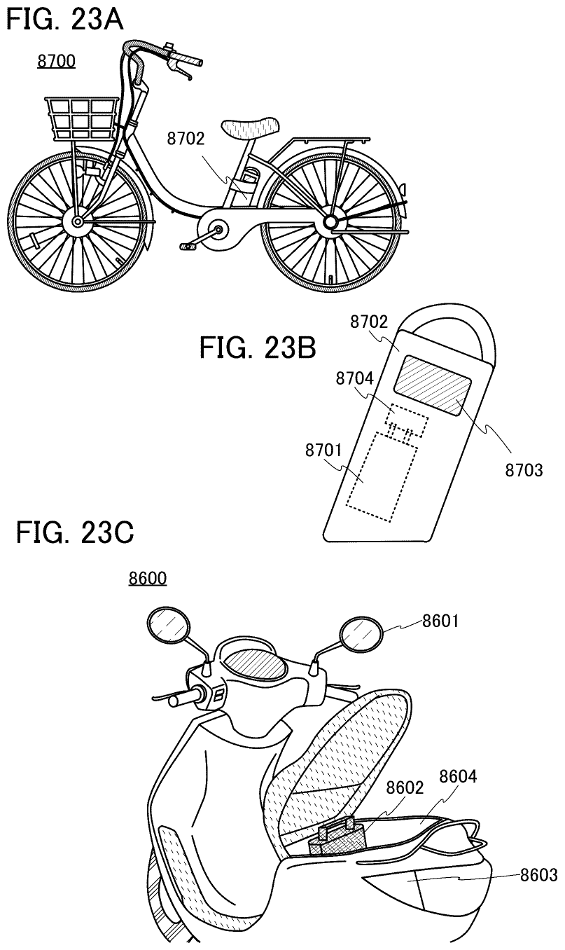

FIG. 23A illustrates an example of an electric bicycle in which the secondary battery of one embodiment of the present invention is mounted. The power storage device of one embodiment of the present invention can be used for an electric bicycle 8700 illustrated in FIG. 23A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 23B illustrates the state where the power storage device 8702 is detached from the bicycle. A plurality of secondary batteries 8701 included in the power storage device of one embodiment of the present invention are incorporated in the power storage device 8702, and the remaining battery capacity and the like can be shown on a display portion 8703. The power storage device 8702 includes a control circuit 8704 capable of charge control or anomaly detection for the secondary battery. The control circuit 8704 is electrically connected to a positive electrode and a negative electrode of the secondary battery 8701. When the control circuit 8704 is used in combination with a secondary battery whose positive electrode includes the positive electrode active material of one embodiment of the present invention, a synergy effect on safety can be obtained.

FIG. 23C illustrates an example of a two-wheeler using the power storage device of one embodiment of the present invention. A motor scooter 8600 illustrated in FIG. 23C includes a power storage device 8602, side mirrors 8601, and indicator lights 8603. The power storage device 8602 can supply electricity to the indicator lights 8603.

In the motor scooter 8600 illustrated in FIG. 23C, the power storage device 8602 can be stored in an under-seat storage unit 8604. The power storage device 8602 can be stored in the under-seat storage unit 8604 even when the under-seat storage unit 8604 is small.

### Embodiment 8

In this embodiment, examples of electronic devices each including the secondary battery of one embodiment of the present invention will be described. The secondary battery including the above-described positive electrode 12 or the like can have high discharge capacity and improved safety.

Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

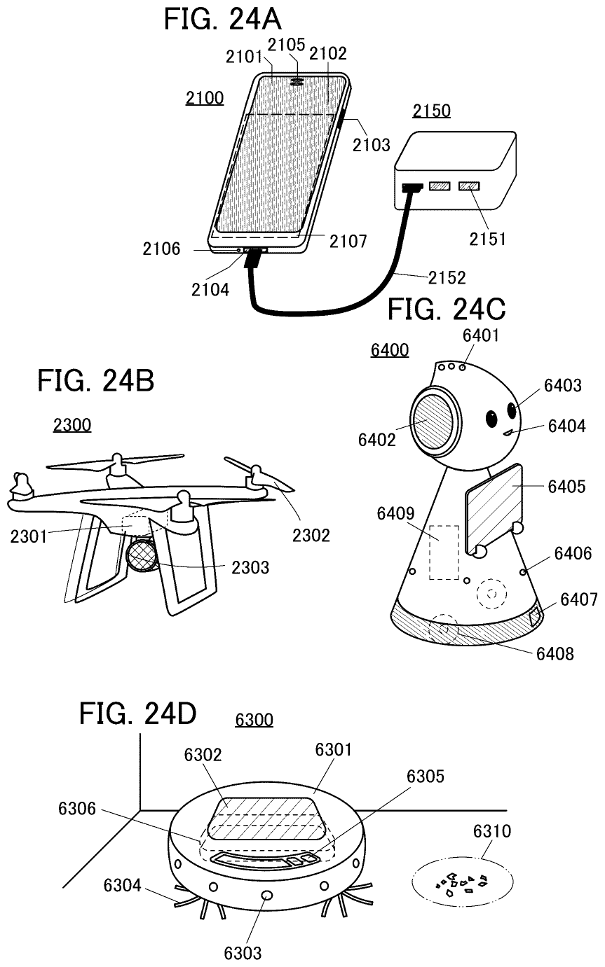

FIG. 24A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a secondary battery 2107. The use of the secondary battery 2107 whose positive electrode includes the positive electrode active material of one embodiment of the present invention described in the above embodiment achieves high capacity and a structure that accommodates space saving due to a reduction in size of the housing.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

The mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

The mobile phone 2100 may be provided with an external battery 2150. The external battery 2150 includes a secondary battery and a plurality of terminals 2151. Through a cable 2152 or the like, the mobile phone 2100 or the like can be charged with electricity from the external battery 2150. When the positive electrode active material of one embodiment of the present invention is used for the secondary battery included in the external battery 2150, the external battery 2150 can have high performance. Furthermore, even when the capacity of the secondary battery 2107 included in the mobile phone 2100 itself is low, the mobile phone 2100 can be used for along time by being charged with electricity from the external battery 2150. Thus, the mobile phone 2100 itself can be small and/or lightweight and can have improved safety.

FIG. 24B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna.

FIG. 24C illustrates an example of a robot. A robot 6400 illustrated in FIG. 24C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user by using the microphone 6402 and the speaker 6404.

The display portion 6405 has a function of displaying various kinds of information. The robot 6400 can display information desired by the user on the display portion 6405. The display portion 6405 may be provided with a touch panel. Alternatively, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes, in its inner region, the secondary battery 6409 of one embodiment of the present invention and a semiconductor device or an electronic component.

FIG. 24D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

The cleaning robot 6300 can determine whether there is an obstacle such as a wall, furniture, or a step by analyzing images taken by the cameras 6303. In the case where the cleaning robot 6300 detects an object that is likely to be caught in the brush 6304, such as a wire, by image analysis, the rotation of the brush 6304 can be stopped. The cleaning robot 6300 includes, in its inner region, the secondary battery 6306 of one embodiment of the present invention and a semiconductor device or an electronic component.

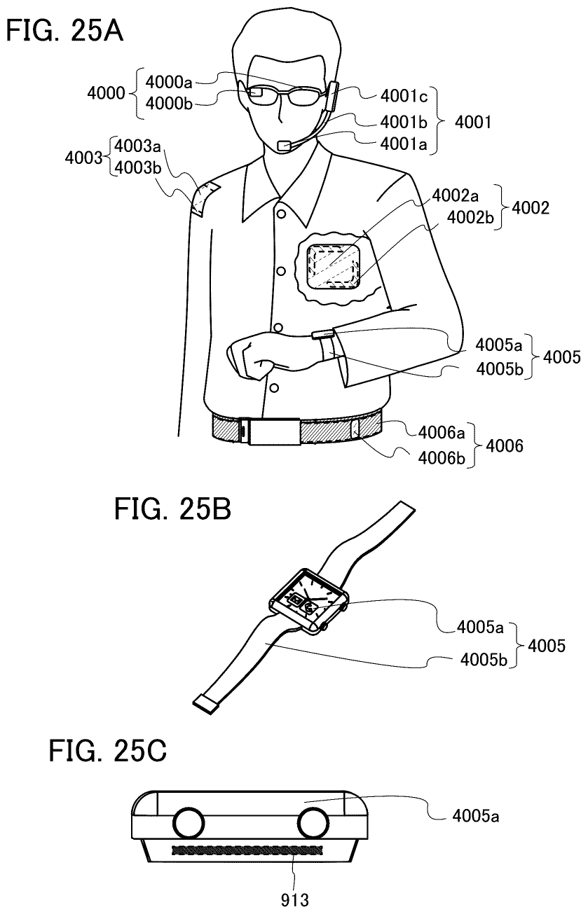

FIG. 25A illustrates examples of wearable devices. A secondary battery is used as a power source of a wearable device. To have improved splash resistance, water resistance, or dust resistance in daily use or outdoor use by a user, a wearable device is desirably capable of being charged wirelessly as well as being charged with a wire having an exposed connector portion to be connected.

For example, the secondary battery of one embodiment of the present invention can be provided in a glasses-type device 4000 illustrated in FIG. 25A. The glasses-type device 4000 includes a frame 4000a and a display portion 4000b. The secondary battery is provided in a temple portion of the frame 4000a having a curved shape, whereby the glasses-type device 4000 can be lightweight, have a well-balanced weight, and be used continuously for a long time.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c.

The secondary battery of one embodiment of the present invention can be provided in a device 4002 that can be attached directly to a body. A secondary battery 4002b can be provided in a thin housing 4002a of the device 4002.

The secondary battery of one embodiment of the present invention can be provided in a device 4003 that can be attached to clothes. A secondary battery 4003b can be provided in a thin housing 4003a of the device 4003.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b.

The display portion 4005a can display various kinds of information such as time and reception information of an e-mail or an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 25B illustrates a perspective view of the watch-type device 4005 that is detached from an arm.

FIG. 25C illustrates a side view. FIG. 25C illustrates a state where the secondary battery 913 is incorporated in the inner region. The secondary battery 913 is provided at a position overlapping with the display portion 4005a.

### Example

### <1-1. Forming of Position Electrode Active Material Used in Example>

In this example, the positive electrode active material of one embodiment of the present invention was formed in accordance with FIG. 11, FIG. 12, and the like.

As lithium cobalt oxide (LiCoO₂ shown as a starting material in the drawing) that was a starting material illustrated in Step S10 in FIG. 11, commercially available lithium cobalt oxide not containing any additive element (CELLSEED C-5H produced by NIPPON CHEMICAL INDUSTRIAL CO., LTD. and referred to as C-5H hereinafter) was first prepared. The median diameter of C-5H is approximately 7.0 μm, which is a lithium cobalt oxide having a median diameter of 12 μm or less.

Next, the heating (initial heating) in Step S15 in FIG. 11 was performed on C-5H, which was put in a saggar (container) covered with a lid, in a muffle furnace at 850° C. for 2 hours. After the muffle furnace was filled with an oxygen atmosphere, an oxygen gas was prevented from entering and exiting from the muffle furnace.

Next, in accordance with Step S20a in FIG. 12A, the additive element A1 source was formed. First, lithium fluoride (LiF) was prepared as the F source, and magnesium fluoride (MgF₂) was prepared as the Mg source. LiF and MgF₂ were weighed such that LiF:MgF₂ was 1:3 (molar ratio). Then, LiF and MgF₂ were mixed in dehydrated acetone and the mixture was stirred at a rotating speed of 500 rpm for 20 hours. In the stirring and mixing, a ball mill was used and a grinding medium was zirconium oxide balls. In the stirring and mixing, the lithium fluoride and the magnesium fluoride were also ground. After the mixing, acetone was evaporated and the mixture was made to pass through a sieve with an aperture of 300 μm, whereby the additive element A1 was obtained.

Next, in accordance with Step S31 in FIG. 11, the lithium cobalt oxide after Step S15 (lithium cobalt oxide after the initial heating) and the additive element A1 source obtained in Step S20a were mixed. Specifically, the additive element A1 source was weighed so that MgF₂ was 1 mol % of the lithium cobalt oxide after the initial heating, and then the materials were mixed by a dry method. At this time, stirring was performed at a rotating speed of 150 rpm for 1 hour. After that, the mixture was made to pass through a sieve with an aperture of 300 μm, whereby the mixture 903 was obtained (Step S32).

Next, in Step S33 in FIG. 11, the mixture 903 was heated at 900° C. for 5 hours. During the heating, the sagger where the mixture 903 was placed was covered with a lid. The sagger was not tightly closed with the lid so that the sagger could have an atmosphere containing oxygen. After the furnace was made to have an oxygen atmosphere, an oxygen gas was prevented from entering and exiting from the furnace. By the heating, lithium cobalt oxide containing Mg and F (a composite oxide in Step S34a) was obtained.

Next, in accordance with Step S40 in FIG. 12C, the additive element A2 source was formed. First, nickel hydroxide (Ni(OH)₂) was prepared as the Ni source, and aluminum hydroxide (Al(OH)₃) was prepared as the Al source. Next, the nickel hydroxide and the aluminum hydroxide were each stirred separately in dehydrated acetone at a rotating speed of 500 rpm for 20 hours. In the stirring, a ball mill was used and a grinding medium was zirconium oxide balls. After the mixing, acetone was evaporated and the materials were each made to pass through a sieve with an aperture of 300 μm, whereby the additive element A2 source in Step S43 was obtained.

Next, in Step S51 in FIG. 11, the lithium cobalt oxide containing Mg and F and the additive element A2 source were mixed by a dry method. The mixing ratio of each of nickel hydroxide and aluminum hydroxide was set to 0.5 mol % with respect to LiCoO₂, and the mixing condition was one-hour stirring at a rotating speed of 150 rpm. In the mixing, a ball mill was used and zirconium oxide balls was used as a media. Finally, the mixture was made to pass through a sieve with an aperture of 300 μm, whereby the mixture 904 was obtained (Step S52).

Next, in Step S53 in FIG. 11, the mixture 904 was heated at 850° C. for 2 hours. During the heating, the sagger where the mixture 904 was placed was covered with a lid. The sagger was not tightly closed with the lid so that the sagger could have an atmosphere containing oxygen. After the furnace was made to have an oxygen atmosphere, an oxygen gas was prevented from entering and exiting from the furnace.

Through the heating in Step S53, lithium cobalt oxide containing Mg, F, Ni, and Al (a positive electrode active material of one embodiment of the present invention in Step S54) was obtained. The obtained lithium cobalt oxide containing Mg, F, Ni, and Al is referred to as LCO in Example.

### <1-2. Measurement of Particle Size Distribution of LCO in Example>

The particle size distribution of LCO in Example was measured.

For the particle size distribution measurement, a laser diffraction particle size distribution measurement apparatus SALD-2200 produced by Shimadzu Corporation was used. First, approximately 0.4 g of LCO in Example, a surface-active agent, and 1 mL to 2 mL, both inclusive, of pure water were mixed in a beaker, ultrasonic treatment was performed, and stirring was performed sufficiently, whereby a dispersion liquid was obtained. After that, the dispersion liquid was injected into a stirring tank, and luminous intensity distribution was measured 64 times at intervals of two seconds to analyze particle size distribution data.

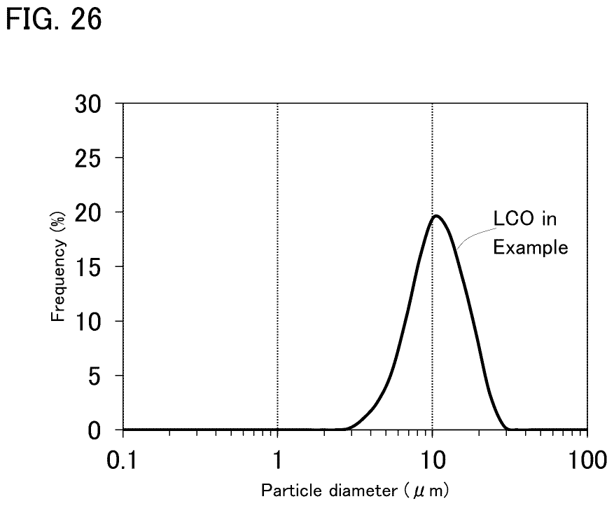

In FIG. 26, a measurement result of particle size distribution of LCO in Example is shown by a solid line. It was confirmed that the median diameter (D50) of LCO in Example was approximately 9.7 μm, which was less than or equal to 12 μm. LCO in Example can correspond to the first positive electrode active material 100 in the above embodiment. In addition, LCO in Example was found to have one peak in the particle size distribution. By the step of adding the additive element and/or the heating step, LCO in Example was presumed to have a smaller variation in particle size distribution than C-5H.

### <1-3. Measurement of Powder Resistance of LCO in Example>

The powder volume resistivity of LCO in Example was measured.

The powder volume resistivity was measured by the method described in <Powder resistance measurement> in Embodiment 1. As a measurement apparatus, MCP-PD51 produced by Mitsubishi Chemical Analytech Co., Ltd. was used. As a resistance meter, Hiresta-UP or Loresta-GP was selected in accordance with the resistivity. The measurement was performed in a dry room environment (i.e., an environment at a temperature higher than or equal to 15° C. and lower than or equal to 30° C.).

The powder of LCO in Example was set in a measurement unit, and the powder volume resistivity was obtained by measuring the resistance of the powder and the thickness of the powder under pressures of 13 MPa, 25 MPa, 38 MPa, 51 MPa, and 64 MPa. Note that the volume resistivity was calculated by resistance×area÷thickness. In the table below, the volume resistivity and the like of C-5H are also shown. Loresta-GP was selected as a resistance meter in accordance with the resistivity of C-5H. The results of the volume resistivity and the conductivity are shown in the table below.

TABLE 1

| | LCO in Example | | C-5H | |
|---|---|---|---|---|
| Pressure | Volume resistivity | Conductivity | Volume resistivity | Conductivity |
| (MPa) | (Ω · cm) | (S/cm) | (Ω · cm) | (S/cm) |
| 13 | 2.68 × 10¹⁰ | 3.74 × 10⁻¹¹ | 6.10 × 10³ | 1.64 × 10⁻⁴ |
| 25 | 1.06 × 10¹⁰ | 9.47 × 10⁻¹¹ | 4.79 × 10³ | 2.09 × 10⁻⁴ |
| 38 | 6.09 × 10⁹ | 1.64 × 10⁻¹⁰ | 4.38 × 10³ | 2.29 × 10⁻⁴ |
| 51 | 3.87 × 10⁹ | 2.59 × 10⁻¹⁰ | 4.23 × 10³ | 2.37 × 10⁻⁴ |
| 64 | 2.67 × 10⁹ | 3.74 × 10⁻¹⁰ | 4.15 × 10³ | 2.41 × 10⁻⁴ |

As shown in Table 1, the volume resistivity under any pressure of LCO in Example was higher than that of C-5H. Specifically, the powder volume resistivity of LCO in Example was 2.67×10⁹ Ω·cm at a pressure of 64 MPa. This value was higher than that of C-5H. That is, LCO in Example has a feature of a higher volume resistivity than C-5H at a pressure of 64 MPa, which is found to be higher than that of C-5H at a pressure of 64 MPa, specifically, higher than or equal to 1.0×10⁴ Ω·cm, preferably higher than or equal to 1.0×10⁸ Ω·cm.

The volume resistivity tends to be higher under low pressure conditions than under high pressure conditions. When the pressure was 13 MPa, the powder volume resistivity of LCO in Example was 2.68×10¹⁰ Ω·cm. This value was also higher than that of C-5H. That is, LCO in Example has a feature of a higher volume resistivity than C-5H at a pressure of 13 MPa, which is found to be higher than C-5H at a pressure of 13 MPa, specifically, higher than or equal to 1.0×10⁴ Ω·cm, preferably higher than or equal to 1.0×10⁸ Ω·cm.

The volume resistivity of LCO in Example can be read from the above table.

It is inferred that the powder resistance of LCO in Example was higher than C-5H owing to magnesium or the like located in the surface portion.

### <1-4. XPS Analysis of LCO in Example>

XPS analysis was performed on LCO and C-5H in Example. The XPS measurement conditions are shown below.
Measurement apparatus: Quantera II produced by PHI, Inc.
X-ray source: monochromatic Al Kα (1486.6 eV)
Detection area: 100 μmφ
Detection depth: approximately 4 to 5 nm (extraction angle 45°)
Measurement spectrum: wide scanning, narrow scanning of each detected element

The XPS analysis results of LCO in Example and C-5H are shown in the table below.

TABLE 2

| | Li | Co | Ni | Al | O | Mg | F | C | Ca | Na | S | Cl | Total |
|---|---|---|---|---|---|---|---|---|---|---|---|---|---|
| LCO in Example | 9.3 | 13.1 | 1.3 | 0.5 | 44.2 | 14.3 | 10.4 | 3.2 | 0.5 | 1.9 | 1 | 0.4 | 100.0 |
| C-5H | 16.9 | 20.5 | 0 | 0 | 50.9 | 0 | 0.3 | 9.6 | 0.4 | 1.4 | 0 | 0 | 99.9 |

Table 2 shows the atomic ratio (atomic %) of each element when the total number of atoms of Li, Co, Ni, Al, O, Mg, F, C, Ca, Na, S, and Cl is 100%. Note that the total amount shown in Table 2 is 99.9% in some cases because the values are rounded off to be shown in the table; however, the total number of atoms is 100.0% in the XPS analysis.

When LCO in Example and C-5H are compared, larger amounts of Ni, Mg, and F are detected and smaller amounts of Li and Co are detected in LCO in Example. This result suggests that the surface portion containing magnesium or the like was formed in LCO in Example.

From the XPS analysis results shown in Table 2, the ratio of the atomic ratio of Ni to the atomic ratio of Co (A_{Ni}/A_{Co}), the ratio of the atomic ratio of Mg to the atomic ratio of Co (A_{Mg}/A_{Co}), the ratio of the atomic ratio of Al to the atomic ratio of Co (A_{Al}/A_{Co}), and the ratio of the atomic ratio of F to the atomic ratio of Co (A_{F}/A_{Co}) were calculated, and are shown in the table below.

TABLE 3

| | A_{Ni}/A_{Co} | A_{Mg}/A_{Co} | A_{Al}/A_{Co} | A_{F}/A_{Co} |
|---|---|---|---|---|
| LCO in Example | 0.099 | 1.092 | 0.038 | 0.794 |
| C-5H | 0.000 | 0.000 | 0.000 | 0.015 |

According to Table 3, in the XPS analysis of LCO in Example, the ratio of the atomic ratio of Ni to the atomic ratio of Co (A_{Ni}/A_{Co}) was greater than or equal to 0.09, the ratio of the atomic ratio of Mg to the atomic ratio of Co (A_{Mg}/A_{Co}) was greater than or equal to 1.00, the ratio of the atomic ratio of Al to the atomic ratio of Co (A_{Al}/A_{Co}) was greater than or equal to 0.03, and the ratio of the atomic ratio of F to the atomic ratio of Co (A_{F}/A_{Co}) was greater than or equal to 0.70. Since A_{Al}/A_{Co} is small, aluminum is inferred to be positioned in the inner portion 100b, which is less likely to be measured by XPS.

From the above results, in the XPS measurement of LCO in Example, the ratio of the atomic ratio of Ni to the atomic ratio of Co (A_{Ni}/A_{Co}) is preferably greater than or equal to 0.07, further preferably greater than or equal to 0.08, still further preferably greater than or equal to 0.09. In addition, A_{Ni}/A_{Co} is preferably less than or equal to 0.13, preferably less than or equal to 0.12, and preferably less than or equal to 0.11.

In addition, in the XPS measurement of LCO in Example, the ratio of the atomic ratio of Mg to the atomic ratio of Co (A_{Mg}/A_{Co}) is preferably greater than or equal to 0.8, further preferably greater than or equal to 0.9, still further preferably greater than or equal to 1.0. In addition, A_{Mg}/A_{Co} is preferably less than or equal to 1.4, further preferably less than or equal to 1.3, still further preferably less than or equal to 1.2.

In addition, in the XPS measurement of LCO in Example, the ratio of the atomic ratio of Al to the atomic ratio of Co (A_{Al}/A_{Co}) is preferably greater than or equal to 0.01, further preferably greater than or equal to 0.02, still further preferably greater than or equal to 0.03. In addition, A_{Mg}/A_{Co} is preferably less than or equal to 0.07, further preferably less than or equal to 0.06, or still further preferably less than or equal to 0.05.

In addition, in the XPS measurement of LCO in Example, the ratio of the atomic ratio of F to the atomic ratio of Co (A_{F}/A_{Co}) is preferably greater than or equal to 0.5, further preferably greater than or equal to 0.6, still further preferably greater than or equal to 0.7. In addition, A_{F}/A_{Co} is preferably less than or equal to 1.0, preferably less than or equal to 0.9, or preferably less than or equal to 0.8.

### <1-5. STEM-EDX Analysis of LCO in Example>

STEM-EDX line analysis was performed on LCO in Example. As a STEM apparatus, HD-2700 produced by Hitachi High-Tech Corporation was used, and an acceleration voltage was 200 kV. As an EDX detector, Octane T Ultra W (a detection element area of 100 mm²×2) produced by AMETEK Co., Ltd. was used. As EDX software, TEAM produced by AMETEK Co., Ltd. was used. The EDX analysis measurement conditions were as follows: the beam diameter was 0.2 nmφ, the beam dwell time was 50 msec, the number of frames was 20, the step pitch was 0.2 nm, and the number of data steps was 850 (width: 42 nm).

Thinning processing was performed for the use in analysis. As pretreatment for the processing, a protective film was deposited on a surface of LCO in Example. Next, the thinning processing of a sample for cross-sectional observation was started with an FIB-SEM apparatus. Specifically, carbon serving as a protective film was deposited by evaporation on an observation portion of the sample with a carbon coating unit of an ion sputtering apparatus (MC1000 produced by Hitachi High-Tech Corporation), the surrounding portions of the observation portion were removed and the bottom portion of the observation portion was cut with the FIB-SEM apparatus (XVision 200TBS produced by Hitachi High-Tech Corporation). The acceleration voltage at the time of the finishing stage of the processing was lowered to 10 kV, and the sample was thinned until the thickness of the observation portion reached approximately 60 nm. The thinned sample was picked up by an MPS (micro probe system). With the use of such thinning processing, as an observation sample of LCO in Example, a sample Edge including a region having a surface (edge plane) parallel to a plane intersecting with a basal plane was prepared.

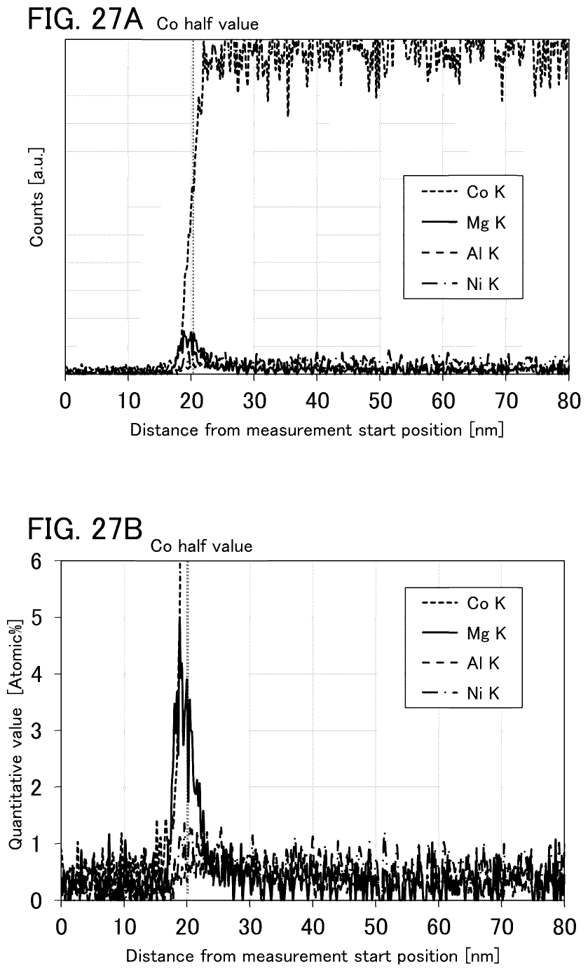

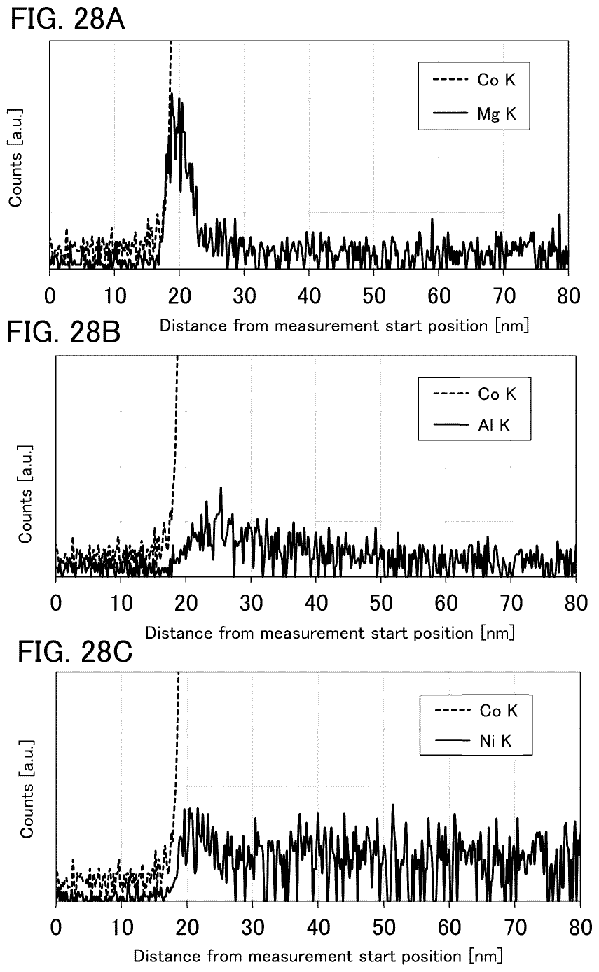

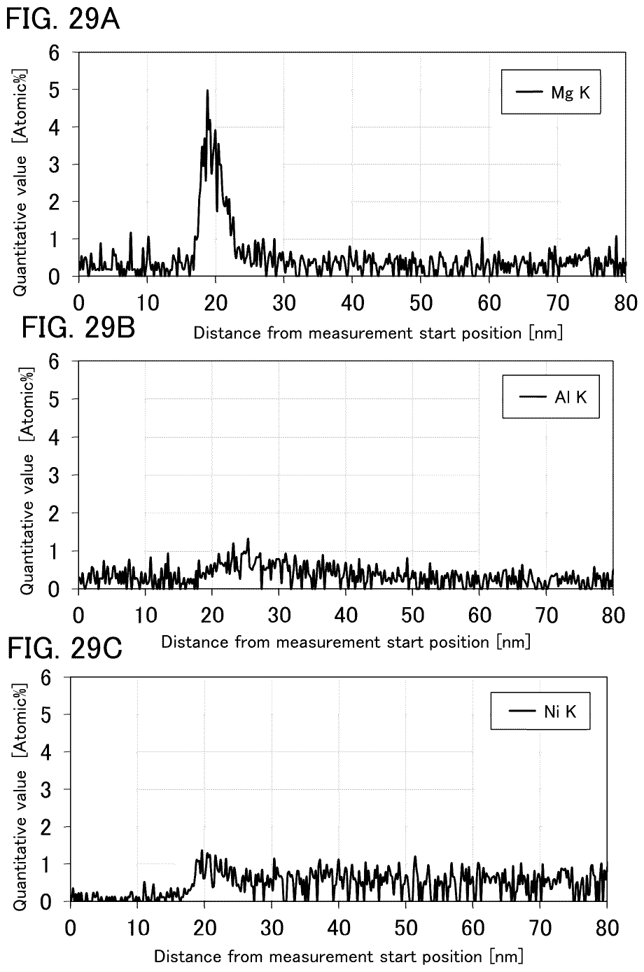

FIG. 27A shows a STEM-EDX line analysis profile (Counts) of the sample Edge. In the profile, the horizontal axis represents a distance (nm) from a measurement start position and the vertical axis represents Counts (a.u.). The distance from the measurement start position is described as a distance hereinafter. FIG. 27B shows quantitative values (atomic %) of STEM-EDX line analysis of the sample Edge. In the profile, the horizontal axis represents the distance (nm) from a measurement start position and the vertical axis represents the quantitative value (atomic %). FIG. 28A, FIG. 28B, and FIG. 28C respectively show Co and Mg, Co and Al, and Co and Ni that are extracted from the profile (Counts) of the STEM-EDX line analysis in FIG. 27A. FIG. 29A, FIG. 29B, and FIG. 29C respectively show only Mg, only Al, and only Ni that are extracted from the quantitative values (atomic %) of the STEM-EDX line analysis in FIG. 27B.

From the profile of FIG. 27A, 50% of the sum of the average value M_{AVE} of the detection intensity in the inner portion of cobalt and the average value M_{BG} of the background of cobalt was calculated, and the calculated value is shown as a Co half value in FIG. 27A and FIG. 27B. The Co half value can be used as a reference point of the peak position in the profile. In addition, the Co half value may be used as the surface of the sample Edge. For easy comparison between the graphs, the Co half values in the graphs were all set to the distance 20 nm on the horizontal axis.

In FIG. 28A, FIG. 28B, and FIG. 28C, the inward direction in the particle from the position at a distance of 20 nm (Co half value) is a positive direction. The peak positions of the additive elements, i.e., Mg, Al, and Ni, were at 0 nm (a distance of 20 nm), at 5.4 nm (a distance of 25.4 nm), and at 0.4 nm (a distance of 20.4 nm), respectively. The distribution of Mg was narrow. The distribution of Al was broad. The distribution of Ni partly overlapped with the distribution of Mg.

In FIG. 28A, the inward direction in the particle from the position at a distance of 20 nm (Co half value) is a positive direction. The quantitative value of magnesium was the maximum value, i.e., 4.90 atomic %, at −1.2 nm (a distance of 18.8 nm), 0.30 atomic % at 10 nm (a distance of 30 nm), 0.70 atomic % at 20 nm (a distance of 40 nm), and 0.30 atomic % at 50 nm (a distance of 70 nm). The maximum value of magnesium indicates its sufficient amount and thus, magnesium was regarded as not being an element in a trace amount, and the energy spectrum of magnesium was not obtained. That is, magnesium had the maximum quantitative value in the surface portion in the sample Edge and was distributed at a concentration within the range of 0.3 atomic % to 4.9 atomic % from the surface portion to the inner portion.

In FIG. 28B, the inward direction in the particle from the position at a distance of 20 nm (Co half value) is a positive direction. The quantitative value of aluminum was the maximum value, i.e., 1.30 atomic %, at 5.4 nm (a distance of 25.4 nm), 0.80 atomic % at 10 nm (a distance of 30 nm), 0.70 atomic % at 20 nm (a distance of 40 nm), and 0.20 atomic % at 50 nm (a distance of 70 nm). The maximum value of aluminum indicates its sufficient amount and thus, aluminum was regarded as not being an element in a trace amount, and the energy spectrum of aluminum was not obtained. That is, aluminum had the maximum quantitative value in the surface portion in the sample Edge and was distributed at a concentration within the range of 0.2 atomic % to 1.3 atomic % from the surface portion to the inner portion.

In FIG. 28C, the inward direction in the particle from the position at a distance of 20 nm (Co half value) is a positive direction. The quantitative value of nickel was the maximum value, i.e., 1.30 atomic %, at 0.6 nm (a distance of 20.6 nm), 0.50 atomic % at 10 nm (a distance of 30 nm), 0.90 atomic % at 20 nm (a distance of 40 nm), and 1.00 atomic % at 50 nm (a distance of 70 nm). The maximum value of nickel indicates its sufficient amount and thus, nickel was regarded as not being an element in a trace amount, and the energy spectrum of nickel was not obtained. That is, nickel had the maximum quantitative value in the surface portion in the sample Edge and was distributed at a concentration within the range of 0.5 atomic % to 1.3 atomic % from the surface portion to the inner portion.

As described above, it was confirmed that in LCO in Example, magnesium was distributed with the peak position closer to the surface of the positive electrode active material than the peak position of aluminum was. In LCO in Example, it was confirmed that the difference between the peak position of magnesium and the peak position of nickel was greater than or equal to 1 nm and less than or equal to 4 nm, the peak position of magnesium was positioned on the surface side, and the distribution of magnesium included a portion overlapping with the distribution of nickel.

### <2-1. Conductive Materials in Example>

As the conductive materials in Example, AB, CNT, and VGCF (registered trademark) were prepared.

<a. CNT>

In this example, ZEONANO SG101 produced by Zeon Nano Technology was used as CNT. SG101 had a specific surface area greater than or equal to 800 m²/g, a fiber length of an assembly greater than or equal to 100 μm and less than or equal to 600 μm, and an average diameter greater than or equal to 3 nm and less than or equal to 5 nm. The fiber length of an assembly of SG101 was larger than the median diameter of LCO in Example.

<b. AB>

In this example, DENKA BLACK produced by Denka was used as AB. DENKA BLACK had a specific surface area of 68 m²/g and an average particle diameter of 35 nm. The average particle diameter of DENKA BLACK was smaller than the median diameter of LCO in Example.

<c. VGCF (Registered Trademark)>

VGCF-H produced by Showa Denko was used as VGCF in this example. VGCF-H was synthesized by a chemical vapor deposition (CVD) method, exhibited high crystallinity, and had a specific surface area of 13 m²/g and a fiber diameter of 150 nm. The specific surface area of VGCF-H was smaller than the specific surface area of CNT.

### <2-2. Powder Resistance Measurement of Conductive Materials in Example>

The powder volume resistivity of each of conductive materials in Example was measured.

The volume resistivity of each of CNT, AB, and VGCF were measured by the method described in <Powder resistance measurement> in Embodiment 1. As the resistor, Loresta-GP was selected. The measurement was performed in a dry room environment (i.e., an environment at a temperature higher than or equal to 15° C. and lower than or equal to 30° C.).

CNT, AB, and VGCF were each set in a measurement unit, and the powder volume resistivity was obtained by measuring the resistance of the powder and the thickness of the powder under pressures of 13 MPa, 25 MPa, 38 MPa, 51 MPa, and 64 MPa. The results of the volume resistivity and the conductivity are shown in the table below.

TABLE 4

| | CNT in Example | | AB in Example | | VGCF in Example | |
|---|---|---|---|---|---|---|
| Pressure | Volume resistivity | Conductivity | Volume resistivity | Conductivity | Volume resistivity | Conductivity |
| (MPa) | (Ω · cm) | (S/cm) | (Ω · cm) | (S/cm) | (Ω · cm) | (S/cm) |
| 13 | 2.95 × 10⁻² | 3.39 × 10 | 4.77 × 10⁻² | 2.1 × 10 | 9.52 × 10⁻³ | 1.05 × 10² |
| 25 | 1.62 × 10⁻² | 6.16 × 10 | 2.83 × 10⁻² | 3.53 × 10 | 5.97 × 10⁻³ | 1.68 × 10² |
| 38 | 1.13 × 10⁻² | 8.83 × 10 | 1.97 × 10⁻² | 5.09 × 10 | 4.65 × 10⁻³ | 2.15 × 10² |
| 51 | 0.88 × 10⁻² | 1.14 × 10² | 1.38 × 10⁻² | 7.22 × 10 | 3.88 × 10⁻³ | 2.58 × 10² |
| 64 | 0.70 × 10⁻² | 1.43 × 10² | 1.03 × 10⁻² | 9.67 × 10 | 3.37 × 10⁻³ | 2.97 × 10² |

As shown in Table 4, the volume resistivity of CNT tended to be lower than VGCF as the pressure got higher. In addition, the conductivity of CNT tended to be higher than AB and VGCF as the pressure got higher. Specifically, the volume resistivity of CNT in Example was 0.70×10⁻² Ω·cm at a pressure of 64 MPa, which was lower than those of AB and VGCF at the same pressure. The volume resistivity of CNT is preferably lower than or equal to 1×10⁻² Ω·cm at a pressure of 64 MPa. Since the volume resistivity of CNT is lower than the volume resistivity of VGCF, it can be said that when the lower limit of a possible range of the volume resistivity of CNT is the volume resistivity of VGCF, the volume resistivity of CNT is lower than or equal to 1×10⁻² Ω·cm and higher than or equal to 1×10⁻³ Ω·cm at a pressure of 64 MPa.

The volume resistivity of CNT in Example was specifically 2.95×10⁻² Ω·cm at a pressure of 13 MPa, which as lower than those of AB and VGCF at the same pressure. The volume resistivity of CNT is preferably lower than or equal to 1×10⁻¹ Ω·cm at a pressure of 13 MPa. Since the volume resistivity of CNT is lower than the volume resistivity of VGCF, it can be said that when the lower limit of a possible range of the volume resistivity of CNT is the volume resistivity of VGCF, the lower limit is lower than or equal to 1×10⁻¹ Ω·cm and higher than or equal to 1×10⁻² Ω·cm at a pressure of 13 MPa.

The volume resistivity of CNT can be read from the above table. The volume resistivity of AB can be read from the above table. The volume resistivity of VGCF can be read from the above table.

### <3. Method for Manufacturing Positive Electrode A in Example>

A method for manufacturing a positive electrode A including LCO in Example and the conductive materials and the like in Example will be described.

As a binder in Example, polyvinylidene fluoride (PVDF) was prepared. Then, the optimal weight ratios of CNT and AB were examined with a fixed weight ratio of the binder. Specifically, a slurry for a positive electrode with LCO:AB:CNT:PVDF=98−(x+y):x:y:2 (weight ratio) was prepared, and positive electrodes A in which x and y satisfy values in the following table were synthesized. Such positive electrodes A are referred to as Sample 1 to Sample 7.

TABLE 5

| Sample | x | y |
|---|---|---|
| Sample 1 | 2 | 1 |
| Sample 2 | 3 | 0 |
| Sample 3 | 1 | 1 |
| Sample 4 | 0 | 1 |
| Sample 5 | 0.5 | 0.5 |
| Sample 6 | 0 | 0.5 |
| Sample 7 | 1 | 0 |

A synthesis procedure of the slurry described above is described with reference to FIG. 13A, FIG. 13B, and the like. First, AB was prepared as the first conductive material 42. The addition amount of AB was set in accordance with the above table. As the binder 48, a mixed solution A in which 5 wt % of PVDF was dissolved in NMP was prepared. These were mixed to give the mixture 53 shown in Step S52.

Next, a positive electrode active material of one embodiment of the present invention was prepared. The positive electrode active material was LCO in Example described above. LCO in Example was added to and mixed with the mixture 53, whereby the mixture 56 shown in Step S55 was obtained.

As the second conductive material 44, a mixed solution in which 0.25 wt % of CNT was dissolved in NMP was prepared. Furthermore, as the binder 48a, a mixed solution B in which 5 wt % of PVDF was dissolved in NMP was prepared. These were mixed with the mixture 56 to give a mixture C serving as a slurry.

Then, the mixture C serving as the slurry was applied to coat the positive electrode current collector containing aluminum. After the coating, drying was performed at 80° C., and an organic solvent such as NMP was volatilized to form a positive electrode active material layer over the positive electrode current collector.

After that, pressing treatment was performed with a roller press machine to increase the density of the positive electrode active material layer over the positive electrode current collector. As a pressing treatment condition, a linear pressure was 210 kN/m. In addition, each of an upper roll and a lower roll of the roller press machine was heated to 120° C.

Through the above process, the positive electrode A was obtained. As described again, the positive electrodes A are referred to as Sample 1 to Sample 7 in accordance with Table 5.

### <Observation of Positive Electrode A>

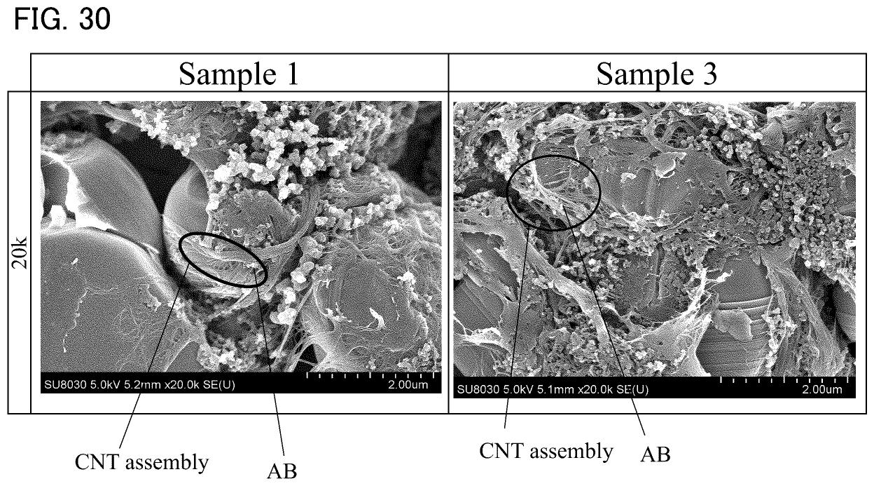

Sample 1 and Sample 3 were observed with a SEM. An SU8030 scanning electron microscope apparatus produced by Hitachi High-Tech Corporation was used for the observation with a SEM image. The conditions were an acceleration voltage of 5 kV and a magnification of 20000 times (denoted as 20 k in FIG. 30). Other measurement conditions are as follows: a working distance was 5.0 mm, an emission current was 9 μA to 10.5 μA, both inclusive, an extraction voltage was 5.8 kV, an SE(U) mode (Upper secondary electron detector) was employed, and observation was performed in an autofocus mode.

FIG. 30 shows surface SEM images of Sample 1 and Sample 3. At least LCO, AB, CNT, a space, and the like are observed in Sample 1 and Sample 3. In Sample 1 and Sample 3, a CNT assembly can be observed and the CNT assembly is in contact with LCO. In other words, the CNT assembly seems to wrap LCO, the CNT assembly seems to bind LCO, and the CNT assembly wraps around LCO. Note that LCO also includes a portion exposed from the CNT assembly, and the CNT assembly is positioned so as not to inhibit insertion and extraction of lithium ions. In addition, part of the CNT assembly is assumed to be in contact with LCO with PVDF interposed therebetween. Judging from Sample 1 and Sample 3 shown in FIG. 30, it can be said that CNT sticks to LCO.

In Sample 1 and Sample 3, AB aggregates are observed and the AB aggregates are in contact with LCO. Specifically, the AB aggregate is positioned to be sandwiched between facing LCO, i.e., adjacent LCO, and in contact with LCO. Furthermore, it is observed that AB over LCO is covered with the CNT assembly, and it is also observed that AB is positioned inside the CNT assembly or is tangled with the CNT assembly. Note that the inside of the CNT assembly does not refer to the center portion formed by carbon layers included in the CNT. The state where AB is tangled with the CNT assembly is more noticeable in Sample 3 than in Sample 1. In addition, AB is dispersed as a whole.

In Sample 1 and Sample 3, LCO is observed to be a single particle in a surface SEM image. Furthermore, as shown in FIG. 30, no crack is observed in Sample 1 and Sample 3.

### <Half Cell Formation 1-1>

Next, a coin cell (CR2032 type with a diameter of 20 mm and a height of 3.2 mm) was assembled as a half cell including the positive electrode A. An electrolyte solution, a separator, and a counter electrode used in the half cell are described.

### <Electrolyte Solution>

As an electrolyte solution, a mixed solution in which 1 mol/L of lithium hexafluorophosphate (LiPF₆) was dissolved in a mixture of ethylene carbonate (EC) and diethyl carbonate (DEC) at EC:DEC=3:7 (volume ratio) was prepared. Furthermore, 2 wt % of vinylene carbonate (VC) to the total amount of the mixed solution was added as an additive agent.

### <Separator>

As a separator, a polypropylene porous film was used.

<Counter electrode>

For a negative electrode (counter electrode), a lithium metal was used.

In Example, Half Cell 1 to Half Cell 7 were formed. The positive electrode of Sample 1 described above was used as Half Cell 1, the positive electrode of Sample 2 described above was used as Half Cell 2, the positive electrode of Sample 3 described above was used as Half Cell 3, the positive electrode of Sample 4 described above was used as Half Cell 4, the positive electrode of Sample 5 described above was used as Half Cell 5, the positive electrode of Sample 6 described above was used as Half Cell 6, and the positive electrode of Sample 7 described above was used as Half Cell 7.

### <Charge-Discharge Cycle Test>

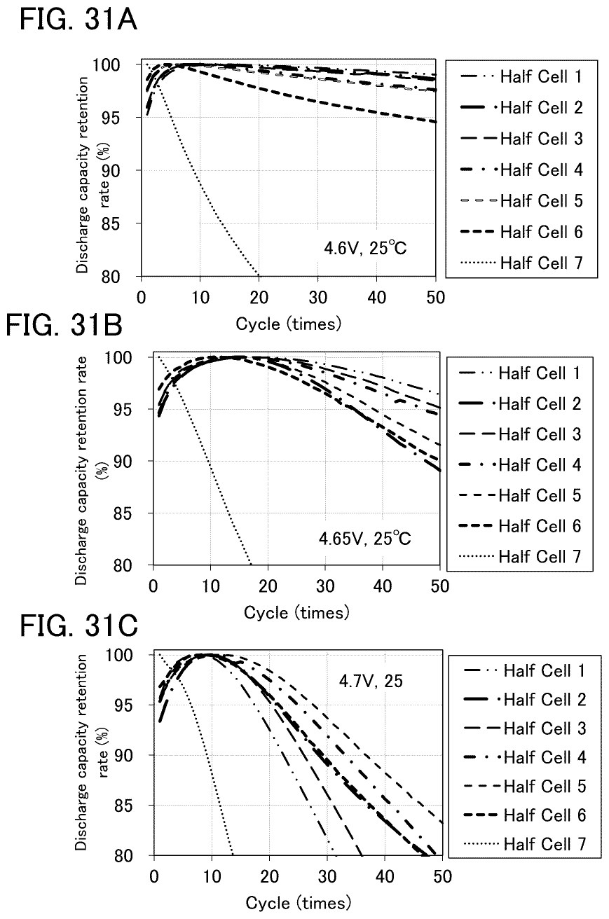

Charge-discharge cycle test was performed on Half Cell 1 to Half Cell 7 under three conditions, whereby discharge capacity retention rates were obtained. FIG. 31A to FIG. 31C show the results. In Condition 1, the temperature of a thermostatic chamber in which the half cells were placed was set to 25° C., and cycles under the following charge and discharge conditions were repeated 50 times.
Charge condition: CCCV charge, 0.5 C rate, 4.6 V, 0.05 C cutoff
Discharge condition: CC discharge, 0.5 C rate, 2.5 V cutoff
FIG. 31A shows the results.

In Condition 2, the temperature of the thermostatic chamber in which the half cells were placed was set to 25° C., and cycles under the following charge and discharge conditions were repeated 50 times.
Charge condition: CCCV charge, 0.5 C rate, 4.65 V, 0.05 C cutoff
Discharge condition: CC discharge, 0.5 C rate, 2.5 V cutoff
FIG. 31B shows the results.

In Condition 3, the temperature of the thermostatic chamber in which the half cells were placed was set to 25° C., and cycles under the following charge and discharge conditions were repeated 50 times.
Charge condition: CCCV charge, 0.5 C rate, 4.7 V, 0.05 C cutoff
Discharge condition: CC discharge, 0.5 C rate, 2.5 V cutoff
FIG. 31C shows the results.

In this charge-discharge cycle test, the current value corresponding to 1C was 200 mA/g per weight of the positive electrode active material. In the case where the current does not reach the cutoff current in the charge condition, charge is cut off at a given time. The voltage such as 4.6 V in the charge condition is referred to as the upper limit voltage, and in the period of the CV charge, the voltage is held at the upper limit voltage. The 2.5 V in the discharge condition is referred to as the lower limit voltage.

The table below summarizes the discharge capacity retention rates (%) of Half Cell 1 to Half Cell 7 after 50 cycles.

TABLE 6
Discharge capacity retention rate (%) after 50 cycles

| Cell | 25° C., 4.6 V | 25° C., 4.65 V | 25° C., 4.7 V |
|---|---|---|---|
| Half Cell 1 | 99.0 | 96.4 | 57.4 |
| Half Cell 2 | 98.6 | 89.1 | 78.7 |
| Half Cell 3 | 98.5 | 95.1 | 63.8 |
| Half Cell 4 | 97.6 | 94.4 | 79.4 |
| Half Cell 5 | 97.5 | 91.5 | 83.2 |
| Half Cell 6 | 94.6 | 90.0 | 78.1 |
| Half Cell 7 | 66.4 | 58.5 | 52.5 |

The discharge capacity retention rate of each half cell can be read from the table. For example, Half Cell 5 is a half cell having a higher weight ratio of LCO in the positive electrode than Half Cell 3 and is found to have a high discharge capacity retention rate after 50 cycles in the charge-discharge cycle test at 25° C. and 4.7 V.

In the case where Half Cell 7 that does not include a CNT is used as a comparative example, it is found that in the charge-discharge cycle test at 25° C. and 4.6 V, the discharge capacity retention rate of Half Cell 1 after 50 cycles is higher than or equal to 67% and lower than 100%, the discharge capacity retention rate of Half Cell 3 after 50 cycles is higher than or equal to 67% and lower than or equal to 99%, and the discharge capacity retention rate of Half Cell 5 after 50 cycles is higher than or equal to 67% and lower than or equal to 98%. That is, the range of the discharge capacity retention rate of each half cell after 50 cycles can be determined as appropriate on the basis of the discharge capacity retention rate in the above table.

The table below summarizes the maximum discharge capacity (mAh/g) per weight of the positive electrode active material of each of Half Cell 1 to Half Cell 7 in the charge-discharge cycle test.

TABLE 7
Maximum discharge capacity (mAh/g)

| Cell | 25° C., 4.6 V | 25° C., 4.65 V | 25° C., 4.7 V |
|---|---|---|---|
| Half Cell 1 | 211.9 | 216.9 | 215.6 |
| Half Cell 2 | 213.4 | 227.1 | 231.4 |
| Half Cell 3 | 212.3 | 218.5 | 217.9 |
| Half Cell 4 | 209.1 | 216.0 | 215.5 |
| Half Cell 5 | 212.4 | 222.0 | 223.4 |
| Half Cell 6 | 209.6 | 217.9 | 219.7 |
| Half Cell 7 | 199.8 | 206.1 | 210.7 |

It is found that Half Cell 5 having the same weight ratios of AB and CNT as Half Cell 3 and a higher weight ratio of LCO than Half Cell 3 tended to have higher maximum discharge capacity than Half Cell 3.

As described above, Half Cell 1, Half Cell 3, and Half Cell 5 each exhibit favorable charge-discharge cycle performance at 25° C. and charge voltages of 4.6 V, 4.65 V, and 4.7 V and have superior maximum discharge capacity. The results show that the positive electrode including AB and CNT is preferable, and it is further preferable that x≥y, x>0, and y>0 be satisfied when the positive electrode is represented by LCO:AB:CNT:PVDF=98−(x+y):x:y:2 (weight ratio). In other words, in the positive electrode, the weight of AB is preferably greater than or equal to the weight of CNT.

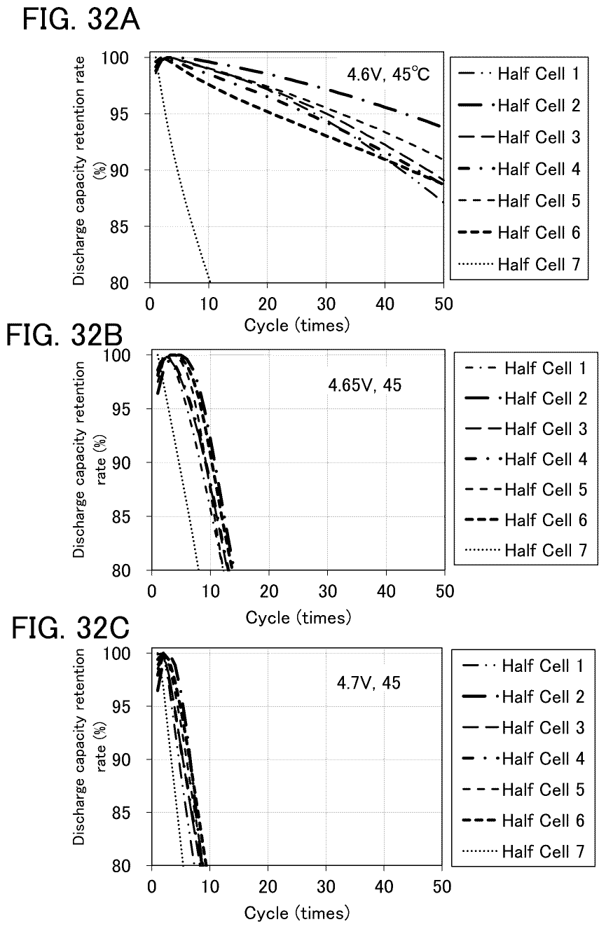

Next, the temperature of the thermostatic chamber was set to 45° C., and the charge-discharge cycle test was performed on Half Cell 1 to Half Cell 7 under the above-described conditions 1 to 3, whereby discharge capacity retention rates were obtained. The results are shown in FIG. 32A to FIG. 32C.

The table below summarizes the discharge capacity retention rates (%) of Half Cell 1 to Half Cell 7 after 50 cycles.

TABLE 8
Discharge capacity retention rate (%) after 50 cycles

| Cell | 45° C., 4.6 V | 45° C., 4.65 V | 45° C., 4.7 V |
|---|---|---|---|
| Half Cell 1 | 87.1 | 47.0 | 36.1 |
| Half Cell 2 | 93.7 | 43.9 | 39.0 |
| Half Cell 3 | 89.1 | 42.7 | 37.3 |
| Half Cell 4 | 88.6 | 41.6 | 38.7 |
| Half Cell 5 | 90.9 | 37.1 | 40.1 |
| Half Cell 6 | 88.7 | 42.5 | 40.3 |
| Half Cell 7 | 49.1 | 49.4 | 44.1 |

The discharge capacity retention rate of each half cell can be read from the table. For example, Half Cell 5 is a half cell having the same weight ratios of AB and CNT as Half Cell 3 and a higher weight ratio of LCO than Half Cell 3 and is found to have a high discharge capacity retention rate after 50 cycles in a charge-discharge cycle test at 45° C. and 4.6 V.

In the case where Half Cell 7 that does not include a CNT is used as a comparative example, it is found that in the charge-discharge cycle test at 45° C. and 4.6 V, the discharge capacity retention rate of Half Cell 1 after 50 cycles is higher than or equal to 49% and lower than 90%, the discharge capacity retention rate of Half Cell 3 after 50 cycles is higher than or equal to 49% and lower than or equal to 90%, and the discharge capacity retention rate of Half Cell 5 after 50 cycles is higher than or equal to 49% and lower than or equal to 92%. That is, the range of the discharge capacity retention rate of each half cell after 50 cycles can be determined as appropriate on the basis of the discharge capacity retention rate in the above table.

The table below summarizes the maximum discharge capacity (mAh/g) per weight of the positive electrode active material of Half Cell 1 to Half Cell 7 in the above charge-discharge cycle test.

TABLE 9
Maximum discharge capacity (mAh/g)

| Cell | 45° C., 4.6 V | 45° C., 4.65 V | 45° C., 4.7 V |
|---|---|---|---|
| Half Cell 1 | 217.5 | 222.3 | 220.7 |
| Half Cell 2 | 219.3 | 231.3 | 236.1 |
| Half Cell 3 | 217.0 | 222.8 | 223.4 |
| Half Cell 4 | 213.9 | 221.7 | 222.2 |
| Half Cell 5 | 216.9 | 227.7 | 227.9 |
| Half Cell 6 | 214.8 | 223.5 | 226.8 |
| Half Cell 7 | 204.9 | 213.8 | 218.9 |

As described above, Half Cell 3 and Half Cell 5 each exhibited favorable charge-discharge cycle performance at 45° C. and a charge voltage of 4.6 V and had high maximum discharge capacity. The results show that x=y, x>0, and y>0 are preferably satisfied when the positive electrode including AB and CNT is represented by LCO:AB:CNT:PVDF=98−(x+y):x:y:2 (weight ratio). In other words, in the positive electrode, the weight ratio of CNT is preferably equal to the weight ratio of AB.

### <Discharge Capacity Measurement at Different Rates (C-Rate Measurement)>

First, Half Cell 1 to Half Cell 4 and Half Cell 6 were subjected to aging treatment. In the aging treatment, the temperature of a thermostatic chamber where the half cells were placed was set to 25° C., and cycles under the following charge and discharge conditions were repeated twice.
Charge condition: CCCV charge, 0.1 C rate, 4.6 V, 0.01 C cutoff
Discharge condition: CC discharge, 0.1 C rate, 2.5 V cutoff
   In this aging treatment, the current value corresponding to 1 C was 200 mA/g per weight of the positive electrode active material. The voltage such as 4.6 V in the charge condition is referred to as the upper limit voltage, and in the period of the CV charge, the voltage is held at the upper limit voltage. The 2.5 V in the discharge condition is referred to as the lower limit voltage.

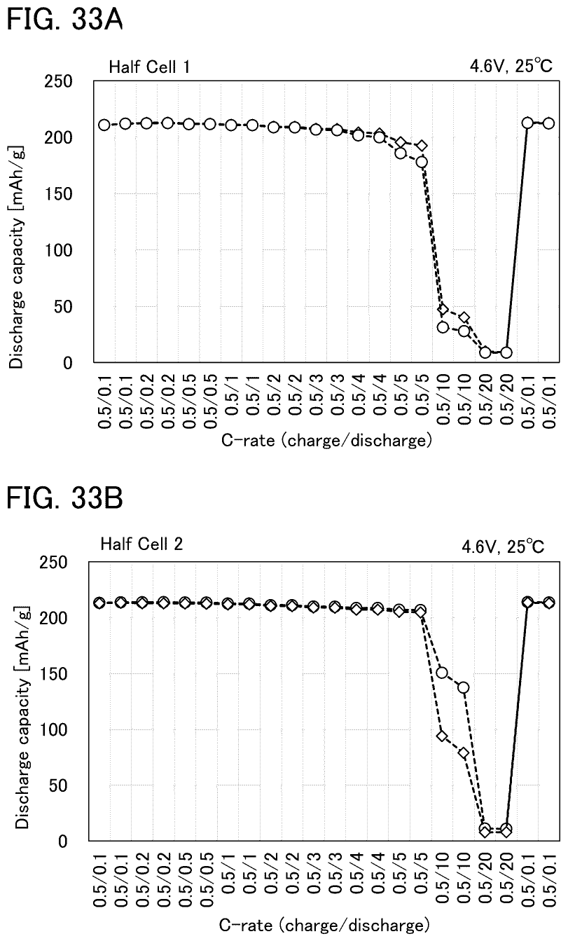

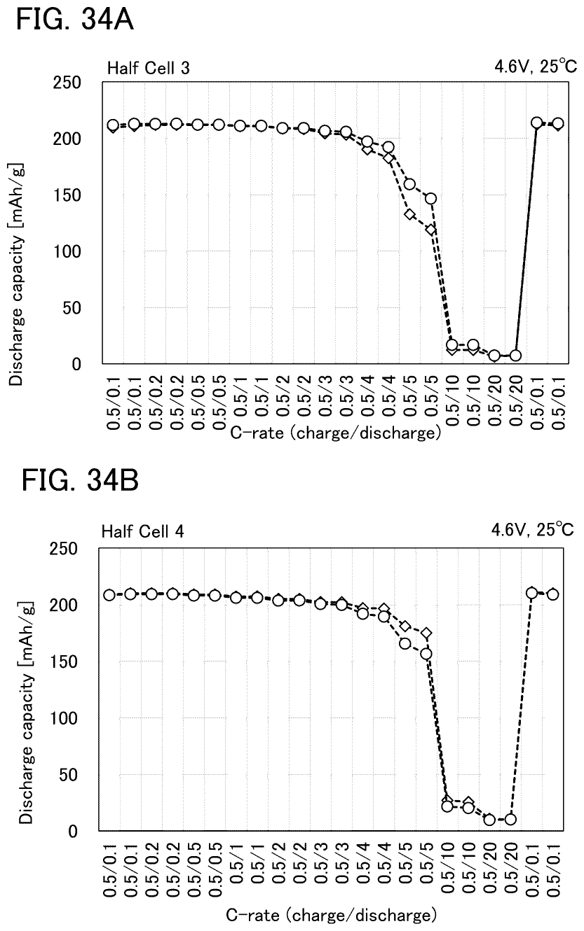

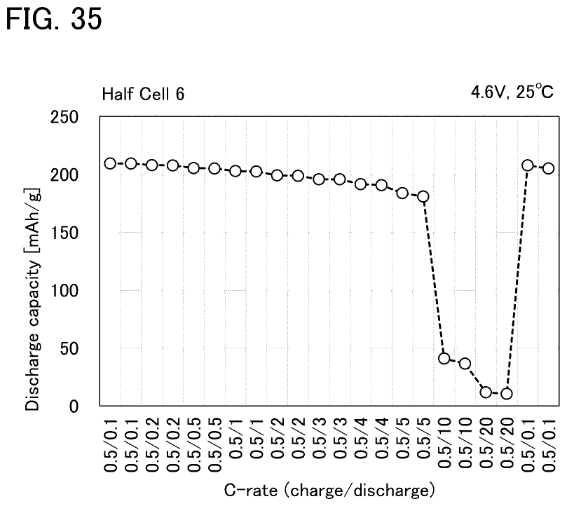

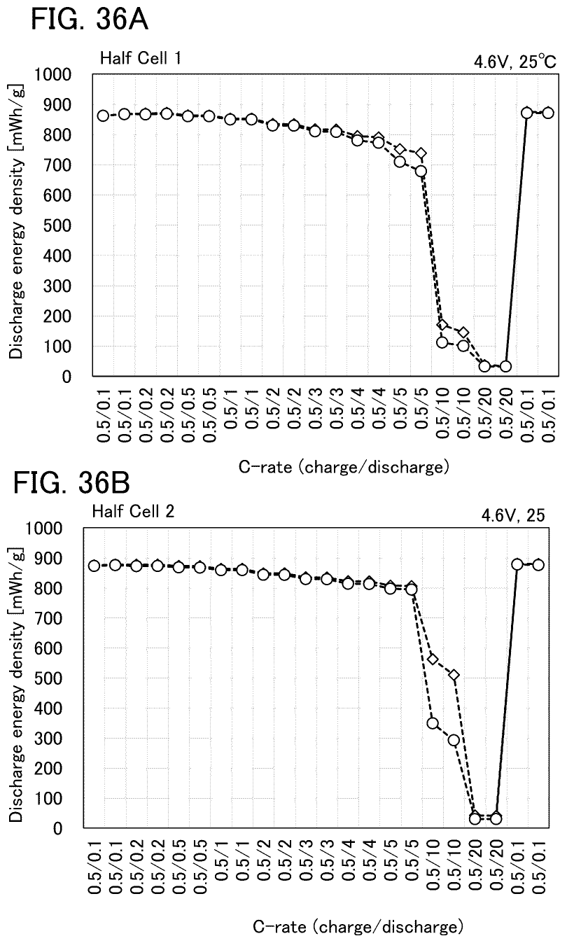

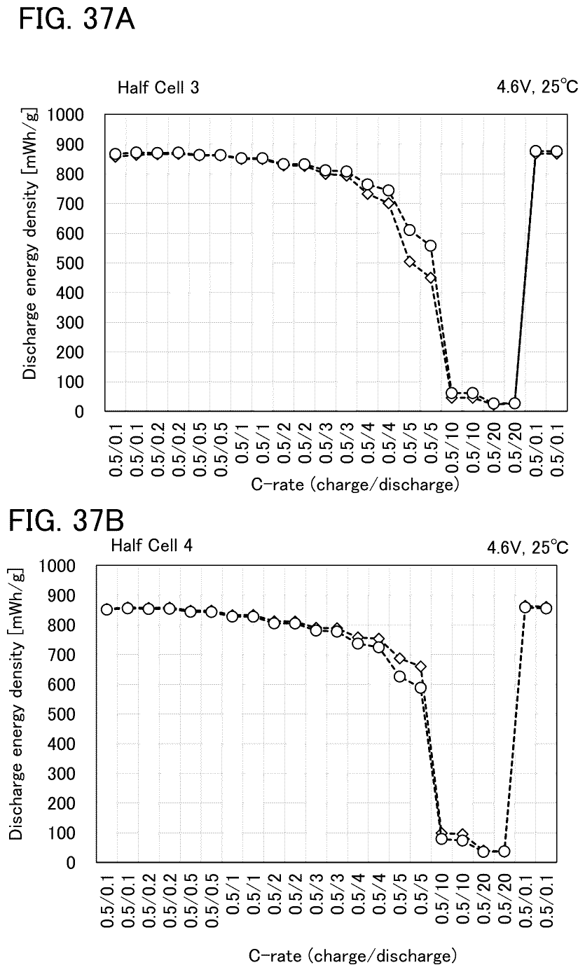

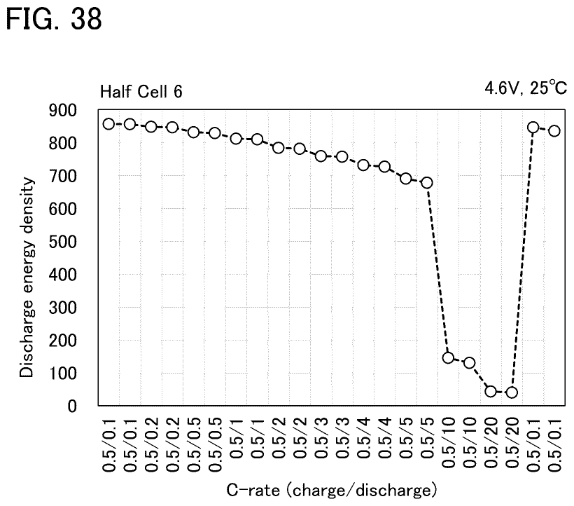

Next, discharge capacity of different rates at 25° C. and an upper limit voltage of 4.6 V was measured using Half Cell 1, Half Cell 2 to Half Cell 4, and Half Cell 6. Two half cells 1, two half cells 2, two half cells 3, and two half cells 4 were prepared. The charge condition of the discharge capacity at different rates were the same as that in the charge-discharge cycle test, and the charge condition was fixed when charge and discharge were repeated. The discharge condition was as follows: the rates were changed in the order of 0.1 C, 0.2 C, 0.5 C, 1 C, 2 C, 3 C, 4 C, 5 C, 10 C, 20 C, and 0.1 C until the voltage reached 2.5 V. Charge and discharge were repeated twice at each rate of discharge condition. As results, FIG. 33A shows a graph of the discharge capacity (mAh/g) per weight of the positive electrode active material corresponding to Half Cell 1, FIG. 33B shows a graph of the discharge capacity (mAh/g) per weight of the positive electrode active material corresponding to Half Cell 2, FIG. 34A shows a graph of the discharge capacity (mAh/g) per weight of the positive electrode active material corresponding to Half Cell 3, FIG. 34B shows a graph of the discharge capacity (mAh/g) per weight of the positive electrode active material corresponding to Half Cell 4, and FIG. 35 shows a graph of the discharge capacity (mAh/g) per weight of the positive electrode active material corresponding to Half Cell 6. FIG. 36A is a graph showing the discharge energy density (mWh/g) per weight of the positive electrode active material corresponding to Half Cell 1, FIG. 36B is a graph showing the discharge energy density (mWh/g) per weight of the positive electrode active material corresponding to Half Cell 2, FIG. 37A is a graph showing the discharge energy density (mWh/g) per weight of the positive electrode active material corresponding to Half Cell 3, FIG. 37B is a graph showing the discharge energy density (mWh/g) per weight of the positive electrode active material corresponding to Half Cell 4, and FIG. 38 is a graph showing the discharge energy density (mWh/g) per weight of the positive electrode active material corresponding to Half Cell 6. When the rate 3C of the discharge condition is focused on, it i found that Half Cell 1 and Half Cell 3 have higher discharge capacity than the other half cells and are preferable.

These results indicate that for favorable discharge capacity at different rates, x≥y, x>0, and y>0 are preferably satisfied in the positive electrode including AB and LCO represented by LCO:AB:CNT:PVDF=98−(x+y):x:y:2 (weight ratio). In other words, the weight of CNT is preferably lower than or equal to the weight of AB in the positive electrode.

<Half cell formation 1-2>

New half cells were prepared, in which positive electrodes of Sample 1, Sample 4, and Sample 5 were used and positive electrode active material layers included in the positive electrodes were pressed under pressing treatment conditions of the linear pressure of 210 kN/m and then the linear pressure of 1467 kN/m. Note that the temperature of each of an upper roll and a lower roll of the roller press machine was set to 120° C.

The half cells including the above-described positive electrodes were assembled. The half cells corresponding to Sample 1, Sample 4, and Sample 5 are referred to as Half Cell 1p, Half Cell 4p, and Half Cell 5p, respectively. The table below summarizes the half cells and the pressing condition. The conditions other than the pressing condition were the same as those for the half cells described above.

TABLE 10

| Sample | Pressing condition |
|---|---|
| Sample 1 | Linear pressure 210 kN/m |
| Sample 1p | Linear pressure 210 kN/m + Linear pressure 1467 kN/m |
| Sample 4 | Linear pressure 210 kN/m |
| Sample 4p | Linear pressure 210 kN/m + Linear pressure 1467 kN/m |
| Sample 5 | Linear pressure 210 kN/m |
| Sample 5p | Linear pressure 210 kN/m + Linear pressure 1467 kN/m |

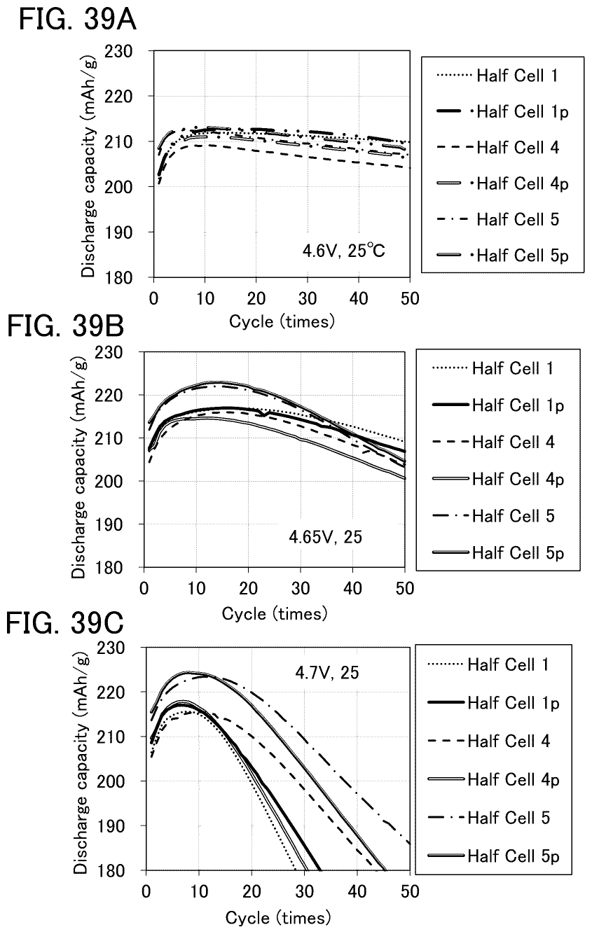

Charge-discharge cycle test was performed on Half Cell 1, Half Cell 1p, Half Cell 4, Half Cell 4p, Half Cell 5, and Half Cell 5p under three conditions, so that discharge capacity (mAh/g) per weight of the positive electrode active material was obtained. FIG. 39A to FIG. 39C show the results. In Condition 1, the temperature of a thermostatic chamber where the half cells were placed was set to 25° C., and cycles under the following charge and discharge conditions were repeated 50 times.
Charge condition: CCCV charge, 0.5 C rate, 4.6 V, 0.05 C cutoff
Discharge condition: CC discharge, 0.5 C rate, 2.5 V cutoff
FIG. 39A shows the results.

In Condition 2, the temperature of the thermostatic chamber where the half cells were placed was set to 25° C., and cycles under the following charge and discharge conditions were repeated 50 times.
Charge condition: CCCV charge, 0.5 C rate, 4.65 V, 0.05 C cutoff
Discharge condition: CC discharge, 0.5 C rate, 2.5V cutoff
FIG. 39B shows the results.

In Condition 3, the temperature of the thermostatic chamber where the half cells were placed was set to 25° C., and cycles under the following charge and discharge conditions were repeated 50 times.
Charge condition: CCCV charge, 0.5 C rate, 4.7 V, 0.05 C cutoff
Discharge condition: CC discharge, 0.5 C rate, 2.5 V cutoff
FIG. 39C shows the results.

In this charge-discharge cycle test, the current value corresponding to 1 C was 200 mA/g per weight of the positive electrode active material. In the case where the current does not reach the cutoff current in the charge condition, charge is cut off at a given time. The voltage such as 4.6 V in the charge condition is referred to as the upper limit voltage, and in the period of the CV charge, the voltage is held at the upper limit voltage. The 2.5 V in the discharge condition is referred to as the lower limit voltage.

The table below summarizes the maximum discharge capacity (mAh/g) per weight of the positive electrode active material of each of Half Cell 1, Half Cell 1p, Half Cell 4, Half Cell 4p, Half Cell 5, and Half Cell 5p.

TABLE 11
Maximum discharge capacity (mAh/g)

| Cell | 25° C., 4.6 V | 25° C., 4.65 V | 25° C., 4.7 V |
|---|---|---|---|
| Half Cell 1 | 211.9 | 216.9 | 215.6 |
| Half Cell 1p | 212.7 | 217.0 | 217.0 |
| Half Cell 4 | 209.1 | 216.0 | 215.5 |
| Half Cell 4p | 211.0 | 214.6 | 217.9 |
| Half Cell 5 | 212.4 | 222.0 | 223.4 |
| Half Cell 5p | 213.1 | 222.9 | 224.4 |

It was found that the discharge capacity was increased due to the increase in the linear pressure of the pressing condition under all of the above conditions.

The following table summarizes the discharge capacity retention rates (%) of Half Cell 1, Half Cell 1p, Half Cell 4, Half Cell 4p, Half Cell 5, and Half Cell 5p after 50 cycles in the charge-discharge cycle test.

TABLE 12
Discharge capacity retention rate (%) after 50 cycles

| Cell | 25° C., 4.6 V | 25° C., 4.65 V | 25° C., 4.7 V |
|---|---|---|---|
| Half Cell 1 | 99.0 | 96.4 | 57.4 |
| Half Cell 1p | 98.4 | 95.4 | 67.7 |
| Half Cell 4 | 97.6 | 94.4 | 79.4 |
| Half Cell 4p | 97.8 | 93.5 | 63.4 |
| Half Cell 5 | 97.5 | 91.5 | 83.2 |
| Half Cell 5p | 97.8 | 91.8 | 76.7 |

The result of comparison between Half Cell 1p and Half Cell 1p and the result of comparison between Half Cell 5p and Half Cell 5p suggest that the discharge capacity retention rate tends to be improved by an increase in the linear pressure of the pressing condition.

### <Half Cell Formation 2-1>

In this example, a coin-type half cell was formed using additionally VGCF as a conductive material and using LCO in Example as a positive electrode active material. As the half cell, a coin cell (CR2032 type with a diameter of 20 mm and a height of 3.2 mm) was used.

### <3. Method for Manufacturing Positive Electrode B in Example>

A method for manufacturing a positive electrode including LCO in Example and conductive materials and the like will be described.

As a binder in Example, polyvinylidene fluoride (PVDF) was prepared. Then, the optimal weight ratios of LCO, AB, CNT, and VGCF were examined with a fixed weight ratio of the binder. Specifically, a slurry for a positive electrode with LCO:AB:CNT:VGCF:PVDF=98−(x+y+z):x:y:z:2 (weight ratio) was prepared, and the positive electrode in which x, y, and z have values in the following table was synthesized. Such positive electrodes are referred to as Sample 11 to Sample 15.

TABLE 13

| Sample | x | y | z |
|---|---|---|---|
| Sample 11 | 3 | 0 | 0 |
| Sample 12 | 2 | 1 | 0 |
| Sample 13 | 0.5 | 0.5 | 0 |
| Sample 14 | 0.5 | 0.3 | 0.2 |
| Sample 15 | 0.5 | 0.1 | 0.4 |

A synthesis procedure of the slurry described above is described with reference to FIG. 13A, FIG. 13B, and the like. First, AB and VGCF were prepared as the first conductive material 42. The addition amounts of AB and VGCF were set in accordance with the above table. As the binder 48, a mixed solution A in which 5 wt % of PVDF was dissolved in NMP was prepared. These were mixed to give the mixture 53 shown in Step S52.

Next, a positive electrode active material of one embodiment of the present invention was prepared. As the positive electrode active material, LCO in Example was used. LCO in Example was added to and mixed with the mixture 53, whereby the mixture 56 shown in Step S55 was obtained.

As the second conductive material 44, a mixed solution in which 0.25 wt % of CNT was dissolved in NMP was prepared. Furthermore, as the binder 48a, a mixed solution B in which 5 wt % of PVDF was dissolved in NMP was prepared. These were mixed with the mixture 56 to give the mixture C serving as a slurry. Note that the total amount of the mixed solution A and the mixed solution B was set to the addition amount of PVDF shown in the above table.

Then, the mixture C serving as the slurry was applied to the positive electrode current collector containing aluminum. After the application, drying was performed at 80° C., and an organic solvent such as NMP was volatilized to form a positive electrode active material layer over the positive electrode current collector.

After that, pressing treatment was performed with a roller press machine to increase the density of the positive electrode active material layer over the positive electrode current collector. As a pressing treatment condition, a linear pressure was 210 kN/m. In addition, each of an upper roll and a lower roll of the roller press machine was set to 120° C.

Through the above process, the positive electrode 12 in Example was obtained. The loading amount of the active material in the positive electrode 12 was approximately 7 mg/cm². The positive electrodes 12 in Example are referred to as Sample 11 to Sample 15 in accordance with x and y in the above table.

### <Observation of Positive Electrode>

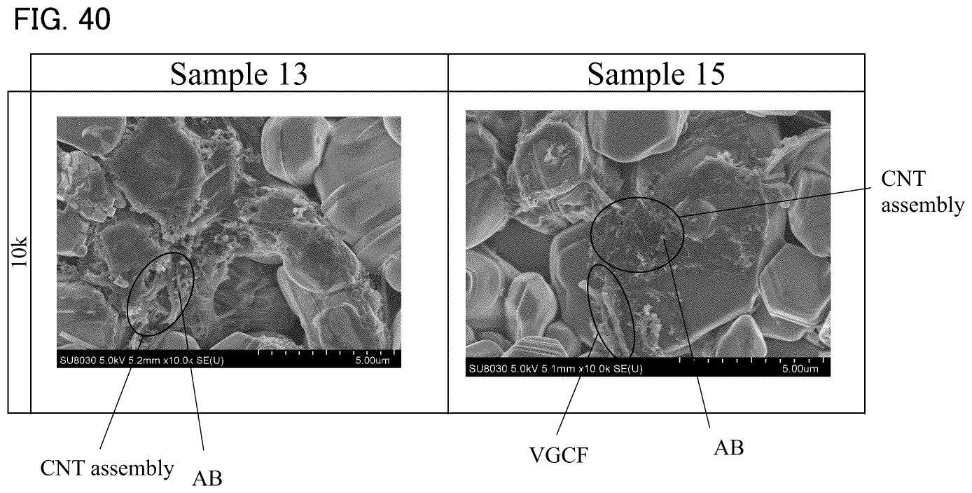

Here, the positive electrodes of Sample 13 and Sample 15 were observed with a SEM. An SU8030 scanning electron microscope apparatus produced by Hitachi High-Tech Corporation was used for the observation with a SEM image. The conditions were an acceleration voltage of 5 kV and a magnification of 20000 times (denoted as 10 k in FIG. 40). Other measurement conditions are as follows: a working distance was 5.0 mm, an emission current was 9 μA to 10.5 μA, both inclusive, an extraction voltage was 5.8 kV, an SE(U) mode (Upper secondary electron detector) was employed, and observation was performed in an autofocus mode.

FIG. 40 shows surface SEM images of the positive electrodes of Sample 13 and Sample 15. At least LCO, AB, CNT, a space, and the like are observed in Sample 13. In Sample 13, a CNT assembly is observed and the CNT assembly is in contact with LCO. In other words, the CNT assembly seems to wrap LCO, the CNT assembly seems to bind LCO, and the CNT assembly wraps around LCO. Note that the LCO also includes a portion exposed from the CNT assembly, and the CNT assembly is positioned so as not to inhibit insertion and extraction of lithium ions. In addition, part of the CNT assembly is in contact with the LCO with PVDF interposed therebetween. The state shown in FIG. 40 can be referred to as a state where CNT sticks to LCO.

At least LCO, AB, CNT, VGCF, a space, and the like are observed in Sample 15. In Sample 15, VGCF is a nearly straight line. In Sample 15, a CNT assembly is observed, and the CNT assembly is in contact with LCO. In other words, the CNT assembly seems to wrap LCO, the CNT assembly seems to bind LCO, and the CNT assembly wraps around LCO. Note that the LCO also includes a portion exposed from the CNT assembly, and the CNT assembly is positioned so as not to inhibit insertion and extraction of lithium ions. In addition, part of VGCF and the CNT assembly is in contact with the LCO with PVDF interposed therebetween. The state shown in FIG. 40 can be referred to as a state where CNT sticks to LCO.

In Sample 13 and Sample 15, AB aggregates are observed and the AB aggregates are in contact with LCO. Specifically, the AB aggregate is positioned to be sandwiched between facing LCO, i.e., adjacent LCO, and in contact with LCO. Furthermore, it is also observed that the AB over LCO is covered with the CNT assembly, and the AB is positioned inside the CNT assembly or is tangled with the CNT assembly. In addition, AB is dispersed as a whole.

In each of Sample 13 and Sample 15, a single particle of LCO is observed in the surface SEM image, and no crack is observed in the LCO in FIG. 40.

### <Electrolyte Solution>

An electrolyte solution used for each of the half cells is described. As an electrolyte solution, a mixed solution in which 1 mol/L of lithium hexafluorophosphate (LiPF₆) was dissolved in a mixture of ethylene carbonate (EC) and diethyl carbonate (DEC) at EC:DEC=3:7 (volume ratio) was prepared. Furthermore, 2 wt % of vinylene carbonate (VC) was added to the total amount of the mixed solution as an additive agent.

### <Separator>

A separator used for each of the half cells is described. As the separator, a polypropylene porous film was used.

### <Counter Electrode>

A counter electrode used for each of the half cells is described. For a negative electrode (counter electrode), a lithium metal was used.

In Example, Half Cell 11 to Half Cell 15 were formed. The positive electrode of Sample 11 described above was used as Half Cell 11, the positive electrode of Sample 12 described above was used as Half Cell 12, the positive electrode of Sample 13 described above was used as Half Cell 13, the positive electrode of Sample 14 described above was used as Half Cell 14, and the positive electrode of Sample 15 described above was used as Half Cell 15.

### <Charge-Discharge Cycle Test>

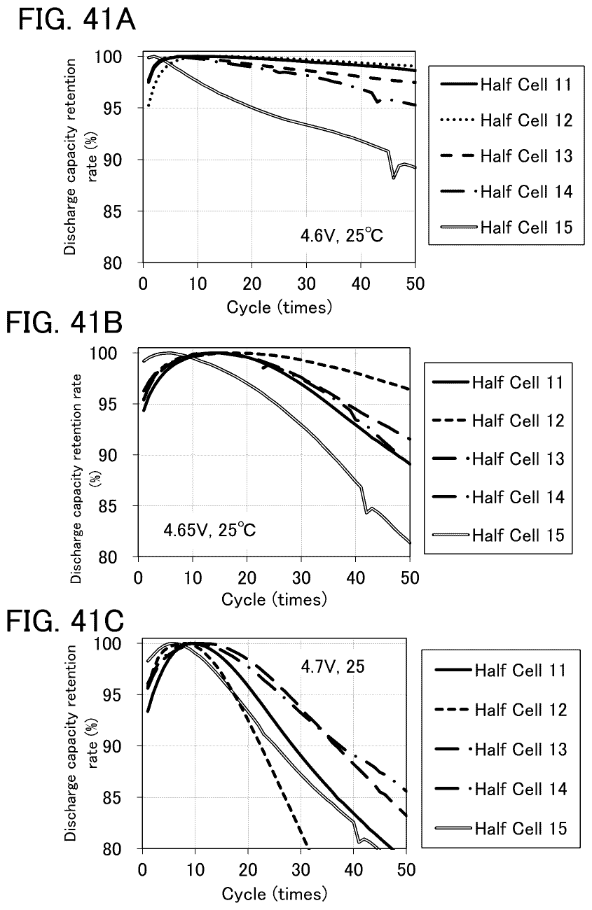

Charge-discharge cycle test was performed on Half Cell 11 to Half Cell 15 under three conditions, so that discharge capacity retention rates were obtained. FIG. 41A to FIG. 41C show the results. In Condition 1, the temperature of a thermostatic chamber where the half cells were placed was set to 25° C., and cycles under the following charge and discharge conditions were repeated 50 times.
Charge condition: CCCV charge, 0.5 C rate, 4.6 V, 0.05 C cutoff
Discharge condition: CC discharge, 0.5 C rate, 2.5 V cutoff
FIG. 41A shows the results.

In Condition 2, the temperature of the thermostatic chamber where the half cells were placed was set to 25° C., and cycles under the following charge and discharge conditions were repeated 50 times.
Charge condition: CCCV charge, 0.5 C rate, 4.65 V, 0.05 C cutoff
Discharge condition: CC discharge, 0.5 C rate, 2.5V cutoff
FIG. 41B shows the results.

In Condition 3, the temperature of the thermostatic chamber where the half cells were placed was set to 25° C., and cycles under the following charge and discharge conditions were repeated 50 times.
Charge condition: CCCV charge, 0.5 C rate, 4.7 V, 0.05 C cutoff
Discharge condition: CC discharge, 0.5 C rate, 2.5 V cutoff
FIG. 41C shows the results.

In this charge-discharge cycle test, the current value corresponding to 1C was 200 mA/g per weight of the positive electrode active material. In the case where the current does not reach the cutoff current in the charge condition, charge is cut off at a given time. The voltage such as 4.6 V in the charge condition is referred to as the upper limit voltage, and in the period of the CV charge, the voltage is held at the upper limit voltage. The 2.5 V in the discharge condition is referred to as the lower limit voltage.

The table below summarizes the discharge capacity retention rates (%) of Half Cell 11 to Half Cell 15 after 50 cycles.

TABLE 14
Discharge capacity retention rate (%) after 50 cycles

| Cell | 25° C., 4.6 V | 25° C., 4.65 V | 25° C., 4.7 V |
|---|---|---|---|
| Half Cell 11 | 98.6 | 89.1 | 78.7 |
| Half Cell 12 | 99.0 | 96.4 | 57.4 |
| Half Cell 13 | 97.5 | 91.5 | 83.2 |
| Half Cell 14 | 95.3 | 89.0 | 85.6 |
| Half Cell 15 | 89.2 | 81.4 | 77.4 |

The table below summarizes the maximum discharge capacity (mAh/g) per weight of the positive electrode active material of each of Half Cell 11 to Half Cell 15 in the charge-discharge cycle test.

TABLE 15
Maximum discharge capacity (mAh/g)

| Cell | 25° C., 4.6 V | 25° C., 4.65 V | 25° C., 4.7 V |
|---|---|---|---|
| Half Cell 11 | 213.4 | 227.1 | 231.4 |
| Half Cell 12 | 211.9 | 216.9 | 215.6 |
| Half Cell 13 | 212.4 | 222.0 | 223.4 |
| Half Cell 14 | 211.1 | 220.6 | 223.5 |
| Half Cell 15 | 204.1 | 211.2 | 216.6 |

Half Cell 11 to Half Cell 13 exhibited favorable maximum discharge capacity at 25° C. and charge voltages of 4.6 V, 4.65 V, and 4.7 V and had favorable charge-discharge cycle performance. Half Cell 14 and Half Cell 15 using VGCF also exhibited sufficient charge-discharge cycle performance. The results show that the positive electrode including AB, CNT, and VGCF is preferable, and x≥y, x>z, x>0, y>0, and z>0 are preferably satisfied when the positive electrode is represented by LCO:AB:CNT:VGCF:PVDF=98−(x+y+z):x:y:z:2 (weight ratio). In other words, in the positive electrode, the weight of CNT is preferably less than or equal to the weight of AB, and the weight of VGCF is also preferably less than or equal to the weight ratio of AB.

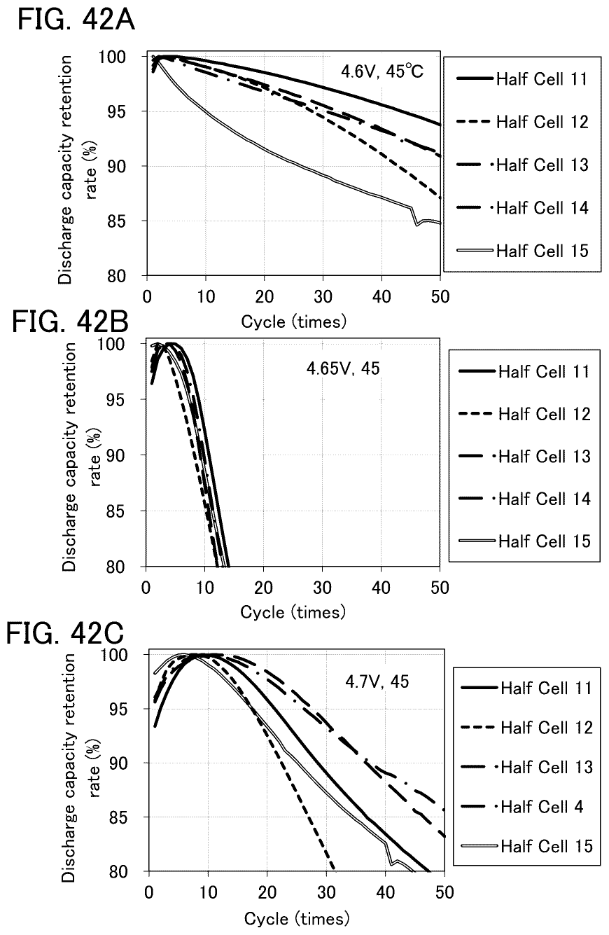

Next, the temperature of the thermostatic chamber was set to 45° C., and charge-discharge cycle test was performed on Half Cell 11 to Half Cell 15 under the above-described conditions 1 to 3, whereby discharge capacity retention rates were obtained. The results are shown in FIG. 42A to FIG. 42C.

The table below summarizes the discharge capacity retention rates (%) of Half Cell 11 to Half Cell 15 after 50 cycles.

TABLE 16
Discharge capacity retention rate (%) after 50 cycles

| Cell | 45° C., 4.6 V | 45° C., 4.65 V | 45° C., 4.7 V |
|---|---|---|---|
| Half Cell 11 | 93.7 | 43.9 | 39.0 |
| Half Cell 12 | 87.1 | 47.0 | 36.1 |
| Half Cell 13 | 90.9 | 37.1 | 40.1 |
| Half Cell 14 | 91.2 | 41.1 | 41.2 |
| Half Cell 15 | 84.8 | 50.1 | 40.8 |

The table below summarizes the maximum discharge capacity (mAh/g) per weight of the positive electrode active material of each of Half Cell 11 to Half Cell 15 in the charge-discharge cycle test.

TABLE 17
Maximum discharge capacity (mAh/g)

| Cell | 45° C., 4.6 V | 45° C., 4.65 V | 45° C., 4.7 V |
|---|---|---|---|
| Half Cell 11 | 219.3 | 231.3 | 236.1 |
| Half Cell 12 | 217.5 | 222.3 | 220.7 |
| Half Cell 13 | 216.9 | 227.7 | 227.9 |
| Half Cell 14 | 216.3 | 226.5 | 230.0 |
| Half Cell 15 | 211.1 | 220.1 | 227.5 |

Half Cell 11 to Half Cell 15 exhibited favorable maximum discharge capacity at 45° C. and a charge voltage of 4.6 V and had favorable charge-discharge cycle performance. Half Cell 14 and Half Cell 15 using VGCF also exhibited sufficient charge-discharge cycle performance. The results show that the positive electrode including AB, CNT, and VGCF is preferable, and x≥y, x≥z, x>0, y>0, and z>0 are preferably satisfied when the positive electrode is represented by LCO:AB:CNT:VGCF:PVDF=98−(x+y+z):x:y:z:2 (weight ratio). In other words, in the positive electrode, the weight of CNT is preferably less than or equal to the weight of AB, and the weight of VGCF is also preferably less than or equal to the weight of AB.

### <Discharge Capacity Measurement at Different Rates (C-Rate Measurement)>

First, Half Cell 13 to Half Cell 15 were subjected to aging treatment. In the aging treatment, the temperature of a thermostatic chamber where half cells were placed was set to 25° C., and cycles under the following charge and discharge conditions were repeated twice. Charge condition: CCCV charge, 0.1 C rate, 4.6 V, 0.01 C cutoff Discharge condition: CC discharge, 0.1 C rate, 2.5 V cutoff In this aging treatment, the current value corresponding to 1C was 200 mA/g per weight of the positive electrode active material. The voltage such as 4.6 V in the charge condition is referred to as the upper limit voltage, and in the period of the CV charge, the voltage is held at the upper limit voltage. The 2.5 V in the discharge condition is referred to as the lower limit voltage.

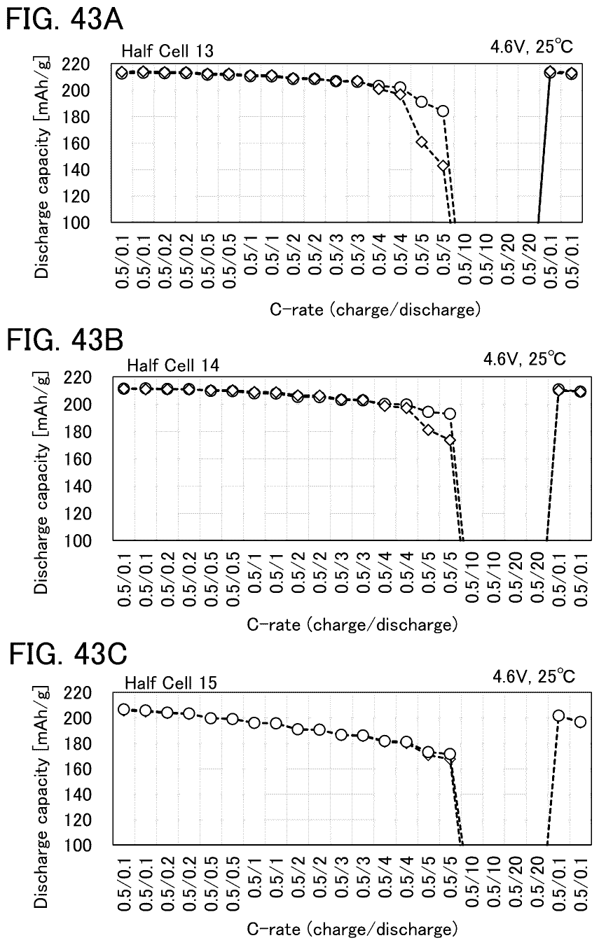

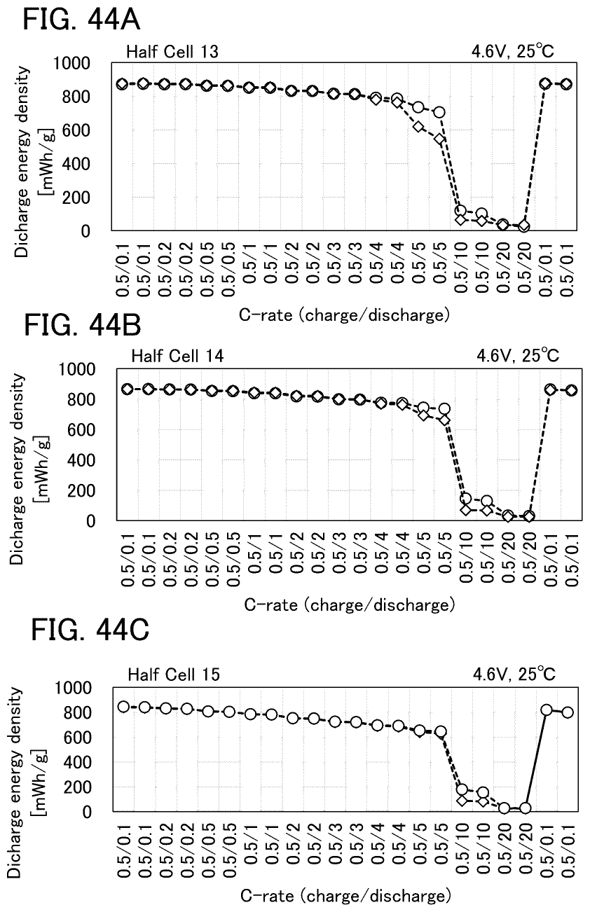

Next, discharge capacity of different rates at 25° C. and an upper limit voltage of 4.6 V were measured using Half Cell 13 to Half Cell 15. Two half cells 13, two half cells 14, and two half cells 15 were prepared. The charge condition of the discharge capacity at different rates were the same as that in the charge-discharge cycle test, and the charge condition were fixed when charge and discharge were repeated. The discharge condition was as follows: the rates were changed in the order of 0.1 C, 0.2 C, 0.5 C, 1 C, 2 C, 3 C, 4 C, 5 C, 10 C, 20 C, and 0.1 C until the voltage was decreased to 2.5 V. Charge and discharge were repeated twice at each rate of discharge condition. As results, FIG. 43A is a graph showing the discharge capacity per positive electrode active material weight (mAh/g) corresponding to Half Cell 13, FIG. 43B is a graph showing the discharge capacity per positive electrode active material weight (mAh/g) corresponding to Half Cell 14, and FIG. 43C is a graph showing the discharge capacity per positive electrode active material weight (mAh/g) corresponding to Half Cell 15. FIG. 44A is a graph showing the discharge energy density (mWh/g) per weight of the positive electrode active material corresponding to Half Cell 13, FIG. 44B is a graph showing the discharge capacity (mAh/g) per weight of the positive electrode active material corresponding to Half Cell 14, and FIG. 44C is a graph showing the discharge capacity (mAh/g) per weight of the positive electrode active material corresponding to Half Cell 15. The discharge energy density (mWh/g) is the product of the discharge capacity and the discharge average voltage. It is found that Half Cell 14 has as high discharge capacity as Half Cell 13 under the discharge condition 3 C and is preferable.

### <Half Cell Formation 2-2>

Positive electrodes as new half cells were prepared as follows: the positive electrode active materials of Sample 14 and Sample 15 were used, and the positive electrode active material layers including the positive electrode active materials were each pressed under pressing treatment conditions of the linear pressure of 210 kN/m and then the linear pressure of 1467 kN/m. Note that each of an upper roll and a lower roll of the roller press machine was set to 120° C.

Half cells including the above-described positive electrodes were assembled. The half cells corresponding to Sample 14 and Sample 15 are referred to as Half Cell 14p and Half Cell 15p, respectively. The table below summarizes the half cells and the pressing condition. The conditions other than the pressing condition were the same as those for the half cells described above.

TABLE 18

| Sample | Pressing condition |
|---|---|
| Sample 14 | Linear pressure 210 kN/m |
| Sample 14p | Linear pressure 210 kN/m + Linear pressure 1467 kN/m |
| Sample 15 | Linear pressure 210 kN/m |
| Sample 15p | Linear pressure 210 kN/m + Linear pressure 1467 kN/m |

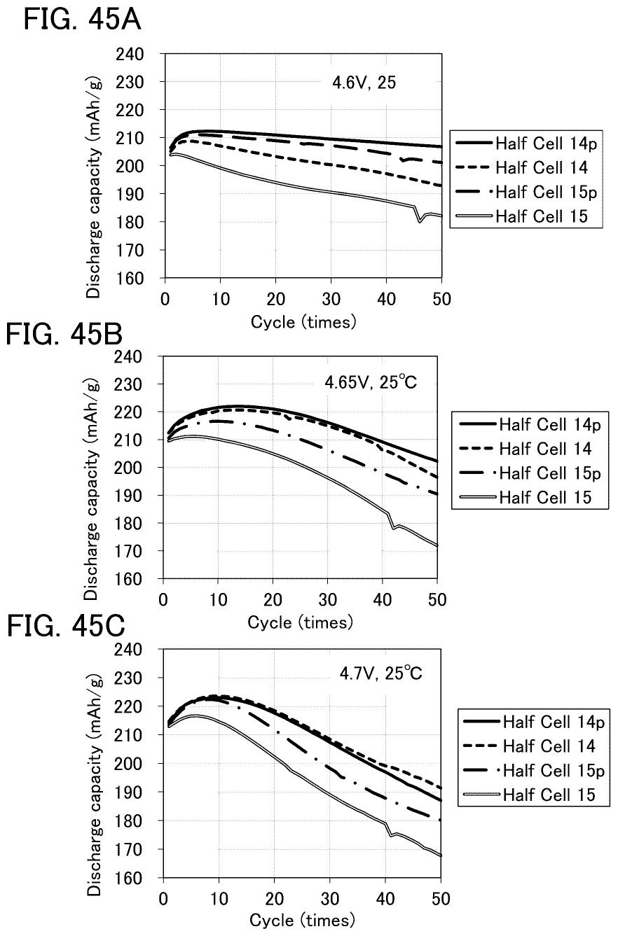

Charge-discharge cycle test was performed on Half Cell 14, Half Cell 14p, Half Cell 15, and Half Cell 15p under three conditions, so that discharge capacity (mAh/g) per weight of the positive electrode active material was obtained. FIG. 45A to FIG. 45C show the results. In Condition 1, the temperature of a thermostatic chamber where the half cells were placed was set to 25° C., and cycles under the following charge and discharge conditions were repeated 50 times.
Charge condition: CCCV charge, 0.5 C rate, 4.6 V, 0.05 C cutoff
Discharge condition: CC discharge, 0.5 C rate, 2.5 V cutoff
FIG. 45A shows the results.

In Condition 2, the temperature of the thermostatic chamber where the half cells were placed was set to 25° C., and cycles under the following charge and discharge conditions were repeated 50 times.
Charge condition: CCCV charge, 0.5 C rate, 4.65 V, 0.05 C cutoff
Discharge condition: CC discharge, 0.5 C rate, 2.5V cutoff
FIG. 45B shows the results.

In Condition 3, the temperature of the thermostatic chamber where the half cells were placed was set to 25° C., and cycles under the following charge and discharge conditions were repeated 50 times.
Charge condition: CCCV charge, 0.5 C rate, 4.7 V, 0.05 C cutoff
Discharge condition: CC discharge, 0.5 C rate, 2.5 V cutoff
FIG. 45C shows the results.

In this charge-discharge cycle test, the current value corresponding to 1C was 200 mA/g per weight of the positive electrode active material. In the case where the current does not reach the cutoff current in the charge condition, charge is cut off at a given time. The voltage such as 4.6 V in the charge condition is referred to as the upper limit voltage, and in the period of the CV charge, the voltage is held at the upper limit voltage. The 2.5 V in the discharge condition is referred to as the lower limit voltage.

The table below summarizes the maximum discharge capacity (mAh/g) per weight of the positive electrode active material of each of Half Cell 14, Half Cell 14p, Half Cell 15, and Half Cell 15p.

TABLE 19
Maximum discharge capacity (mAh/g)

| Cell | 25° C., 4.6 V | 25° C., 4.65 V | 25° C., 4.7 V |
|---|---|---|---|
| Half Cell 14 | 211.1 | 220.6 | 223.5 |
| Half Cell 14p | 212.3 | 222.0 | 223.0 |
| Half Cell 15 | 204.1 | 211.2 | 216.6 |
| Half Cell 15p | 212.3 | 222.0 | 223.0 |

It was found that the discharge capacity was increased due to the increase in the linear pressure of the pressing condition under all of the above conditions.

The following table summarizes the discharge capacity retention rates (%) of Half Cell 14, Half Cell 14p, Half Cell 15, and Half Cell 15p after 50 cycles in the charge-discharge cycle test.

TABLE 20
Discharge capacity retention rate (%) after 50 cycles

| Cell | 25° C., 4.6 V | 25° C., 4.65 V | 25° C., 4.7 V |
|---|---|---|---|
| Half Cell 14 | 95.3 | 89.0 | 85.6 |
| Half Cell 14p | 97.4 | 91.1 | 83.9 |
| Half Cell 15 | 89.2 | 81.4 | 77.4 |
| Half Cell 15p | 92.4 | 87.9 | 81.0 |

Increasing the linear pressure of the pressing condition tended to improve the discharge capacity retention rate.

### <Electrode Density>

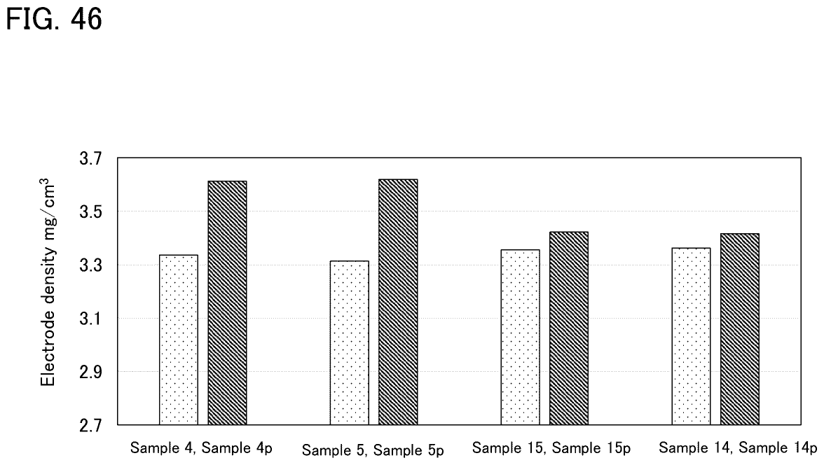

By changing the linear pressure of the pressing condition, the density of the positive electrode active material layer is changed. The densities (referred to as electrode densities) of Sample 4, Sample 5, Sample 14, and Sample 15, which were pressed at a linear pressure of 210 kN/m, and Sample 4p, Sample 5p, Sample 14p, and Sample 15p, which were pressed at linear pressures of 210 kN/m and then 1467 kN/m, were measured. FIG. 46 shows the results.

Sample 4p, Sample 5p, Sample 14p, and Sample 15p were found to have increased electrode densities. In consideration of the above charge-discharge cycle test, Sample 4p, Sample 5p, Sample 14p, and Sample 15p with increased electrode density each have improved maximum discharge capacity and a high discharge capacity retention rate.

A higher linear pressure might cause cracks in LCO; however, it is inferred that the discharge capacity retention rate was high because the positive electrode contained CNT and/or VGCF as conductive materials.

### <Measurement of Low-Temperature Characteristics>

The half cells including Sample 1, Sample 2, Sample 5, Sample 6, Sample 5p, Sample 14, and Sample 15 were placed in a thermostatic chamber whose temperature was set below freezing, and the charge and discharge characteristics thereof were measured. In this example, the temperature below freezing means 0° C. or lower, and this characteristic is referred to as a low-temperature characteristic. As a half cell, a coin cell (CR2032 type with a diameter of 20 mm and a height of 3.2 mm) was used.

### <Electrolyte Solution>

As the electrolyte solution of each half cell, a mixed solvent including EC, EMC, and DMC (with the volume ratio at 25° C. being EC:EMC:DMC=3:3.5:3.5) was used.

### <Separator>

As a separator, a polypropylene porous film was used.

### <Counter Electrode>

For a negative electrode (counter electrode), a lithium metal was used.

As shown in the following table, the half cells including the above mixed solvents and Sample 1, Sample 2, Sample 5, Sample 6, Sample 5p, Sample 14, and Sample 15 are referred to as Half Cell 1c, Half Cell 2c, Half Cell 5c, Half Cell 6c, Half Cell 5pc, Half Cell 14c, and Half Cell 15c, respectively.

TABLE 21

| Cell | Positive electrode | Electrolyte solution |
|---|---|---|
| Half Cell 1c | Sample 1 | EC:EMC:DMC = |
| Half Cell 2c | Sample 2 | 3:3.5:3.5 |
| Half Cell 5c | Sample 5 | |
| Half Cell 6c | Sample 6 | |
| Half Cell 5pc | Sample 5p | |
| Half Cell 14c | Sample 14 | |
| Half Cell 15c | Sample 15 | |
| Half Cell 14pc | Sample 14p | |
| Half Cell 15pc | Sample 15p | |

The half cells in the above table were placed in a thermostatic chamber set at 25° C., and were subjected to aging treatment. In the aging treatment, the temperature of the thermostatic chamber where the half cells were placed was set to 25° C., and cycles under the following charge and discharge conditions were repeated twice.
Charge condition: CCCV charge, 0.1 C rate, 4.6 V, 0.01 C cutoff
Discharge condition: CC discharge, 0.1 C rate, 2.5 V cutoff
   In this aging treatment, the current value corresponding to 1 C was 200 mA/g per weight of the positive electrode active material. The voltage such as 4.6 V in the charge condition is referred to as the upper limit voltage, and in the period of the CV charge, the voltage is held at the upper limit voltage. The 2.5 V in the discharge condition is referred to as the lower limit voltage.

After the aging treatment, the temperature of the thermostatic chamber was set to 25° C. and charge and discharge were performed once; the temperature of the thermostatic chamber was set to 0° C. and charge and discharge were performed once; the temperature of the thermostatic chamber was set to 25° C. and charge and discharge were performed once; the temperature of the thermostatic chamber was set to −20° C. and charge and discharge were performed once; the temperature of the thermostatic chamber was set to 25° C. and charge and discharge were performed once; the temperature of the thermostatic chamber was set to −40° C. and charge and discharge were performed once; and the temperature of the thermostatic chamber was set to 25° C. and charge and discharge were performed once. The charge and discharge conditions were similar to those in the above aging treatment.

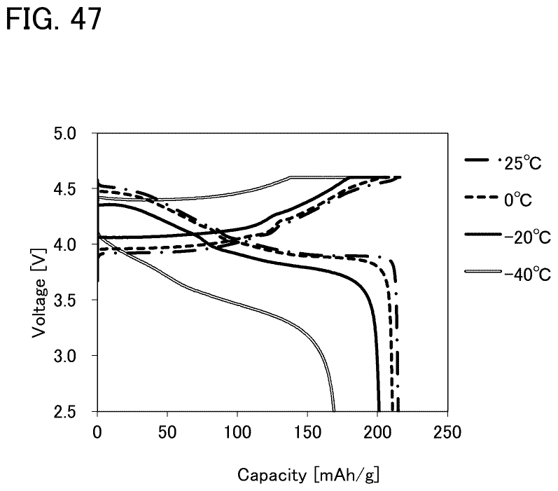

FIG. 47 shows the results of the low-temperature characteristics of Half Cell 1c. The table below shows discharge capacity at 25° C., 0° C., −20° C., and −40° C. of Half Cell 1c and normalized values based on the discharge capacity at 25° C. The above-described normalized value at −20° C. was higher than or equal to 90%, or higher than or equal to 93% as a preferable value, and the above-described normalized value at −40° C. was higher than or equal to 70%, or higher than or equal to 78% as a preferable value. The results show excellent low-temperature characteristics.

TABLE 22
Half Cell 1c

| Temp. | Discharge capacity | Normalized value based on |
|---|---|---|
| (° C.) | (mAh/g) | discharge capacity at 25° C. |
| 25 | 214.6 | 100.0 |
| 0 | 210.7 | 98.2 |
| −20 | 201.2 | 93.7 |
| −40 | 168.9 | 78.7 |

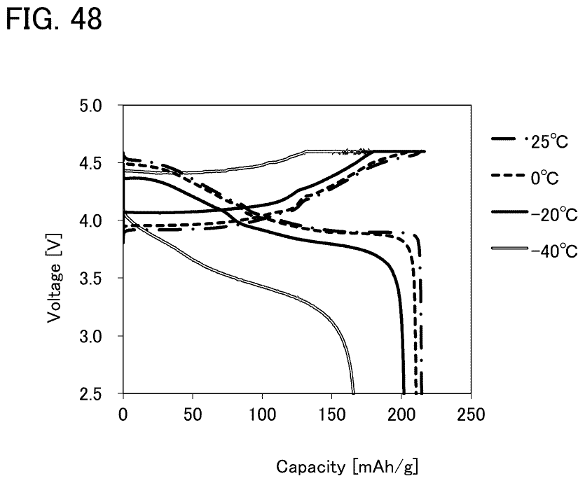

FIG. 48 shows the results of the low-temperature characteristics of Half Cell 2c. The table below shows discharge capacity at 25° C., 0° C., −20° C., and −40° C. of Half Cell 2c and normalized values based on the discharge capacity at 25° C. The above-described normalized value at −20° C. was higher than or equal to 90%, or higher than or equal to 94% as a preferable value, and the above-described normalized value at −40° C. was higher than or equal to 70%, or higher than or equal to 77% as a preferable value. The results show excellent low-temperature characteristics.

TABLE 23
Half Cell 2c

| Temp. | Discharge capacity | Normalized value based on |
|---|---|---|
| (° C.) | (mAh/g) | discharge capacity at 25° C. |
| 25 | 214.5 | 100.0 |
| 0 | 210.5 | 98.2 |
| −20 | 201.8 | 94.1 |
| −40 | 165.4 | 77.1 |

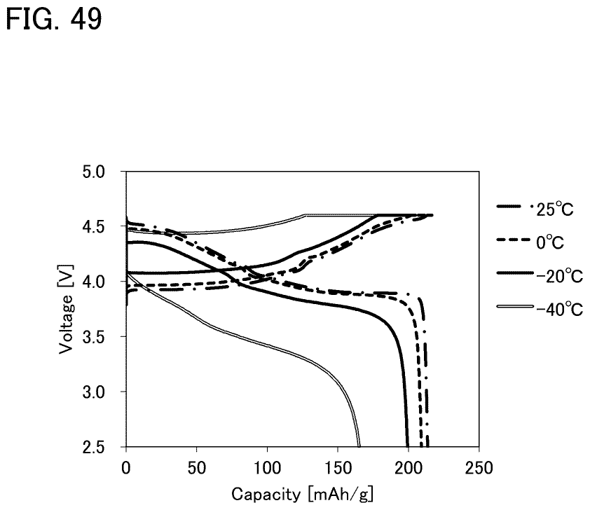

FIG. 49 shows the results of the low-temperature characteristics of Half Cell 5c. The table below shows discharge capacity at 25° C., 0° C., −20° C., and −40° C. of Half Cell 5c and normalized values based on the discharge capacity at 25° C. The above-described normalized value at −20° C. was higher than or equal to 90%, or higher than or equal to 93% as a preferable value, and the above-described normalized value at −40° C. was higher than or equal to 70%, or higher than or equal to 77% as a preferable value. The results show excellent low-temperature characteristics.

TABLE 24
Half Cell 5c

| Temp. | Discharge capacity | Normalized value based on |
|---|---|---|
| (° C.) | (mAh/g) | discharge capacity at 25° C. |
| 25 | 213.6 | 100.0 |
| 0 | 209.1 | 97.9 |
| −20 | 199.4 | 93.4 |
| −40 | 165.0 | 77.2 |

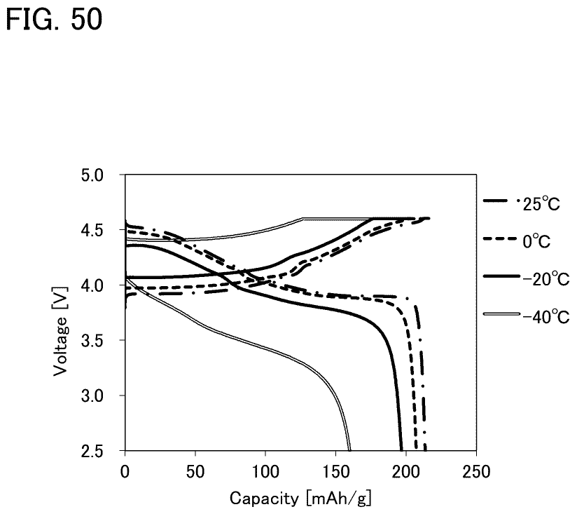

FIG. 50 shows the results of the low-temperature characteristics of Half Cell 6c. The table below shows discharge capacity at 25° C., 0° C., −20° C., and −40° C. of Half Cell 6c and normalized values based on the discharge capacity at 25° C. The above-described normalized value at −20° C. was higher than or equal to 90%, or higher than or equal to 92% as a preferable value, and the above-described normalized value at −40° C. was higher than or equal to 70%, or higher than or equal to 74% as a preferable value. The results show excellent low-temperature characteristics.

TABLE 25
Half Cell 6c

| Temp. | Discharge capacity | Normalized value based on |
|---|---|---|
| (° C.) | (mAh/g) | discharge capacity at 25° C. |
| 25 | 213.6 | 100.0 |
| 0 | 207.3 | 97.0 |
| −20 | 196.7 | 92.1 |
| −40 | 159.9 | 74.8 |

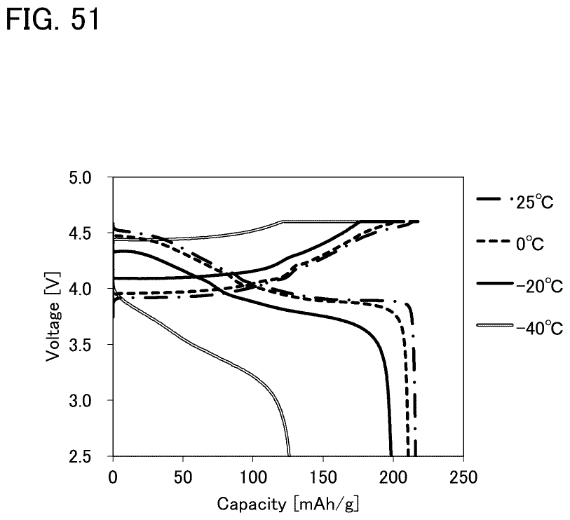

FIG. 51 shows the results of the low-temperature characteristics of Half Cell 5pc. The table below shows discharge capacity at 25° C., 0° C., −20° C., and −40° C. of Half Cell 5pc and normalized values based on the discharge capacity at 25° C. The above-described normalized value at −20° C. was higher than or equal to 90%, or higher than or equal to 93% as a preferable value, and the above-described normalized value at −40° C. was higher than or equal to 70%, or higher than or equal to 77% as a preferable value. The results show excellent low-temperature characteristics.

TABLE 26
Half Cell 5pc

| Temp. | Discharge capacity | Normalized value based on |
|---|---|---|
| (° C.) | (mAh/g) | discharge capacity at 25° C. |
| 25 | 213.7 | 100.0 |
| 0 | 209.1 | 97.9 |
| −20 | 199.4 | 93.3 |
| −40 | 165.0 | 77.2 |

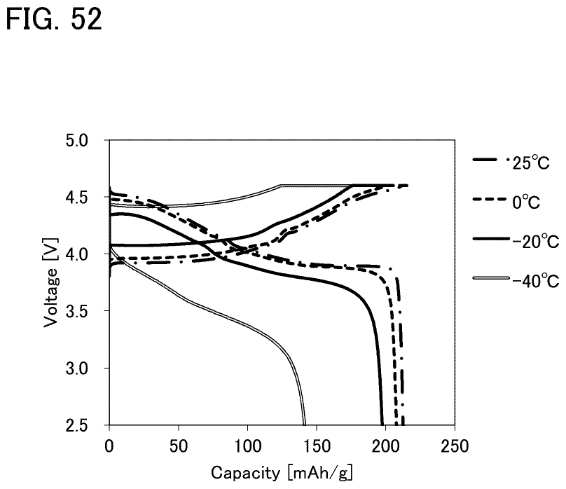

FIG. 52 shows the results of the low-temperature characteristics of Half Cell 14c. The table below shows discharge capacity at 25° C., 0° C., −20° C., and −40° C. of Half Cell 14c and normalized values based on the discharge capacity at 25° C. The above-described normalized value at −20° C. was higher than or equal to 90%, or higher than or equal to 92% as a preferable value, and the above-described normalized value at −40° C. was higher than or equal to 63%, or higher than or equal to 66% as a preferable value. The results show excellent low-temperature characteristics.

TABLE 27
Half Cell 14c

| Temp. | Discharge capacity | Normalized value based on |
|---|---|---|
| (° C.) | (mAh/g) | discharge capacity at 25° C. |
| 25 | 212.5 | 100.0 |
| 0 | 207.7 | 97.7 |
| −20 | 197.4 | 92.9 |
| −40 | 141.1 | 66.4 |

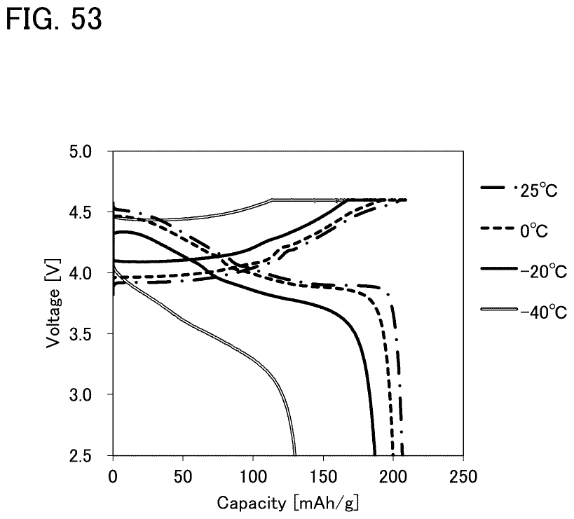

FIG. 53 shows the results of the low-temperature characteristics of Half Cell 15c. The table below shows discharge capacity at 25° C., 0° C., −20° C., and −40° C. of Half Cell 15c and normalized values based on the discharge capacity at 25° C. The above-described normalized value at −20° C. was higher than or equal to 87%, or higher than or equal to 90% as a preferable value, and the above-described normalized value at −40° C. was higher than or equal to 60%, or higher than or equal to 62% as a preferable value. The results show excellent low-temperature characteristics.

TABLE 28
Half Cell 15c

| Temp. | Discharge capacity | Normalized value based on |
|---|---|---|
| (° C.) | (mAh/g) | discharge capacity at 25° C. |
| 25 | 206.5 | 100.0 |
| 0 | 199.8 | 96.8 |
| −20 | 186.9 | 90.5 |
| −40 | 129.8 | 62.9 |

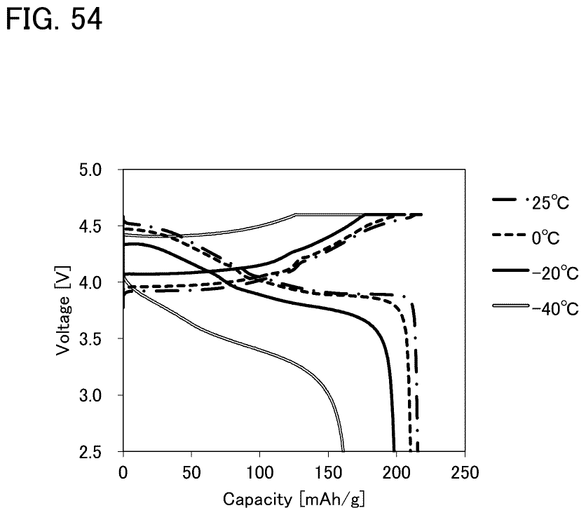

FIG. 54 shows the results of the low-temperature characteristics of Half Cell 14pc. The table below shows discharge capacity at 25° C., 0° C., −20° C., and −40° C. of Half Cell 14pc and normalized values based on the discharge capacity at 25° C. The above-described normalized value at −20° C. was higher than or equal to 90%, or higher than or equal to 96% as a preferable value, and the above-described normalized value at −40° C. was higher than or equal to 70%, or higher than or equal to 77% as a preferable value. The results show excellent low-temperature characteristics.

TABLE 29
Half Cell 14pc

| Temp. | Discharge capacity | Normalized value based on |
|---|---|---|
| (° C.) | (mAh/g) | discharge capacity at 25° C. |
| 25 | 206.5 | 100.0 |
| 0 | 210.2 | 101.8 |
| −20 | 198.1 | 96.0 |
| −40 | 160.9 | 77.9 |

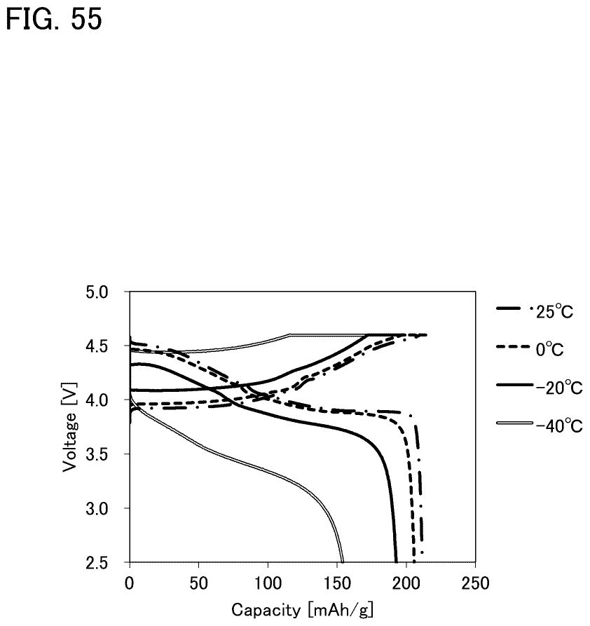

FIG. 55 shows the results of the low-temperature characteristics of Half Cell 15pc. The table below shows discharge capacity at 25° C., 0° C., −20° C., and −40° C. of Half Cell 15pc and normalized values based on the discharge capacity at 25° C. The above-described normalized value at −20° C. was higher than or equal to 87%, or higher than or equal to 91% as a preferable value, and the above-described normalized value at −40° C. was higher than or equal to 70%, or higher than or equal to 72% as a preferable value. The results show excellent low-temperature characteristics.

TABLE 30
Half Cell 15pc

| Temp. | Discharge capacity | Normalized value based on |
|---|---|---|
| (° C.) | (mAh/g) | discharge capacity at 25° C. |
| 25 | 211.6 | 100.0 |
| 0 | 205.8 | 97.2 |
| −20 | 192.8 | 91.1 |
| −40 | 154.0 | 72.8 |

Half Cell 1c and Half Cell 5c each including AB and CNT as the conductive materials had improved low-temperature characteristics compared with Half Cell 1c including AB as the conductive material. The half cells including AB, CNT, and VGCF as conductive materials had improved low-temperature characteristics by increasing the linear pressure of the pressing condition.

### <XRD Analysis on High-Voltage Charged State>

The LCO in Example being in a high-voltage charged state was subjected to XRD analysis.

First, the temperature of a thermostatic chamber in which Half Cell 2 (a half cell different from the one subjected to the charge-discharge cycle test) was placed was set to 25° C., and cycles under the following charge and discharge conditions were repeated.
Charge condition: CCCV charge, 0.2 C rate, 4.5 V, 0.05 C cutoff
Discharge condition: CC discharge, 0.2 C, 3.0 V cutoff Note that as in the other tests, the current value corresponding to 1 C was 200 mA/g per weight of the positive electrode active material. The voltage such as 4.5 V in the charge condition is referred to as the upper limit voltage, and in the period of the CV charge, the voltage is held at the upper limit voltage. The 2.5 V in the discharge condition is referred to as the lower limit voltage.

Next, charge was performed before the XRD analysis on a high-voltage charged state.
Charge condition: CCCV charge, 0.2 C rate, 4.6 V, 0.02 C cutoff
   Note that as in the other tests, the current value corresponding to 1 C was 200 mA/g per weight of the positive electrode active material. The voltage such as 4.6 V in the charge condition is referred to as the upper limit voltage, and in the period of the CV charge, the voltage is held at the upper limit voltage.

Then, Half Cell 2 was disassembled within 1 hour after termination of the above charge. For taking out a positive electrode including Sample 2 that was kept in a high-voltage charged state, the disassembly was performed carefully using an insulating tool so as to prevent a short circuit. Note that for the disassembly, an argon-filled glove box in which the dew point and the oxygen concentration were controlled was used. Note that the dew point of the glove box is preferably lower than or equal to −70° C., and the oxygen concentration is preferably lower than or equal to 5 ppm. Since the crystal structure of the positive electrode active material might change due to self-discharge after a long time has passed from the above charge, XRD analysis is preferably performed immediately after the disassembly.

Sample 2 obtained by disassembling Half Cell 2 was set on an XRD measurement stage that could be hermetically sealed in the glove box, whereby Sample 1 on the XRD measurement stage hermetically sealed together with argon was obtained.

After that, XRD measurement was started within 15 minutes. The XRD apparatus and conditions are as follows.
XRD apparatus: D8 ADVANCE produced by Bruker AXS
X-ray source: CuKα₁ radiation
Output: 40 kV, 40 mA
Angle of divergence: Div. Slit, 0.5°
Detector: LynxEye
Scanning method: 2θ/θ continuous scanning
Measurement range (2θ): from 15° to 75°
Step width (2θ): 0.01°
Counting time: 1 second/step
Rotation of sample stage: 15 rpm

From the obtained XRD patterns, the background and CuKα₂ radiation peak were removed using analysis software, DIFFRAC. EVA.

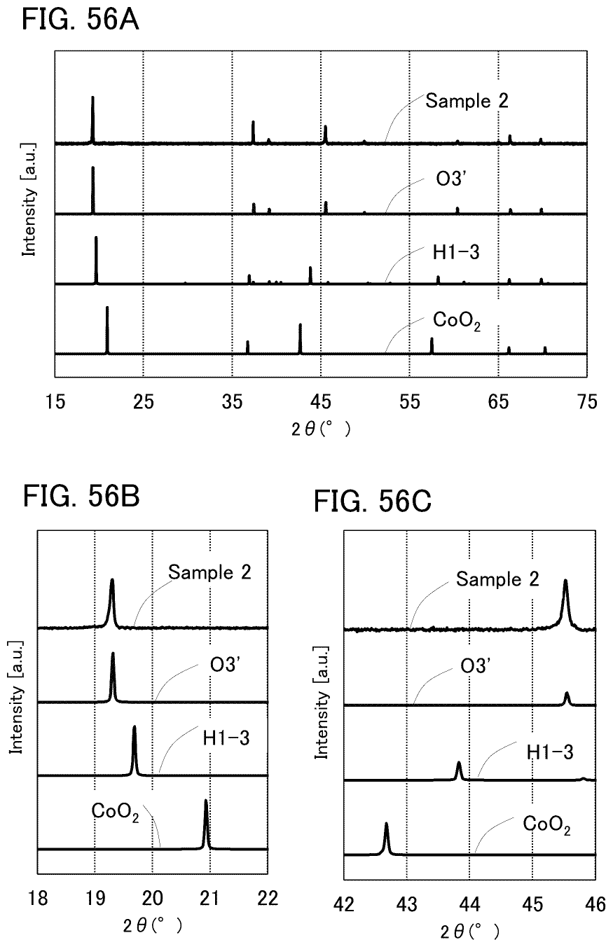

FIG. 56A to FIG. 56C show the XRD measurement data of Sample 2 in a high-voltage charged state obtained in the above manner. FIG. 56A to FIG. 56C in which Intensity is shown on the vertical axis and 2θ (°) is shown on the horizontal axis, show a reference profile (O3′) of the O3′ structure, a reference profile (H1-3) of the H1-3 structure, and a reference profile (CoO₂) of CoO₂ together.

FIG. 56A illustrates a 2θ range from 15° to 75° C., both inclusive, FIG. 56B illustrates a 2θ range from 18° to 22° C., both inclusive, and FIG. 56C illustrates a 2θ range from 42° to 46° C., both inclusive. The vertical axis in FIG. 56B and the vertical axis in FIG. 56C are each enlarged from the vertical axis in FIG. 56A.

As a result of the XRD analysis on a high-voltage charged state shown in FIG. 56A to FIG. 56C, Sample 2 charged under a high voltage condition of 4.6 V (the above description is referred to for the other charge conditions) had a diffraction peak at 2θ=19.30° within the range of 2θ=19.25±0.12° (greater than or equal to 19.13° and less than or equal to 19.37°) and a diffraction peak at 2θ=45.52° within the range of 2θ=45.47±0.10° (greater than or equal to 45.37° and less than or equal to 45.57°). That is, it is confirmed that the O3′ structure is included. Thus, the O3′ structure included in Sample 1 in a high-voltage charged state can be concluded to be a major factor of favorable cycle performance at 4.60 V, favorable cycle performance at 4.65 V, and favorable cycle performance at 4.70 V of Half Cell 2 including Sample 2.

### REFERENCE NUMERALS

100: first positive electrode active material, 110: second positive electrode active material, 100c: surface portion, 100b: inner portion

1. A secondary battery comprising:
a positive electrode comprising a positive electrode active material, a first conductive material, and a second conductive material having a shape different from a shape of the first conductive material,
wherein the positive electrode active material comprises lithium cobalt oxide,
wherein the positive electrode active material comprises magnesium in a surface portion,
wherein a median diameter of the positive electrode active material is greater than or equal to 1 μm and less than or equal to 12 μm,
wherein a weight of the first conductive material is greater than or equal to a weight of the second conductive material, and
wherein the second conductive material forms an assembly and comprises a portion sticking to the positive electrode active material.

2. The secondary battery according to claim 1,
wherein the first conductive material is positioned inside the assembly.

3. A secondary battery comprising:
a positive electrode comprising a positive electrode active material, a particulate conductive material, and a fibrous conductive material,
wherein the positive electrode active material comprises lithium cobalt oxide,
wherein the positive electrode active material comprises magnesium in a surface portion,
wherein a median diameter of the positive electrode active material is greater than or equal to 1 μm and less than or equal to 12 μm,
wherein a weight of the particulate conductive material is greater than or equal to a weight of the fibrous conductive material, and
wherein the fibrous conductive material forms an assembly and comprises a portion sticking to the positive electrode active material.

4. The secondary battery according to claim 3,
wherein the particulate conductive material is positioned inside the assembly.

5. The secondary battery according to claim 1, wherein a powder volume resistivity of the positive electrode active material is higher than or equal to 1.0×10⁸ Ω·cm at a pressure of 64 MPa and higher than or equal to 1.0×10⁸ Ω·cm at a pressure of 13 MPa.

6. The secondary battery according to claim 1, wherein the second conductive material comprises a carbon fiber.

7. The secondary battery according to claim 3, wherein the fibrous conductive material comprises a carbon fiber.

8. The secondary battery according to claim 6, wherein the carbon fiber comprises a carbon nanotube.

9. The secondary battery according to claim 8, wherein a powder volume resistivity of the carbon nanotube is lower than or equal to 1×10⁻² Ω·cm at a pressure of 64 MPa.

10. The secondary battery according to claim 8, wherein a powder volume resistivity of the carbon nanotube is lower than or equal to 1×10⁻² Ω·cm at a pressure of 64 MPa and lower than or equal to 1×10⁻¹ Ω·cm at a pressure of 13 MPa.
